(19) United States
(12) Patent Application Publication
(10) Pub. No.: US 2021/0378161 A1
(43) Pub. Date: Dec. 9, 2021

(54) FARM MANAGEMENT SYSTEM

(71) Applicant: CROP ONE HOLDINGS, INC., Millis, MA (US)

(72) Inventors: Thomas J. Kerr, Millis, MA (US); Deane L. Falcone, Medway, MA (US)

(21) Appl. No.: 17/339,675

(22) Filed: Jun. 4, 2021

Related U.S. Application Data
(60) Provisional application No. 63/034,493, filed on Jun. 4, 2020.

(51) Int. Cl. A01B 79/02; A01C 7/06; A01C 7/18; G06F 3/0482

(52) U.S. Cl. CPC A01B 79/02; G06F 3/0482; A01C 7/18; A01C 7/06

(57) ABSTRACT

Described herein is a farm management system and related apparatus and operations including providing environmental monitoring and control systems, tracking seed sources, managing cultivation, growth, and harvest, improving enclosure operations, and managing system data. Example farm management systems may include a physical growing unit, a capacity control circuit structured to interpret a growing capacity description, and a growth support circuit structured to determine a planting instruction value in response to the growing capacity description. The physical growing unit may be responsive to the planting instruction value to initiate a growing support operation.

### CLAIM TO PRIORITY

This application claims the benefit of priority to the following provisional application, which is hereby incorporated by reference in its entirety: U.S. Ser. No. 63/034,493, filed on Jun. 4, 2020 and entitled “Farm Management System” (AQUA-0003-P02).

### BACKGROUND

The present disclosure relates to, but is not limited to, a farm manager application for managing aspects of an indoor farm.

### SUMMARY

An example farm manager application facilitates managing operations and parameters of a vertical indoor farm, including providing environmental monitoring and control systems, tracking seed sources, managing cultivation, growth, and harvest, and improving and/or optimizing enclosure operations. The example farm manager application further manages collection, storage, access, and access control for data relating to the vertical indoor farm.

### BRIEF DESCRIPTION OF THE FIGURES

The disclosure and the following detailed description of certain embodiments thereof may be understood by reference to the following figures:

FIG. 1 depicts an embodiment of a farm management system.

FIG. 2 depicts an embodiment of a farm management system.

FIG. 3 depicts an embodiment of a farm management system.

FIG. 4 depicts an embodiment of a farm management system.

FIG. 5 depicts an embodiment of a physical growing unit.

FIG. 6 depicts an embodiment of a growing support operation.

FIG. 7 depicts an embodiment of a growing capacity description.

FIG. 8 depicts an embodiment of a farm management system.

FIG. 9 depicts an embodiment of a planting instruction value.

FIG. 10 depicts an embodiment of a harvest characteristic.

FIG. 11 depicts an embodiment of a plant request description.

FIG. 12 depicts an embodiment of a farm management system.

FIG. 13 depicts an embodiment of a plant growing unit.

FIG. 14 depicts an embodiment of an outcome description value.

FIG. 15 depicts an embodiment of a nutrient mix value.

FIG. 16 depicts an embodiment of a physical growing unit.

FIG. 17 depicts an embodiment of distinctions of a nutrient mix value.

FIG. 18 depicts an embodiment of fluid paths between a nutrient monitoring sensor and a plurality of plant growing units.

FIG. 19 depicts an embodiment of a farm management system.

FIG. 20 depicts an embodiment of operations performed by a growing system improvement circuit.

FIG. 21 depicts an embodiment of a growth outcome value.

FIG. 22 depicts inputs to a learning algorithm.

FIG. 23 depicts an embodiment of a planting instruction value.

FIG. 24 depicts an embodiment of a target plant metabolite value.

FIG. 25 depicts an embodiment of a planting instruction value.

FIG. 26 depicts an embodiment of a target growth timing value.

FIG. 27 depicts an embodiment of a traceability request value.

FIG. 28 depicts an embodiment of a tracing protocol value.

FIG. 29 depicts an embodiment of a monitoring request value.

FIG. 30 depicts an embodiment of a monitoring protocol value.

FIG. 31 depicts an embodiment of an operation for initiating a growing support operation.

FIG. 32 depicts an embodiment of an operation for initiating a growing support operation.

FIG. 33 depicts an embodiment of an operation for providing a growing support operation command.

FIG. 34 depicts an embodiment of an operation for providing a growing support operation command.

FIG. 35 depicts an embodiment of an operation for providing a growing support operation command.

FIG. 36 depicts an embodiment of an operation for providing a growing support operation command.

FIG. 37 depicts an embodiment of an operation for providing a growing support operation command.

FIG. 38 depicts an embodiment of an operation for determining a nutrient mix value.

FIG. 39 depicts an embodiment of an operation for determining a nutrient mix value.

FIG. 40 depicts an embodiment of an operation for determining a nutrient mix value.

FIG. 41 depicts an embodiment of an operation for adjusting a nutrient content value.

FIG. 42 depicts an embodiment of an operation for adjusting a nutrient content value.

FIG. 43 depicts an embodiment of an operation for adjusting a nutrient content value.

FIG. 44 depicts an embodiment of an operation for adjusting a nutrient content value.

FIG. 45 depicts an embodiment of an operation for adjusting a nutrient content value.

FIG. 46 depicts an embodiment of an operation for adjusting a nutrient content value.

FIG. 47 depicts an embodiment of an operation for adjusting a nutrient content value.

FIG. 48 depicts a screenshot of a cultivar page of a farm management application.

FIG. 49 depicts a screenshot of a page for editing cultivars of a farm management application.

FIG. 50 depicts a screenshot of a plantlets page of a farm management application.

FIG. 51 depicts a screenshot of a page for editing plantlets of a farm management application.

FIG. 52 depicts a screenshot of a transplants page of a farm management application.

FIG. 53 depicts a screenshot of a page for editing transplants of a farm management application.

FIG. 54 depicts a screenshot of a harvests page of a farm management application.

FIG. 55 depicts a screenshot of a harvests detail page of a farm management application.

FIG. 56 depicts a screenshot of a page for editing harvests of a farm management application.

FIG. 57 depicts a screenshot of an enclosures page of a farm management application.

FIG. 58 depicts a screenshot of an enclosures page of a farm management application.

FIG. 59 depicts a screenshot of an enclosures details page of a farm management application.

FIG. 60 depicts a screenshot of a data browser of a farm management application.

FIG. 61 depicts an embodiment of an operation for adjusting a nutrient content value.

FIG. 62 depicts an embodiment of an operation for adjusting a nutrient content value.

FIG. 63 depicts an embodiment of an operation for adjusting a nutrient content value.

FIG. 64 depicts an embodiment of an operation for initiating a growing support operation.

FIG. 65 depicts an embodiment of an operation for initiating a growing support operation.

FIG. 66 depicts an embodiment of an operation for initiating a growing support operation.

FIG. 67 depicts an embodiment of an operation for performing tracing operations.

FIG. 68 depicts an embodiment of an operation for performing tracing operations.

FIG. 69 depicts an embodiment of an operation for determining a monitoring instruction value.

FIG. 70 depicts an embodiment of an operation for determining a monitoring instruction value.

FIG. 71 depicts an embodiment of a farm management system.

FIG. 72 depicts an embodiment of an operation for iteratively adjusting a planting instruction value.

FIG. 73 depicts an embodiment of an operation for iteratively adjusting a planting instruction value.

### DETAILED DESCRIPTION

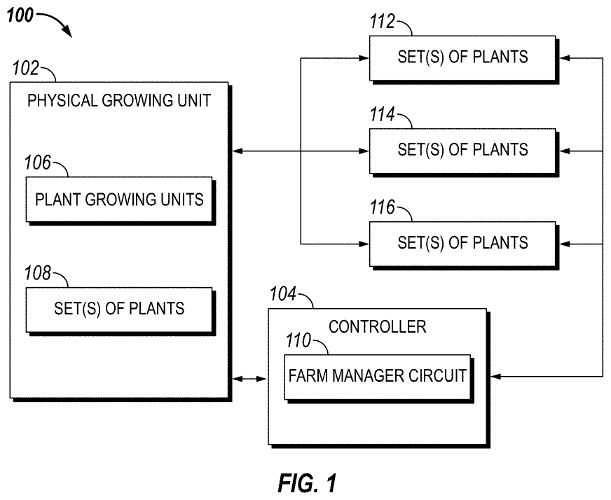

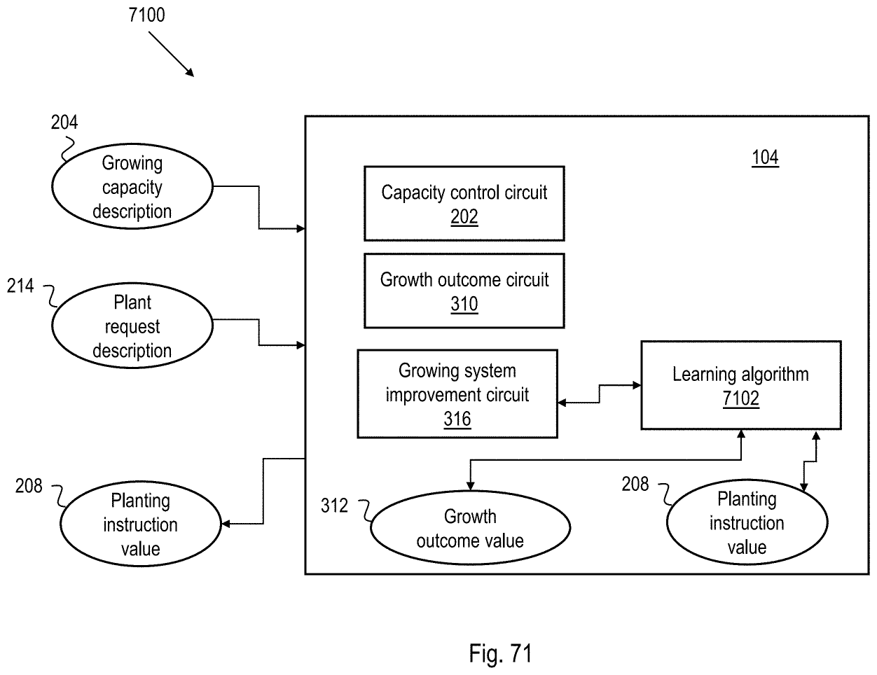

Referencing FIG. 1, an example system 100 includes an enclosed and/or indoor farm system. The example system 100 includes a physical growing unit 102, which encompasses the physical equipment that holds growing plants, and includes related hardware and components that perform the growing operations. An example physical growing unit 102 may be a vertical indoor farm, for example having a number of trays, shelves, and/or racks, where the vertical arrangement allows for more plants to be grown within a given floor space. An example physical growing unit 102 includes a number of plant growing units 106—for example enclosures having one or more racks, each rack having one or more shelves, and each shelf having one or more trays. In certain embodiments, the physical growing unit 102 includes lighting (e.g., configurable lighting based on intensity, frequency values/color, on/off schedules, etc.) which may be separately for each tray, shelf, rack, and/or enclosure, and which may be configured according to the type of plants, the growth stage of the plants, and the like, and which may be further adjusted by operations such as those described in relation to FIGS. 71-73. An example physical growing unit 102 includes a nutrient solution provided for the growing plants, for example within a tray housing the plant. In certain embodiments, the nutrient solution can be individually measured and adjusted for a selected subset of the physical growing unit 102, including for an enclosure, a rack, a shelf, and/or an individual tray. In certain embodiments, the physical growing unit 102 includes air management components, for example fans and/or compressed air to provide selected air movement, and/or HVAC components to provide temperature and/or humidity management.

In certain embodiments, the physical growing unit 102 includes a number of groups of plants 108 positioned therein. Each group of plants 108 may be a physical group of plants—for example all plants within a selected enclosure, planted at a selected time, within a selected rack, etc. Additionally or alternatively, the group of plants 108 may be a conceptual group of plants—for example all plants planned to provide a selected harvest product, to fulfill a selected order, etc.

The example system 100 further includes a controller 104 communicatively and/or operatively coupled to the physical growing unit 102. The example controller 104 is depicted as a distinct, single device, that is separate from the physical growing unit 102. As set forth throughout the present disclosure, aspects of the controller 104 may be distributed among multiple devices, may be positioned in whole or part within the physical growing unit 102, and/or may be embodied, at least in part, as a sensor, actuator, logic circuit, and/or instructions stored on a non-transient computer readable medium.

The example system 100 further includes a number of user interfaces, such as a supplier user interface 112, an operator user interface 114, and/or a buyer user interface 116. In certain embodiments, the controller 104, and/or a farm manager circuit 110 of the controller 104, exercises the interfaces 112, 114, 116 to perform selected operations, including providing information to users, allowing users to request information, allowing users to order harvest products, allowing users to order cultivars and/or seeds, and the like.

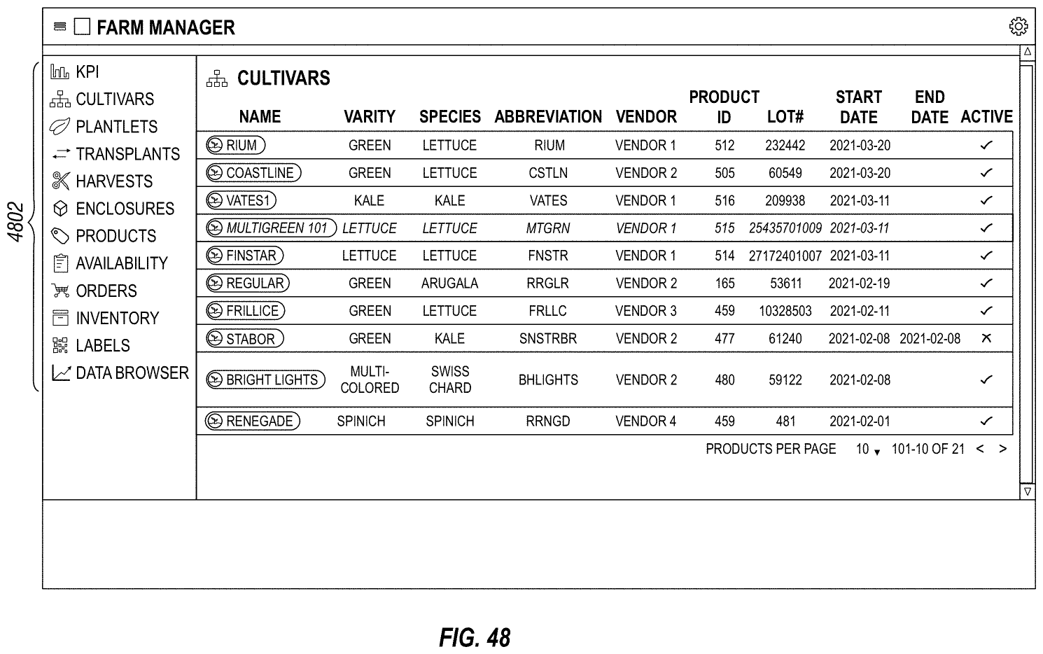

Referring to FIGS. 48 to 60, a number of user interfaces are depicted, showing example interfaces that may be utilized as a part of a supplier user interface 112, an operator user interface 114, and/or a buyer user interface 116. The interfaces 112, 114, 116 are illustrative examples to depict certain aspects of the present disclosure, and are non-limiting. Further, a given interface may have more or fewer options, and/or may have selections unavailable, not depicted, or the like, based on the type of interface (e.g., user, buyer, operator, or other) and/or the authorization of a user accessing the interface. In certain embodiments, a farm manager application (e.g., executed in whole or part with a farm manager circuit 110) may be used to organize and manage a physical growing unit (e.g., including an indoor vertical farm), to manage and/or track inventory, trace seed stock, determine transplant and harvest times, assist with management and tracking of transplant and harvest events, to manage environmental and/or operational parameters of enclosures, and the like. In certain embodiments, the farm manager application may be a cloud-based application, an internet based application, a web portal, a mobile application, and/or a dedicated application (e.g., for a desktop, laptop, and/or tablet, etc.) to facilitate remote management, quick response times, collaboration, and sharing.

Referencing FIG. 48, an example farm manager application includes a main navigating menu 4802 having a number of categories (e.g., “cultivars,” “plantlets”, etc.). In the example of FIG. 48, the “cultivars” category is selected, and data depicted provides cultivar information according to the user and interface type being accessed. In the example of FIG. 48, cultivar inventory and supplier information is depicted, for example as a part of an operator user interface 114. In certain embodiments, the cultivar category may depict different information for a buyer user interface 116 (e.g., cultivar listings, order parameters, etc.) and/or for a supplier user interface 112 (e.g., information may be limited to the specific supplier or vendor, and/or may include order information, status information, etc.).

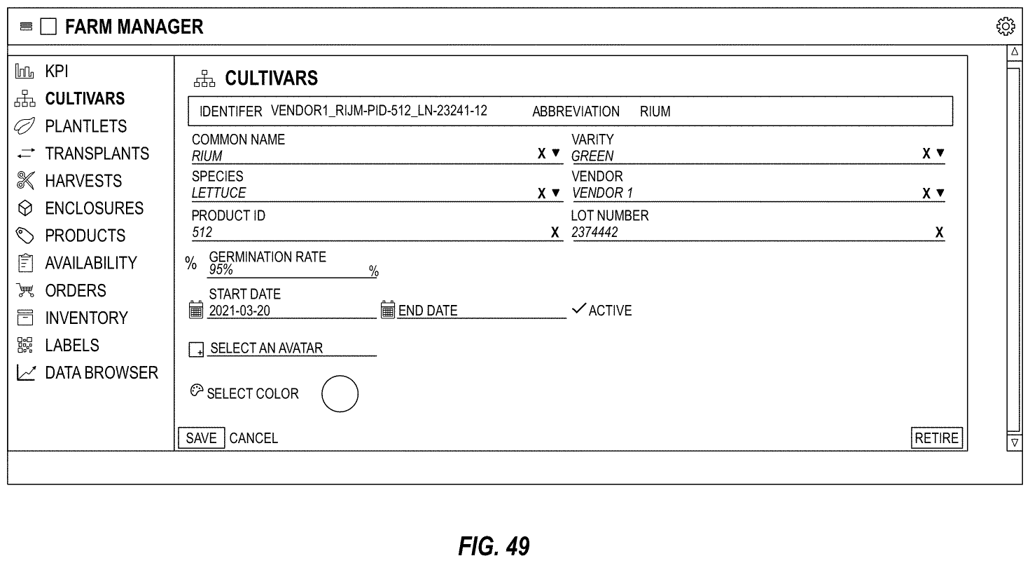

In the example of FIG. 48, cultivar management is facilitated by being able to trace seed stock from the date of first use. The farm manager application can track various cultivar parameters including name, an image of the cultivar, a color coding, variety, species, abbreviation, vendor, product ID, germination rate, lot number, start date (e.g. first use of the lot of seed), end date, and whether or not the cultivar is active, or the like. Referencing FIG. 49, an example detail of a cultivar from the list in FIG. 48 is depicted, which may be accessed, for example, by selecting the cultivar, cultivar ID, or other element on the interface of FIG. 48. The detail information in the example of FIG. 49 may be looked up information, and/or may be editable on the interface (e.g., depending upon the permissions of the user, etc.). The cultivar management data such as depicted in FIG. 49 may be used in inventory management for seeds. In certain embodiments, some of the information of FIG. 49 may be provided by a supplier/vendor, and/or taken from information (e.g., a specification sheet) provided by the supplier/vendor.

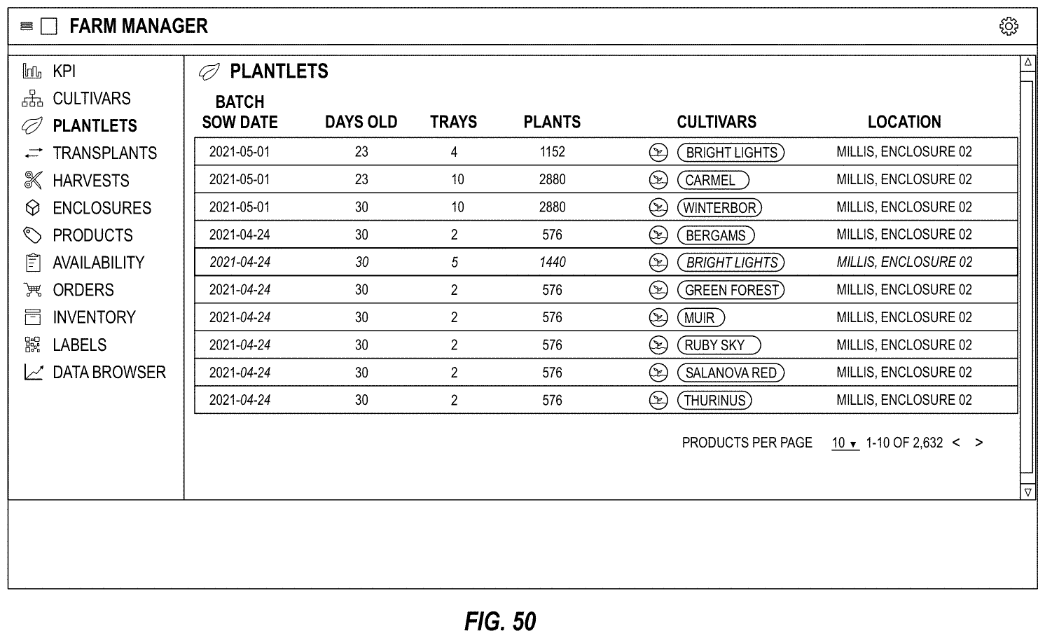

Referring now to FIG. 50, cultivars are germinated to form plantlets, in embodiments in a germination unit configured to optimize germination. FIG. 50 depicts an example interface where the plantlet category is selected at the top level. In the example of FIG. 50, plantlets are tracked so that at any point in time, an operator can see the batch sow date, how many days old the plantlets are, what tray(s) the plantlets are on, how many total plantlets associated with the cultivar are in the germination unit, and which location the plantlets are in. These data may be associated with a shelf or tray tag affixed or disposed near the plantlets. The tag may have a pattern that when scanned, recalls the relevant data from the farm manager application. The pattern can be anything, including barcodes (2D, 1D, linear, Code 39, 93, 128, data matrix), QR codes, graphics, logos, symbols, images, characters, or the like. In embodiments, the tag may be an RFID or NFC device that may be interrogated for information. In embodiments, when a user interacts with a tag, they may be able to access data, indicate an operation has commenced, receive information about planned operations, receive or access camera/video monitoring events. In certain embodiments, aspects of the data depicted in FIG. 50, and/or all of the data depicted in FIG. 50, may be associated with a particular growing event, order, or the like. In certain embodiments, a learning algorithm 7102 utilizes information such as that depicted in FIG. 50 to determine correlations and/or detect patterns, for example using time information to determine which enclosures and/or plantlets may have been affected by an event or disturbance, where potentially affected plantlets were in the growth cycle, etc.

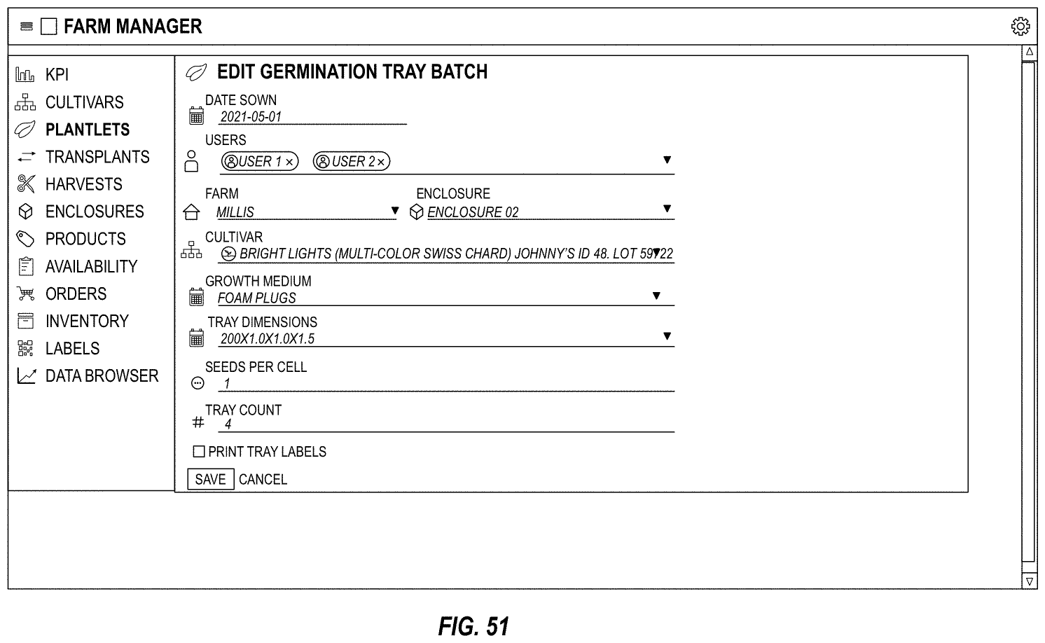

FIG. 51 depicts an example interface where a specific tray has been selected, for example by selecting a tray, cultivar, or other element from the interface of FIG. 50. The example interface of FIG. 51 provides information for a germination tray batch such as the date sown, users associated with or authorized to handle the plantlets in the germination tray, the farm where the plantlets are located, the enclosure in which the plantlets are located, the cultivar, the growth medium, the tray dimensions, the number of seeds per cell, the tray count, or the like. In certain embodiments, information on FIG. 51 may be edited, depending on the user permissions, for example. In certain embodiments, a tray label can be printed from the interface of FIG. 51, for example providing a convenient location where tray information can be confirmed and then the label created. In certain embodiments, the label may be printed or otherwise provided (e.g., on an electronic display located in proximity to the tray, such as on a shelf above or below the tray) at the tray location—for example at an enclosure where the tray is positioned.

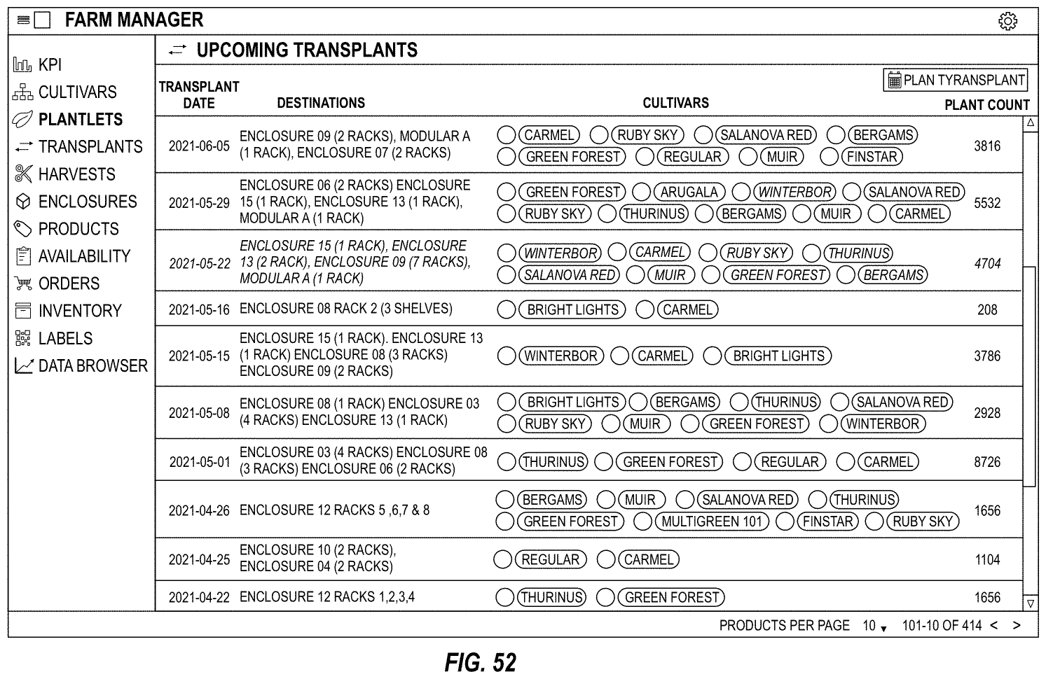

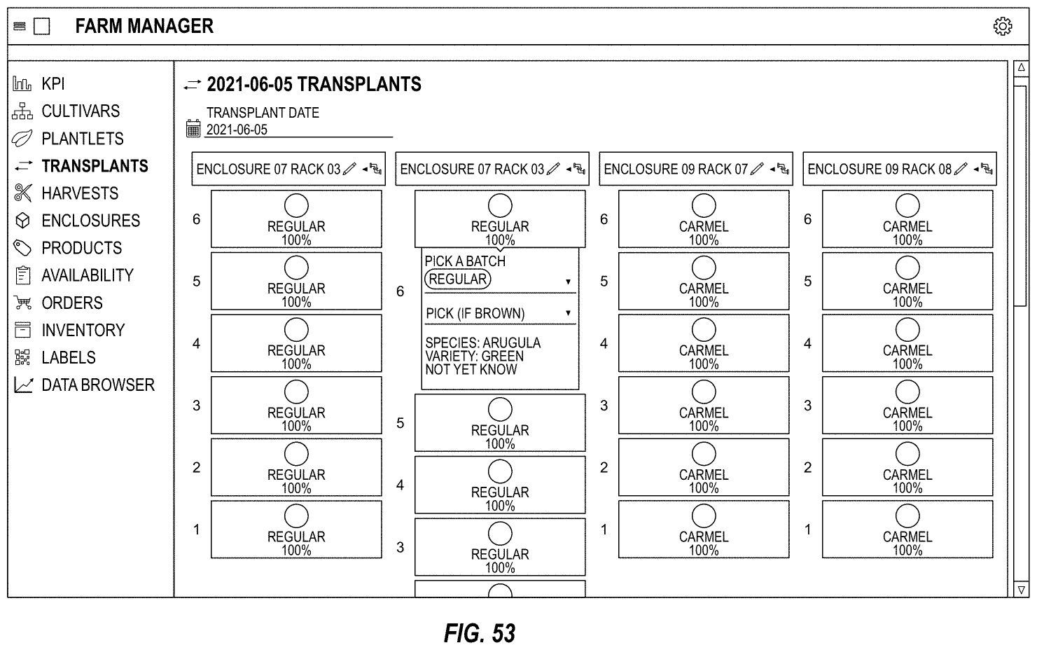

Referring now to FIG. 52, an example farm manager application interface for transplants is depicted, for example utilized to plan which cultivar goes in which shelf, or which portion of a shelf. The new plantlets are placed into a plantlet development unit (PDU) configured to optimize plant growth, for example as one enclosure of the physical growing unit. On a user interface of a device executing the farm manager application, the upcoming transplants page shows data on planned transplants including the identified or projected transplant date, the destination or destinations receiving the transplant, the cultivar being transplanted, a plant count, and the like. From the user interface shown in FIG. 52, a user can initiate transplant planning, and/or adjust transplant operations. Referencing FIG. 53, a screen for planning transplants is shown. An example farm manager application interface accesses the interface of FIG. 53, for example by selecting a transplant date in the interface of FIG. 52. An identified or projected transplant date can be entered and an image of each rack and each tray on the rack in the enclosure is shown with what plants are currently residing on the rack or scheduled to be transplanted into the rack. Users may use data entry, including drop-down menus, to indicate a plan for transplant, including which cultivars will be transplanted, which batch (if shown), what the species is and variety are, and if it has been sown already. Transplant planning allows for estimates of how many trays of plantlets to cut to support number of seedlings needed to transplant and to automate task management, such as allocation of sowing tasks.

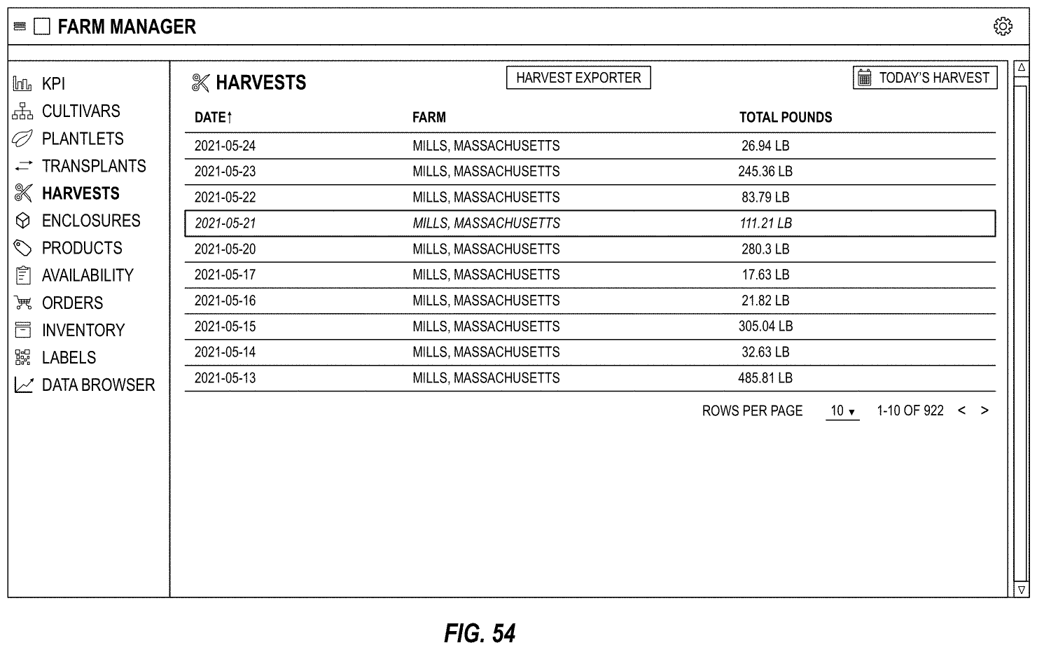

Referring to FIG. 54, harvests may be tracked and planned in the farm manager application, including harvest date, farm, harvest weight, and the like. The example interface of FIG. 54 may be accessed by selected the top level Harvests category from any farm manager screen. The interface of FIG. 54 may be utilized to initiate, confirm, and/or view harvest operations. The capabilities of user operations using the interface of FIG. 54 may be scheduled according to permissions associated with the user. An operator may indicate they are harvesting a set of plants by interacting with a shelf or tray tag and indicating that the plants on that shelf or tray are being harvested. In an embodiment, the user may be shown the shelf or tray they are harvesting on a user interface. The application may automatically update a database with the detail that the plants are being harvested. Total weight of the harvest may be manually entered or may be automatically entered by using a wirelessly connected scale that feeds data into the application.

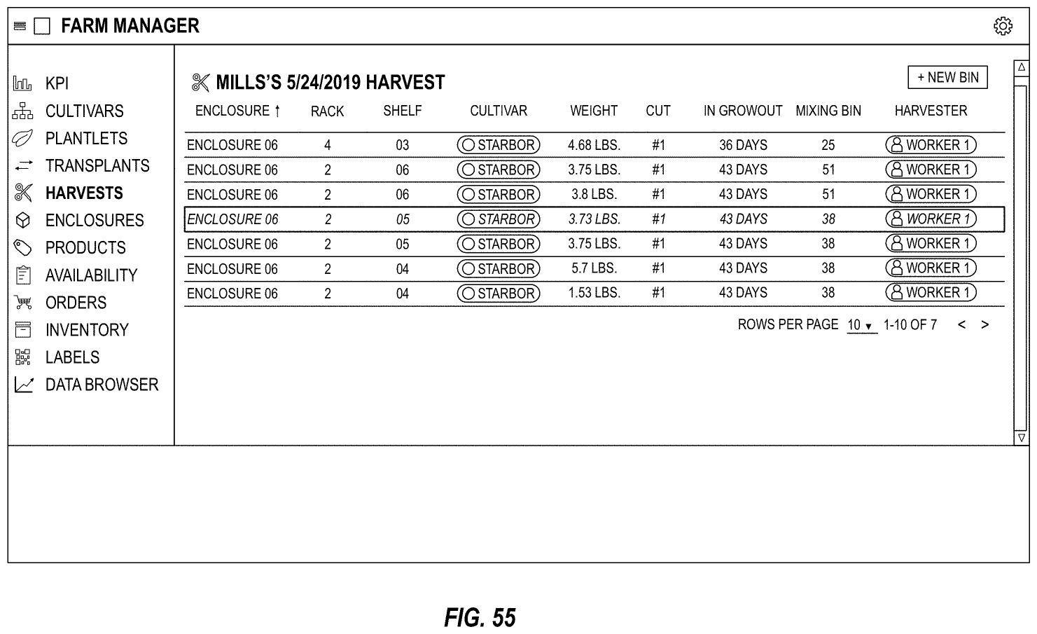

For each harvest entry, more granular detail may be available such as shown in FIG. 55, which may be accessed, for example, by selecting a harvest line item on the interface of FIG. 54. Information depicted in the example interface of FIG. 55 includes which enclosure the harvest was from, the rack, the shelf, the cultivar, the weight of the harvest, which cut number the plant is on, how many days of growth the plant has experiences, which mixing bin the harvest product went to, the harvester, images or video of the harvest process, images or video of the plants before and after harvest, and the like. In embodiments, multiple shelves might end up in the same mixing bin. Users may be able to quickly see more information about Today's Harvest through the application. In an embodiment, the efficiency and progress of harvest may be monitored using the application. For example, two people may indicate that they are harvesting at the same time on a shelf, each starting on a separate end, and a map of the shelf may be updated with the progress of harvesting from one end of shelf to other as they use shelf or tray tags to check or indicate progress. Images of harvesting may be used to check for variability of the harvester.

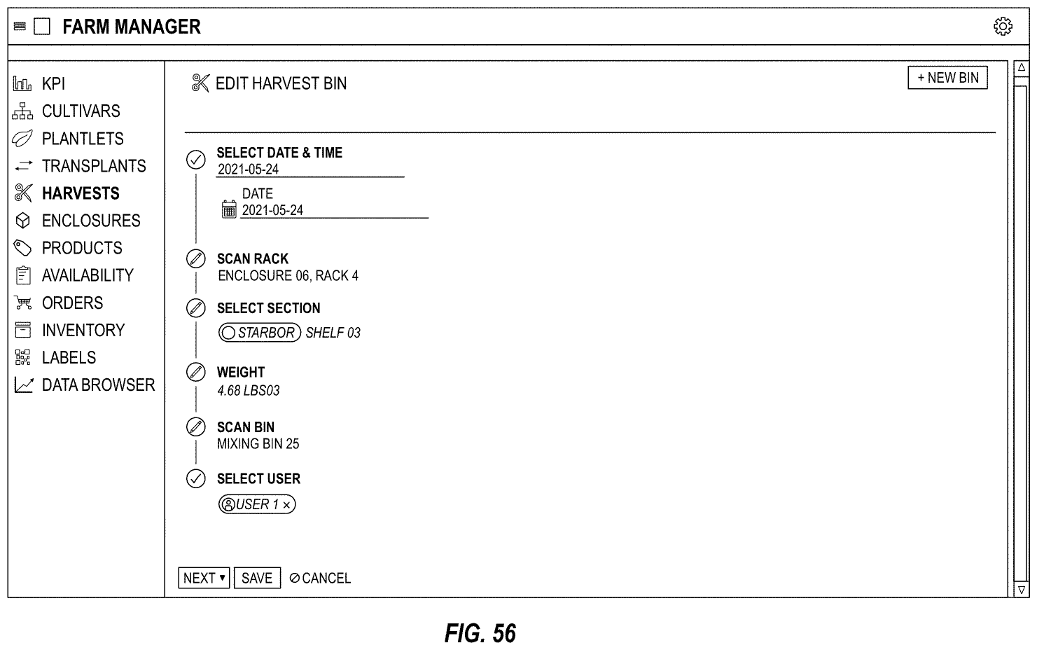

Referring to FIG. 56, individual harvest bins may be edited, such as by selecting a date and time of harvest, a rack, a section of rack, a tray, a weights of the harvest, a bin the harvest was placed in, or the like. In certain embodiments, the interface depicted in FIG. 56 may be accessed by selecting a harvest bin in the interface depicted in FIG. 55.

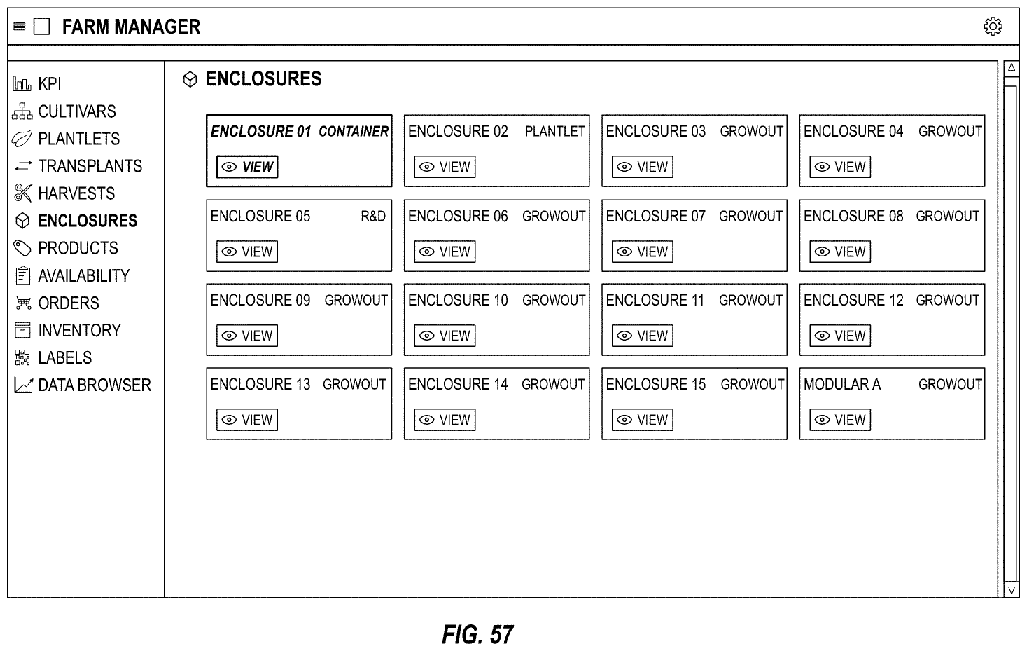

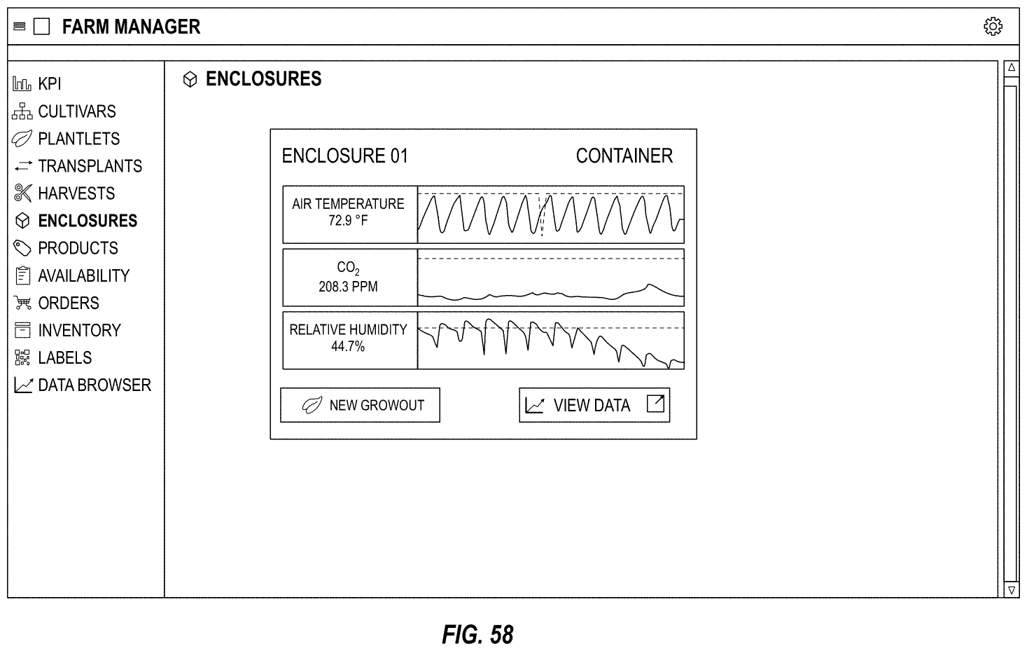

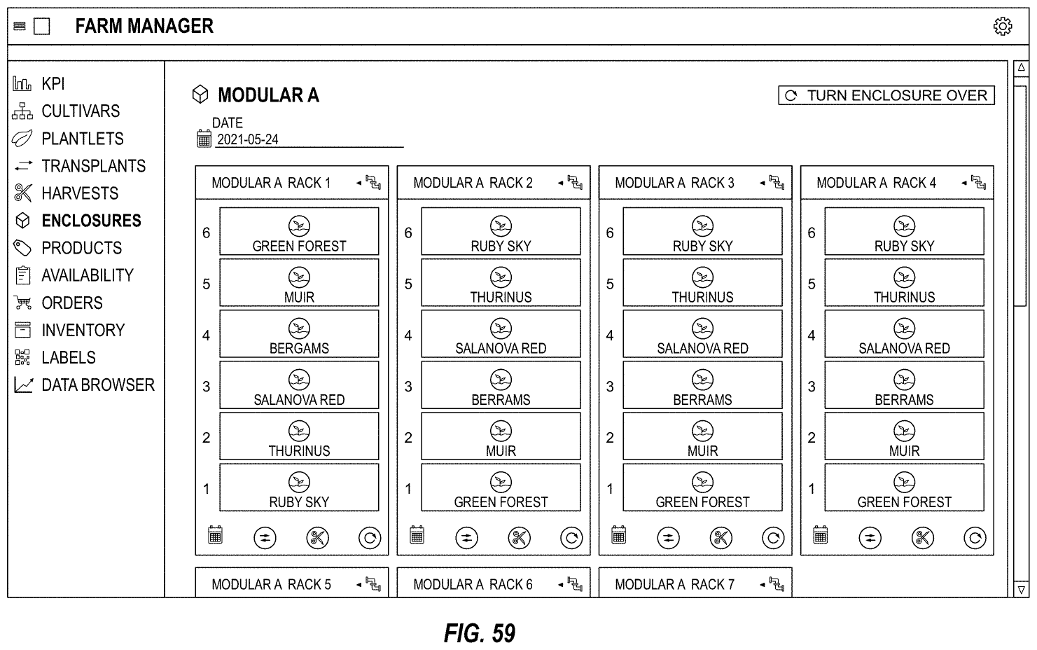

Referring to FIG. 57, conditions for the enclosures may be accessed, for example by accessing the top level Enclosures category from any farm manager screen. The example of FIG. 57 depicts a high level view of all enclosures, for all enclosures of a physical growing unit, and/or all enclosures of a particular type (e.g., germination, plantlet, etc.). In certain embodiments, a more detailed view of one or more disclosures (e.g., reference FIG. 58) may be depicted by selecting the enclosure, making a selection near the enclosure (e.g., the “view” button depicted in the example of FIG. 57), or the like. Referring to FIG. 58, information about each enclosure may be available, including the type of operation, temperature, lights status, humidity, oxygen levels, carbon dioxide levels, and the like. The selected/displayed information in FIG. 58 may depend on the type of enclosure, user selections for information to be depicted, and/or user permissions to see certain types of data. The examples of FIGS. 57-59 are organized around an enclosure, but may additionally or alternatively be organized around any other physical aspect of the physical growing unit (e.g., a rack, shelf, tray, etc.) and/or around any other conceptual aspect of the physical growing unit (e.g., a group of plants 108, a specific order and/or harvest product, etc.). In FIG. 59, an enclosure details screen for one of the enclosures is shown. In this view, details regarding all of the racks, shelves, and trays in the enclosure may be accessible and various operations may be possible, such as exchanging or editing rack details, or turning the enclosure over and clearing data (e.g., from the display, where the data may be stored for at least a selected period of time after clearing, for example to be utilized for auditing, certification, learning algorithm 7102 operations, etc.), such as when the harvest(s) are complete or the plants are otherwise no longer growing.

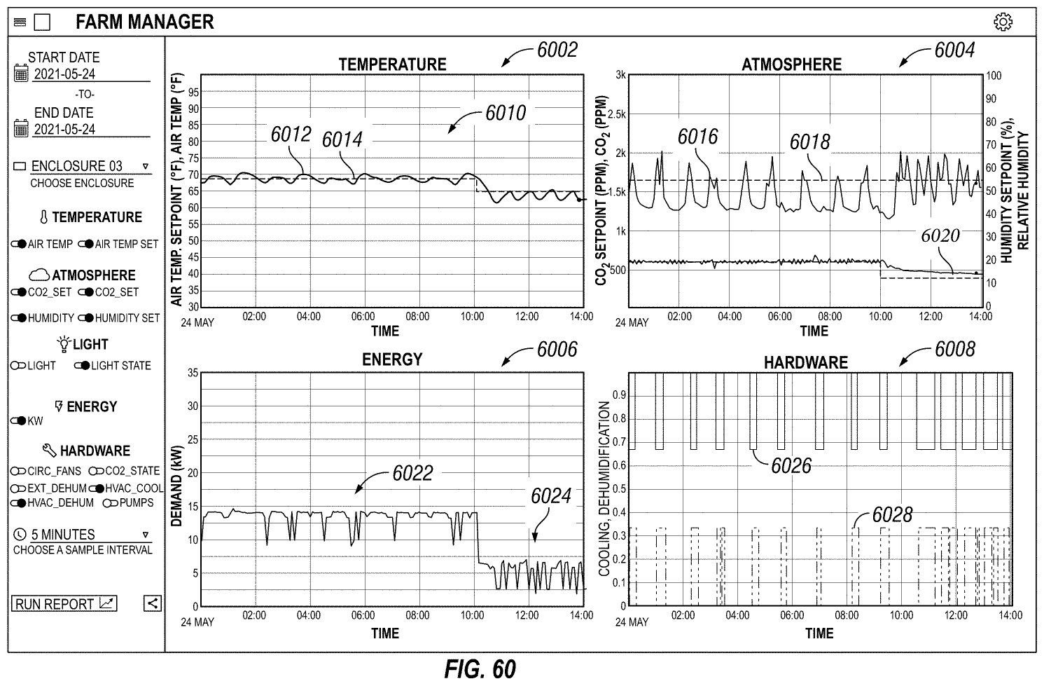

Referring to FIG. 60, a data browser interface is shown depicting illustrative data. The physical growing unit, indoor farm, and/or various elements therein may be monitored by sensors. The sensors may take data periodically, such as every 30 seconds. Without limitation to any other aspect of the present disclosure, sensors may include air temperature, carbon dioxide levels, relative humidity, light intensity, energy expended, operational status of hardware (e.g. cooling HVAC, dehumidifying HVAC, pumps, external dehumidification, circulating fans, etc.), fluid composition, flow rates, weight sensors (e.g., a digital scale), or the like. Additionally, parameters may be electronically stored. Any known or sensed parameters can be displayed by the data browser for any desired time interval. The data browser may be used to generate associations between output and various parameters of growth or operation of the farm, such as to be able to predict an output or plan a starting number of cultivars to reach a target output. In the example of FIG. 60, a first data view 6002 depicts a temperature trace 6010 for a selected enclosure (e.g., “ENCLOSURE 03” in the example) and a selected date range (e.g., 24 May 2021, in the example). In the example data view 6002, a temperature set point 6014 is depicted, and which is shown to change at about 10:00 AM in the example. In the example data view 6002, the measured temperature 6012 is depicted, which tracks the temperature set point 6014. Further to the example of FIG. 60, a second data view 6004 depicts an atmospheric composition for the selected enclosure, with a CO2 set point 6018 and measurement trace 6016 depicted above, and a humidity set point (unlabeled) and measurement trace 6020 depicted below. Further to the example of FIG. 60, a third data view 6006 depicts an energy demand associated with the selected enclosure. In the example third data view 6006, the energy trace 6022 experiences a significant drop at about 10:00 AM to energy trace 6024, for example due to the change in temperature set point 6014 from the first data view 6002. Further to the example of FIG. 60, a fourth data view 6008 depicts an operating status of certain hardware, such as cooling hardware 6026 (e.g., based on a compressor state) and/or dehumidification hardware 6028. The example data views 6002, 6004, 6006, 6008 are illustrative and non-limiting. In certain embodiments, various data options, such as data depicted, arrangement of views, sampling intervals depicted, etc. are available on the interface, such as on the left-side menu panel. In certain embodiments, operating adjustments may be performed from the farm manager application, for example moving a set point by dragging it on the data view, selecting it and entering a change in a next menu (not depicted), or the like. In certain embodiments, reports may be generated from the interface, for example selecting the “RUN REPORT” option on the left-side menu panel.

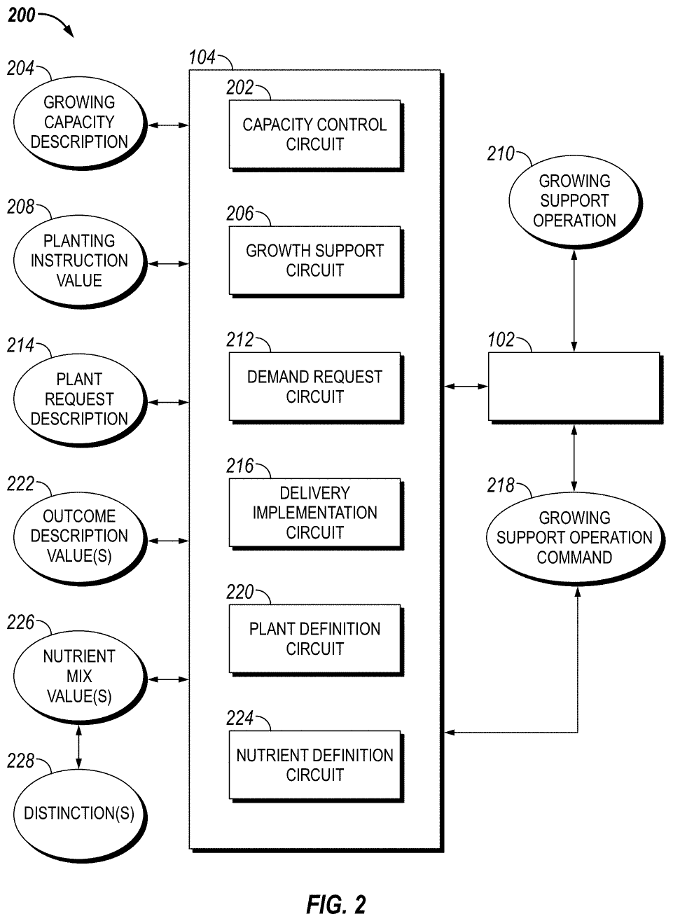

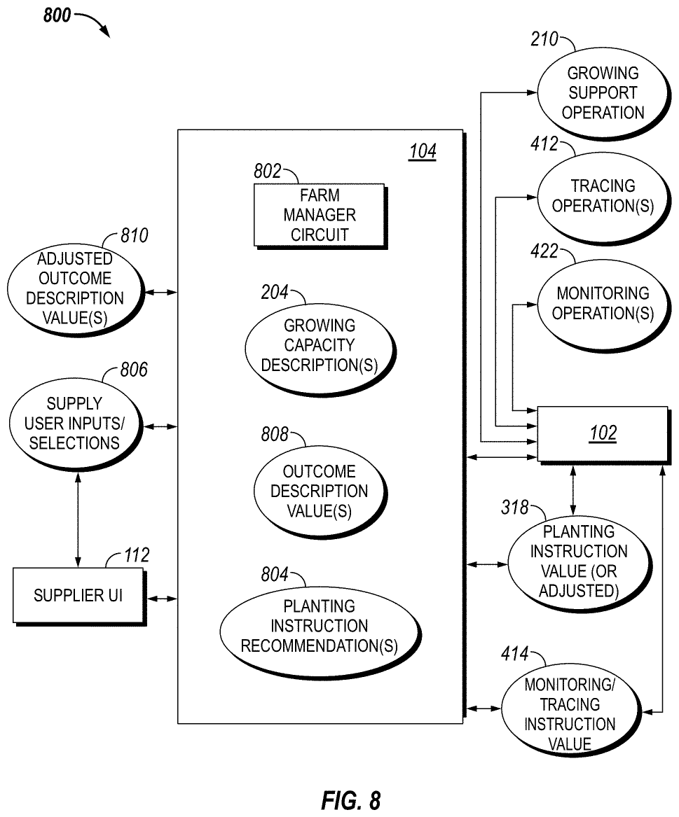

With reference to FIG. 2, an illustrative and non-limiting farm management system 200 is depicted. The example system may include a capacity control circuit 202 structured to interpret a growing capacity description 204, a growth support circuit 206 structured to determine a planting instruction value 208 in response to the growing capacity description 204, a farm manager circuit 110 (as shown by example in FIG. 1) structured to receive an input 806 (as shown by example in FIG. 8) from a supply user and to adjust the planting instruction value 208 in response to the input, and a physical growing unit 102 (as shown by example in FIG. 1) responsive to the planting instruction value 208 to initiate a growing support operation 210.

Example embodiments depicted throughout the present disclosure are presented with a controller 104 (e.g., reference FIG. 1) having a number of circuits configured to functionally execute operations of the controller 104. A controller, processor, application, circuit, computer, computing device, or other similar terms (“controller”) as utilized herein should be understood broadly. An example controller may be a single device such as depicted in FIG. 1 herein, but may additionally or alternatively be distributed among several devices, and/or portions thereof (e.g., a single circuit of the controller) may be distributed among more than one device. Example controller embodiments include any hardware such as a sensor, an actuator, a logic circuit, hardware configured to be responsive to stimuli (e.g., a sensor and valve configured to maintain a set point), and/or interfaces to any one or more of these. Example controller embodiments including computing resources (e.g., a processor, memory, and/or communication resources) and instructions stored on a non-transient computer readable medium configured such that the computing resources executing the instructions thereby perform one or more operations of the controller. A given controller aspect, such as a particular circuit, may be described in a particular context and embodiment for clarity of the present description, but any controller aspect set forth herein may be utilized as a part of any controller, system, application, or apparatus set forth herein. Additionally or alternatively, any controller or aspect thereof of the present disclosure may be utilized, in whole or part, to perform one or more operations of any method, procedure, or operational function of embodiments described herein. In certain embodiments, aspects of a controller may be positioned on a physical growing unit, a user device (e.g., a supplier device, consumer device, operator device, or the like), and/or a dedicated computer (e.g., a computer associated with a growing facility, vertical farm, physical growing unit, or the like). In certain embodiments, an aspect of a controller may be distributed between more than one device, and/or may be present on more than one device (e.g., a circuit positioned at least partially on multiple user devices).

In some embodiments, the input 806 may relate to a harvest capacity. Example harvest capacity parameters include one or more of a harvest amount, a certification, a verification, a nutrient content, a cultivar, or a cut limitation. As used herein, a harvest amount may include any description of a harvest that is relevant to the respective user—for example a harvesting weight for a cultivar of interest and/or to service a particular order, a harvested plant count (e.g., a number of tomatoes), a harvested volume, or the like. In certain embodiments, a harvest amount for a same harvesting event may be the same or distinct for different users—for example an operator user (e.g., a user responsible for operations of a physical growing unit) may associate a first harvest amount with the harvest event that is distinct from a harvest amount for that harvesting event that might be determined by another user—for example to account for expected losses, drying, shipping efficiencies, etc. In certain embodiments, a harvest amount may be a quantitative value (e.g., a number of kilograms harvested) or a qualitative value (e.g., an indication that the harvest event yielded a sufficient quantity according to an ordered amount, reflecting a desired harvesting efficiency, or the like). A certification, as utilized herein, relates to any constraints, requirements, or other criteria for harvested plants, for example and without limitation a certification that the harvested plants are kosher, organic, prepared without the use of certain chemicals, utilize correct cultivars, have particular nutrient profiles, or the like. A certification may be associated with a voluntary characteristic of the harvested plants, and/or may be associated with compulsory requirements such as a regulation, specified requirements by a regulatory body, or the like. A verification, as utilized herein, relates to information utilized to determine that an aspect of the harvested plants meets predetermined criteria, and may further include underlying information utilized to infer and/or confirm that the desired aspect has been achieved. A verification may relate to a certification (e.g., data captured that promotes certainty that the certification is proper), but may additionally or alternatively relate to any aspect of the planting, growing, and harvesting process. A nutrient content, as utilized herein, references an amount of a nutrient present within any aspect of a physical growing unit, including at least nutrients present in feed stock, plants at any stage (e.g., seedlings, plantlets, and/or full plants), fertilizer compositions, water compositions, or the like. A nutrient content may be a desired range, a minimum value, a maximum value, or the like. In certain embodiments, a nutrient content may reference a composition value related to the plant growing medium (e.g., the nutrient fluid utilized for the plant), an air volume, and/or within the plants themselves (or portions thereof, such as in fruit, leaves, stems, seeds, and/or roots). A cultivar, as utilized herein, references a particular variety of a plant, for example as the plant is referenced by a supplier, consumer, regulatory body, seed provider, or the like. A cut limitation, as utilized herein, references a number of times that a plant can be harvested from a single seed growth event. In certain embodiments, a harvested plant cannot be re-grown, and is limited to a single cut. In certain embodiments, a plant can be re-grown after harvest, allowing for a second cut to be performed from the same plant. In certain embodiments, multiple cuts can change aspects of the plant and/or harvesting product of the plant, for example generating a distinct nutrient profile, taste, or other aspect of later cut harvesting products relative to earlier cut harvesting products. Certain embodiments of the present disclosure allow for a greater range of cut capability, including the use of multiple cuts for a particular plant, reducing cost and emissions to produce a given harvest amount over a life cycle of the physical growing unit, while maintaining commercially viable harvest products from multiple cut plants. In certain embodiments, the quality of a later cut plant can be maintained relative to a first cut, and in certain embodiments the quality of a later cut plant can be sufficiently maintained for certain uses, which may not be sufficient for other uses. For example, a first cut harvesting operation on a plant may be utilized to fulfill an order having a first certification, while a later cut harvesting operation on the plant may provide harvest products that meet the first certification, or that do not meet the first certification but are nevertheless commercially viable for a different type of use or certification.

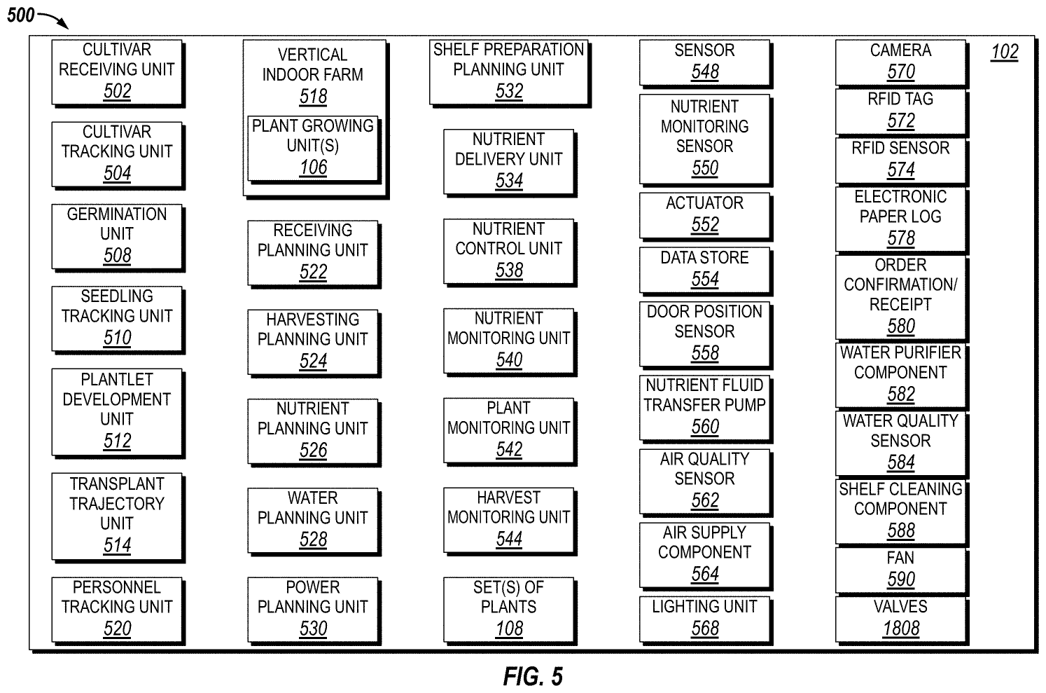

With reference to FIG. 5, which is a depiction of an illustrative and non-limiting physical growing unit 102, the physical growing unit 102 may include one or more sets of plant(s) 108. The one or more sets of plant(s) 108 each include any related group of plants, which may be related for various reasons as set forth throughout the present disclosure, where the relationship of the group may be physical (e.g., location, tray, shelf, rack, etc.) and/or conceptual (e.g., a group of plants that contribute to fulfill an order, utilize a related nutrient, etc.). A set of plants 108 as utilized herein provides for clarity of the present description to demonstrate a number of operations herein, but a given system may not have any set of plants 108 identifying a related group of plants. In certain embodiments, a given group of plants may be a part of a same set of plants 108 at certain times, operating conditions, and/or for certain purposes, but may not be a part of the same set of plants 108 at another time, operating condition, and/or for another purpose. For example, a first cultivar and a second cultivar positioned in a same tray may be a part of a first set of plants 108 (e.g., organized by physical location or tray) for a first purpose and/or for a first operating condition, but not for another purpose or operating condition. In a further example, the first and second cultivars may be a part of the first set of plants 108 for nutrient delivery to the same tray, but not a part of the same set of plants 108 for another purpose such as harvest planning (e.g., where the cultivars are dedicated to separate orders, utilize different harvesting personnel or equipment, etc.). In a further example, the first and second cultivars may be moved to separate trays at a subsequent operating condition (e.g., moving from a germination unit to a plantlet development unit).

The example physical growing unit 102 may include one or more enclosures—for example green house units, physical spaces separated from the environment, or the like. In certain embodiments, plants are transferred between enclosures at selected stages, for example moving from a first enclosure at a seedling stage to a second enclosure at a plantlet stage. In certain embodiments, a plant is developed through more than one stage, or all stages, within a single enclosure. An example physical growing unit 102 includes a vertical indoor farm 518, for example including a number of racks, with plants on each rack, where the plants may be provided on trays or other growing containment units, and exposed to a nutrient solution. The vertical arrangement of the rack shelves and/or trays allows for a higher density of plant units to develop within a given floor space area. An example physical growing unit 102 includes one or more plant growing units 106, which may be a subset of the plants (at any stage) growing within the physical growing unit 102, and organized—physically or conceptually—as a unit for various purposes as set forth herein, including at least providing coordinated nutrition, coordinated movement, coordinated harvesting, coordinated monitoring, or the like for the plants of the plant growing unit 106. For example, a plant growing unit 106 may include the plants of a shelf, the plants of a rack, the plants of a tray, the plants for a particular order, and/or the plants of a particular cultivar and/or growing stage. An example plant growing unit 106 includes an enclosure having a number of racks, a number of shelves on each rack, and one or more tray(s) on each shelf. In a further example, a number of enclosures provided together form the physical growing unit 102, where each enclosure is at least partially environmentally separated from the other enclosures, and from the surrounding environment at the physical growing unit.

An example physical growing unit 102 includes a cultivar receiving unit 502—for example to receive cultivars provided by a supplier or the like, which may include trays, racks, shelves, and/or dedicated enclosure(s) where initially received cultivars are placed. The cultivar receiving unit 502 may have predetermined conditions (e.g., lighting, temperature, air composition, etc.), for example conditions that promote or inhibit germination and/or growth of the cultivar. An example physical growing unit 102 includes a cultivar tracking unit 504, which may include sensors, monitors, and/or stored information for tracking cultivars in the physical growing unit 102. Example and non-limiting aspects that may embody the cultivar tracking unit 504 include sensors (e.g., temperature, lighting, air composition, nutrient solution composition, bar code, RFID, etc.) monitoring a condition of the cultivar receiving unit 502, and/or cameras (e.g., providing images of cultivars, seedlings, etc., of personnel interacting with plants, and/or of environmental conditions related to the plants). In certain embodiments, stored data may be captured and associated with the cultivar(s) and/or a plant growing unit 106 and/or other group of cultivars to be tracked together. The stored data may be utilized in any system, apparatus, procedure, or other embodiment of the present disclosure, for example as a part of a certification operation, verification operation, continuous improvement operation, or the like. An example physical growing unit 102 includes a germination unit 508, for example utilized to bring a cultivar to the seedling stage and/or plantlet stage, and which may be a same or distinct enclosure to the cultivar receiving unit 502. Accordingly, a same enclosure may be a cultivar receiving unit 502 at a first time and/or operating condition, and a germination unit 508 at a second time and/or operating condition. Additionally or alternatively, a same enclosure may be a cultivar receiving unit 502 for a first plant growing unit 106, and a germination unit 508 for a second plant growing unit 106, for example when the plant growing units are at distinct growth stages. An example physical growing unit 102 includes a seedling tracking unit 510, and/or a plantlet development unit 512. As described throughout, each development unit (e.g., germination unit 508, plantlet development unit 512, cultivar receiving unit 502, and/or vertical indoor farm 518) may be provided separately, and/or with a single physical embodiment (e.g., an enclosure with racks, shelves, and/or trays therein), and includes sufficient climate control capability (e.g., lighting, air composition and flow, temperature control, and/or humidity control) to perform the operations for the stages and cultivars to be utilized with the development unit. Additionally or alternatively, each development unit may be coupled to a tracking unit (e.g., cultivar tracking unit 504, seedling tracking unit 510, and/or personnel tracking unit 520) that monitors, captures, and/or stores tracking information for the coupled development unit.

An example physical growing unit 102 includes a transplant trajectory circuit 514 that performs operations related to execution and monitoring of cultivars (e.g., “transplants” brought in by a supplier, provided as a second cutting, etc.) through the physical growing unit 102. Example operations of the transplant trajectory circuit 514 include determining a schedule of one or more cultivars through each enclosure and/or development unit of the physical growing unit 102, and performing operations to implement the schedule—for example providing notifications, updating status parameters, lighting a status light (e.g., of an enclosure, and/or of a user interface such as on an operator UI 114), or the like. The schedule of the one or more cultivars can include time and/or date values, positions of the cultivar(s) (e.g., which enclosure the cultivar should be positioned within at each stage), environment values (e.g., temperature, lighting, humidity, air composition, etc.), nutrient values (e.g., nutrient solution compositions, thresholds, min/max values, etc.), monitoring values, or the like for a given cultivar, plant growing unit 106, etc. The example transplant trajectory circuit 514 may be positioned, in whole or part, on any controller 104, apparatus, system, etc. throughout the present disclosure. In certain embodiments, the transplant trajectory circuit 514 is responsive to instructions and/or commands from a controller 104, for example to implement planned movement, environmental conditions, monitoring, data capture, verification operations, and/or certification operations to implement operations of any embodiment of the present disclosure.

An example physical growing unit 102 includes one or more planning units, such as a receiving planning unit 522, harvesting planning unit 524, water planning unit 528, power planning unit 530, and/or shelf preparation planning unit 532. Any planning unit herein may include sensors, actuators, interface components (e.g., as a part of a user interface such as the operator interface 114), and/or include instructions and/or stored data provided as a non-transient computer readable element. Any planning unit herein may operate as a unit based planning unit (e.g., responsive to controller 104 instructions and/or commands to determine operations for a single unit such as a cultivar, order, rack, shelf, etc.), and/or as a part of a planning unit having a higher scope (e.g., responsive to controller 104 instruction and/or commands to determine operations for a subset of units (e.g., an enclosure, a group of racks and/or shelves, and/or a group of cultivars), and/or for all units within the physical growing unit 102).

The utilization of planning units allows for scaling strategic operations of the physical growing unit 102. For example, a high level control element may provide an overall target (e.g., a harvest amount of specified cultivars at a specific date), where the appropriate planning units operate to determine operations within the scope of the unit to support the overall target. In another example, a single control element may perform all planning and implementation operations, without the utilization of one or more planning units. Further, the utilization of planning units provides for a systematic implementation allowing for selected operations to control and operate the physical growing unit 102 responsive to growing support operation command(s), planting instruction value(s), monitoring instruction value(s), and/or tracing instruction value(s). The systematic implementation provides for a scaled integration of operations of the physical growing unit 102, for example changing parameters monitored, sensed, schedules, and/or nutrient mixes, and which can vary between enclosures, racks, shelves, trays, harvest products, etc. The planning units provide for an organizing conception of control implementation, but any one or more, or all, planning units may be omitted. Additionally or alternatively, the control scope of planning units may have overlap, gaps, or the like, for example where the controller 104 provides operations to manage conflicts, disambiguation, or the like, for operations performed by individual planning units.

An example receiving planning unit 522 determines one or more of shelf positions, environment variables, and the like for a cultivar/transplant receiving unit, such as a receiving enclosure, a germination closure, and/or a plantlet development enclosure. Example operations of the receiving planning unit 522 include, without limitation: managing capacity of the enclosure; rotation/utilization of shelves, trays, pumps, fans, lights, etc.; and/or determining timing and/or capacity of personnel utilization related to the enclosure(s). In certain embodiments, the receiving planning unit 522 determines implementation details based on monitoring parameters, for example directing a cultivar position to be on a tray/rack/shelf having a certain sensor type (e.g., where a parameter of the sensor is to be measured, and not all trays/racks/shelves have the sensor), directing a cultivar position to be visible to a camera (e.g., where one or more aspects of the growing and/or harvesting cycle are to be visibly measured), etc.

An example harvesting planning unit 524 determines one or more of shelf positions, harvest timing, environment conditions, etc. for a cultivar, order, rack, shelf, enclosure, or the like. Example operations of the harvesting planning unit 524 include, without limitation: scheduling harvest operations to be monitored according to a monitoring/tracing instruction value (e.g., images, weights, video, determination of personnel, determination of environment variables, and/or determination of any aspect of the harvest product); scheduling harvest operations according to a personnel requirement and/or schedule; and/or scheduling harvest operations in response to upstream capacity (e.g., freeing a tray/rack/shelf such that cultivars from another enclosure can be moved in) and/or a downstream capacity (e.g., scheduling a harvest operation according to storage capacity, transport capacity, packaging capacity, etc.).

An example nutrient planning unit 526 determines nutrient delivery operations to support the physical growing unit 102, including all related enclosures, shelves, racks, trays, etc. In certain embodiments, the nutrient planning unit 526 configures operations according to a capacity with the physical growing unit 102, for example delivery of nutrients to various components, storage capacity of nutrient products available on-site, and/or separation capability of nutrient delivery systems (e.g., where an unusual nutrient is to be provided to some but not all plants, and where capability may relate to the available number of separate systems and/or delivery capacity on each system).

An example water planning unit 528 determines water storage, treatment, recycling, and/or disposal operations to support the operations of the physical growing unit 102 and/or commands/instructions from the controller 104. The water planning unit 528 may include considerations specific to enclosures of the physical growing unit 102, for example individual water sourcing and return capacities, pressure and/or temperature requirements, treatment requirements, and the like. In certain embodiments, water treatment may be performed on source water—for example where local water includes one or more trace elements that are to be removed, and/or for control of scaling, algae growth, or the like. In certain embodiments, the water treatment capacity and/or storage capacity of treated water are considered by the water planning unit 528, and may be controlled by the water planning unit 528 and/or controller 104 (e.g., controlling the water level in a storage unit, controlling treatment operations and/or monitoring of treatment operations to ensure compliance, and/or controlling treatment of recycled water if applicable).

An example power planning unit 530 determines power utilization, ensures power support for operations, and/or control of operations to improve power usage. For example, high intensity activity (e.g., water treatment) may be moved to utilize cheaper power (e.g., off-hour and/or non-peak power), and/or control of power storage devices may be scheduled to improve power utilization. Additionally or alternatively, timing of certain operations, such as germination, plantlet growth, etc., may be scheduled to level out power utilization and/or reduce peak power utilization, for example accounting for light schedules, fluid pumping schedules, and other operations of the physical growing unit 102.

An example shelf preparation planning unit 532 determines availability of trays, nutrient connections and delivery capacity, available locations within an enclosure, and the like. An example system includes trays that may be recycled, re-used, cleaned, and/or otherwise treated between growing/harvesting operations. An example shelf preparation planning unit 532 determines the capacity of the tray provision system, and/or any other capacity related to shelf preparation (e.g., maintenance, cleaning, of the shelf and/or a related component such as a light, fan, pump, etc.). In certain embodiments, aspects of the shelf preparation planning unit 532 are performed by another planning unit such as the receiving planning unit 522 and/or the harvesting planning unit 524, and/or by operations of the controller 104.

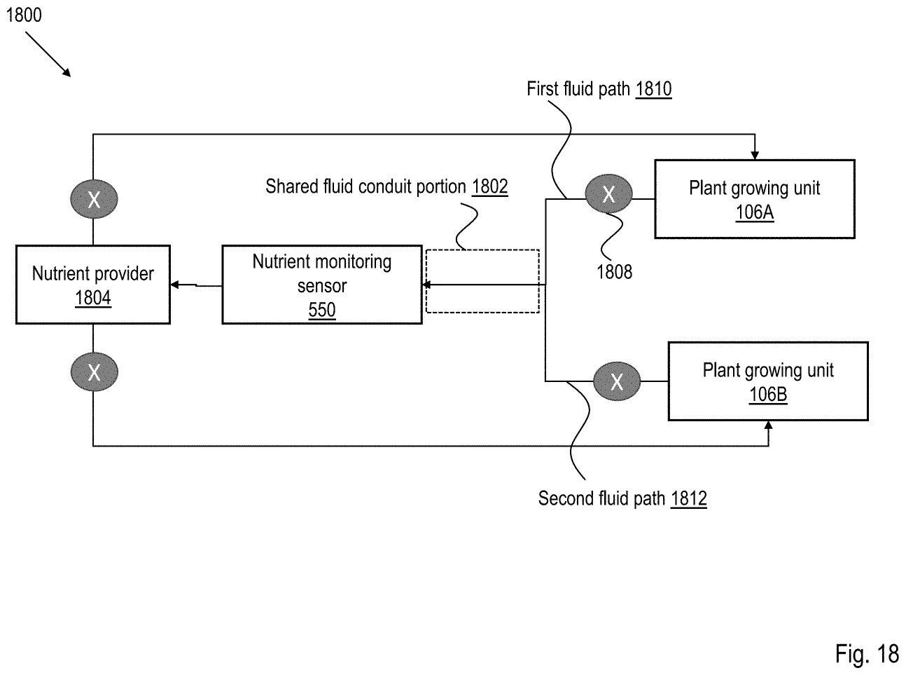

An example physical growing unit 102 includes a nutrient delivery unit 534, that provides delivery of nutrient solution to selected components of the system, such as trays, racks, shelves, or the like having set(s) of plants 108. In certain embodiments, the nutrient delivery unit 534, and/or in cooperation with the nutrient control unit 538, is capable to deliver selected nutrient mixes to selected set(s) of plants 108, for example accessing one or more nutrient reservoirs (not shown), and controlling flow to individual trays, shelves, racks, and/or enclosures to provide the scheduled nutrient delivery. In certain embodiments, the nutrient delivery unit 534 includes connecting pipes, manifolds, valves, and/or sensors (e.g., flow, pressure, temperature, density, etc.) to implement nutrient delivery operations. An example physical growing unit 102 includes a nutrient monitoring unit 540, for example monitoring feedforward nutrients (e.g., determining nutrient composition in the tray feed stream), feedback nutrients (e.g., determining nutrient composition in the nutrient solution of the tray), and/or parameters that may correlate with the nutrient composition (e.g., plant growth monitoring, plant color monitoring, nutrient depletion monitoring, etc.), where the monitored parameters of the nutrient monitoring unit 540 may be utilized by any controller, circuit, operation, or the like as set forth herein. An example nutrient delivery unit 534 includes valves, a nutrient fluid transfer pump 560, or other features (e.g., reference FIG. 18 and the related description) that allow for the nutrient monitoring unit 540 to separate monitoring values between racks, shelves, and/or trays, while allowing for a single sensor (or sensor set) to provide monitoring operations. An example nutrient monitoring unit 540 includes and/or is coupled to a nutrient monitoring sensor 550.

An example physical growing unit 102 includes a plant monitoring unit 542, including sensors and/or components to support operations to monitor plants. For example, a plant monitoring unit 542 may include one or more of: a light sensor, an imaging device (e.g., including imaging outside of the visible spectrum), and/or a composition indicator (e.g., determining plant health or status based on the consumption and/or release of a compound, molecule, or nutrient). In certain embodiments, the plant monitoring unit 542 is responsive to monitoring instructions, and/or is provided in communication with any other controller, circuit, or active component of the present disclosure. An example physical growing unit 102 includes a harvest monitoring unit 544, including sensors and/or component to support operations to monitor harvesting operations. For example, a harvest monitoring unit 544 may include one or more of: an imaging sensor and/or RFID transceiver; a scale/mass determination device; a sensor to determine specified environmental parameters (e.g., temperature, composition, opening events of the enclosure, etc.); and/or a sensor to determine any certification-related and/or verification-related parameter (e.g., monitoring a parameter that indicates whether a proper procedure was followed, such as enclosure opening events during harvesting operations, maintenance of temperature or other conditions, proper cutting procedures, etc.).

Without limitation to any other aspect of the present disclosure, an example physical growing unit 102 includes any one or more of: an actuator 552 (of any type, coupled to any component of the system), a data store 554 (e.g., storing data for and/or separately from the controller 104, and/or storing any intermediate data, calibrations, instructions, or the like), a door position sensor 558 (e.g., to determine enclosure opening events), an air quality sensor 562 (e.g., capable to determine humidity, O₂ levels, CO₂ levels, and/or any other constituent), an air supply component 564 (e.g., a fan, a pressurized air system with controllable valves or ducts, and/or pressurized air storage), a lighting unit 568 (e.g., capable to perform scheduled lighting operations including selected timing and/or frequency/color profile), a camera 570, an RFID tag 572 (e.g., on a cultivar tag, shelf, try, personnel badge, etc.), an electronic or paper log 578 (e.g., storing verification parameters, historical data, etc.), an order confirmation/receipt 580 (e.g., operated by a controller 104 exercising an interface such as a supplier UI 112 and/or buyer UI 116, and which provides confirmation communications related to ordering, supplying, accepting, declining, and/or a combination of these—for cultivars, harvest products, nutrient constituents, etc.), a water purifier component 582, a water quality sensor 584, a shelf cleaning component 588 (e.g., a portion of a facility that cleans shelves and/or trays for re-use, including washing components, related chemicals (if any), transport components such as conveyors, drying racks, etc.), a fan 590, one or more valve(s) 1808, and one or more other sensor(s) 548. In certain embodiments, any component of a physical growing unit 102, including without limitation components depicted in FIG. 5, may be operationally coupled to and responsive to commands from a controller 104 to implement operations of the system, including at least growing support operation command(s) 218, planting instruction value(s) 318, and/or monitoring/tracing instruction value(s) 414.

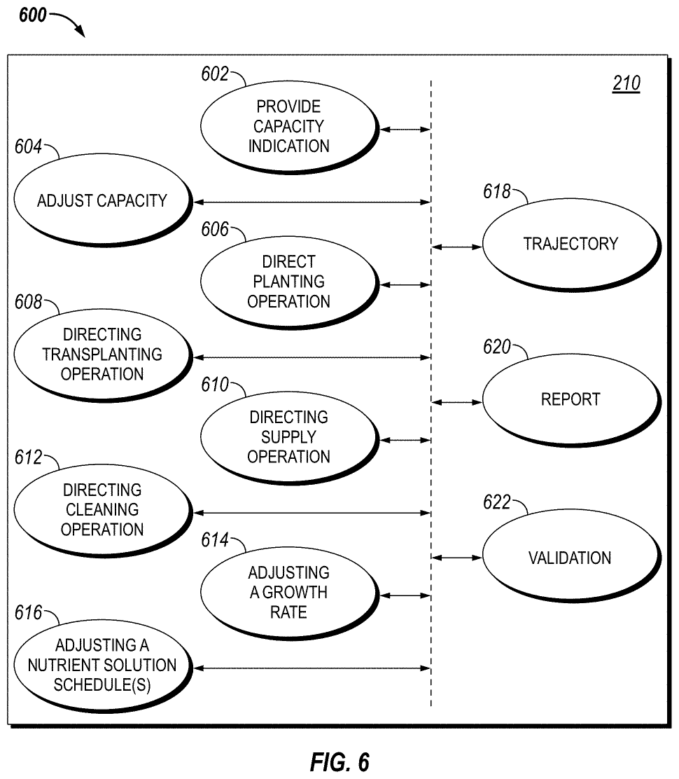

With reference to the example embodiment 600 of FIG. 6, which depicts an illustrative and non-limiting example of a growing support operation 210, the physical growing unit 102 may be structured to initiate the growing support operation 210. Without limitation to any other aspect of the present disclosure, a number of example growing support operations 210 are depicted, any one or more of which may be performed in certain embodiments. An example growing support operation 210 includes providing a capacity indication 602 related to an indoor vertical farm such as: a harvest product capacity such as weight of selected cultivars that can be harvested within a specified time period; a rack/shelf/tray capacity, such as a number of plants of a specified type that can be initiated at a selected stage such as germination, plantlet development, etc.; a trajectory of any of these such as the expected evolution over time; and/or providing/communicating a limiting factor of any of these such as shelf count, nutrient delivery capacity, separated nutrient delivery limitation, and/or personnel available at a limiting step.

An example growing support operation 210 includes adjusting a capacity 604 related to an indoor vertical farm 518, such as accelerating a growth rate of plants at a particular stage to increase the capacity of the unit 102; moving a cultivar, for example to free up shelf space, consolidate nutrient delivery, etc.; and/or increasing a number of shelves on a rack, a number of enclosures activated, bringing an additional pump or fan on-line, or other direct capacity increase operation.

An example growing support operation 210 includes directing a planting operation 606, such as adjusting a timing, cultivar mix, shelf positioning, etc. of a planting operation 606 to increase the capacity 604, and/or to reduce the capacity (e.g., where operations at a reduced capacity are still sufficient to achieve the harvest product targets, and that may reduce water utilization, power utilization, and/or personnel utilization).

An example growing support operation 210 includes directing a transplanting operation 608, for example moving a plant (or set of plants 108) to a different rack, shelf, tray, enclosure, or the like, to increase or adjust the capacity 604 of the unit 102. An example growing support operation 210 includes directing a supply operation 610, such as: a supply of cultivars/seeds (e.g., executing an order, sending a notification, etc.), planting/growing units (e.g., taking units (e.g., an enclosure, rack, pump, etc.) offline or bringing them online; and/or adjusting a purpose of an enclosure (e.g., changing from germination duty to plantlet development duty); an offset farm activity (e.g., moving delivery burden of a harvest product target, such as a particular order, in whole or part, to another physical growing unit (not shown), and/or from the other physical growing unit to the physical growing unit 102); and/or a scheduling activity (e.g., personnel capacity, power consumption and/or storage, harvest activity, movement activity of sets of plants 108 between enclosures, a power request, a water request (e.g., treatment, storage, and/or recycling), and/or a nutrient request). An example growing support operation 210 includes directing a cleaning operation 612 (e.g., of trays, enclosures, racks, shelves, fluid lines, fans, etc.). An example growing support operation 210 includes adjusting a growth rate 614 (e.g., for a set of plants 108, for example by adjusting a nutrient solution, light schedule, environmental condition, etc.). An example growing support operation 210 includes adjusting a nutrient solution transfer and/or monitoring schedule 616 (e.g., increasing or decreasing a monitoring frequency, isolating monitoring and/or nutrient solution delivery for a set of plants 108, and/or adjusting a nutrient solution composition, etc.).

The described operations 210 are non-limiting examples provided for illustration. Any operations described herein, and/or that one of skill in the art having the benefit of the present disclosure would understand to adjust or implement a growing support operation command 218 are contemplated herein. Example operations 210 include adjusting a trajectory 618 of any one or more of the described operations 210. An example trajectory 618 includes a progression based on time, plant/growth stage, enclosure progression, unit 102 operating cycle, or the like. Example operations to adjust a trajectory 618 include pre-planning/feedforward operations (e.g., anticipating disturbances to the system based on known information such as order schedules, personnel schedules, holidays, power interruption events, water interruption events, etc.), and/or feedback operations (e.g., measuring outputs of the system such as nutrient content values, plant growth progression, etc., and further adjusting operations 210 in response to the feedback information), for example to adjust the trajectory 618 toward a desired trajectory 618. Example operations 210 include providing a report 620 associated with any one or more of the described operations 210. An example report 620 includes any one or more of: metadata related to the operations 210 (e.g., cultivars, related orders, related personnel, related enclosures, and/or related components of any type); monitored data values related to the operations 210; status values (e.g., plant status, enclosure status, fault codes, etc.) related to the operations 210. Example operations 210 include validation 622 operations associated with any one or more of the described operations 210. Example validation 622 operations include: capturing images related to operations; capturing RFID and/or bar code information related to operations; collecting data related to operations; and/or confirming status values related to operations.

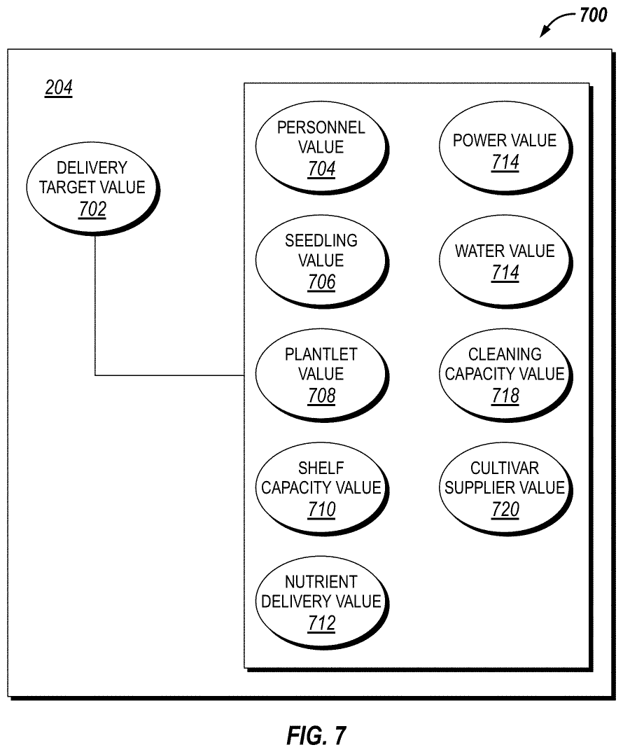

With reference to the example embodiment 700 of FIG. 7, which depicts an illustrative and non-limiting example of a growing capacity description 204, the growing capacity description 204 may include a delivery target value 702 for at least one aspect of the indoor vertical farm 518 (and/or of the physical growing unit 102). The delivery target value 702 may include at least one value selected from the values consisting of: a personnel value 704, a seedling value 706, a plantlet value 708, a shelf capacity value 710, a nutrient delivery value 712, a power value 714, a water value 716, a cleaning capacity value 718, a cultivar supplier value 720, and a trajectory of any one or more of the foregoing. In certain embodiments, the delivery target value 702 can relate to any aspect of the system, and can be utilized to determine a limiting component of the system—for example to allow for capacity adjustment operations to increase overall capacity of the unit 102. In some embodiments, any of delivery target value(s) 702 may or may not be important depending on a particular operation. For example, the water value 716 may be important where the indoor vertical farm 518 is limited in capacity due to water being scarce. In another example, the water value 716 may not be utilized where unlimited water is available at a predictable cost. Furthermore, some delivery target values 702 may be important in accordance with a time aspect. For example, with reference to the power value 714, power may be plentiful during some parts of the year, or times during the day, but not others.

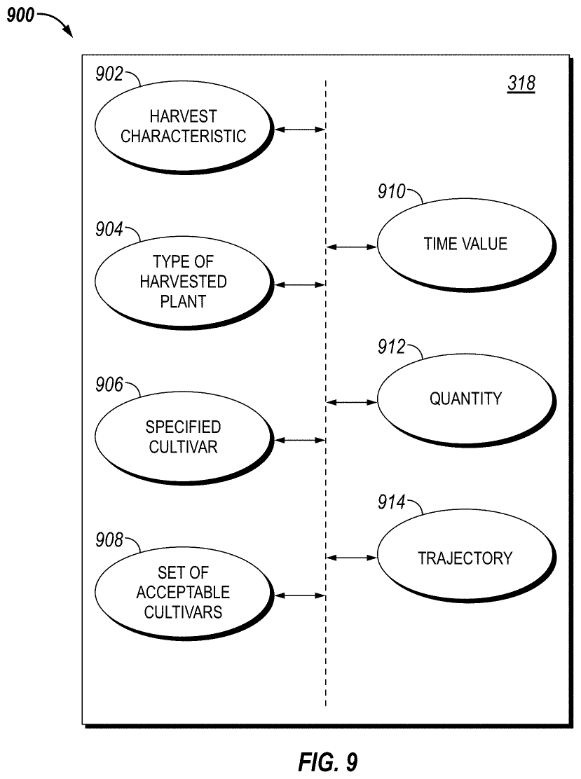

With reference to FIG. 1, the farm manager circuit 110 may be structured to provide a supplier user interface (UI) 112 structured to display the growing capacity description 204 to the supply user, and to receive the input from the supply user in response to the growing capacity description 204. Furthermore, with reference to the example embodiment 900 of FIG. 9, which depicts an illustrative and non-limiting example of a planting instruction value 318, the farm manager circuit 110 may adjust the planting instruction value 318 in response to the input.

In some embodiments, the planting instruction value 318 may include at least one value selected from the values consisting of: a type of harvested plant 904, a specified cultivar 906, a set of acceptable cultivars 908, a harvest characteristic 902 (e.g. including plant features such as low nitrates, and as-harvested features such as a selected chain-of-custody, certification, or verification level (e.g., Kosher)), a time value 910 of any one or more of the foregoing, a quantity 912 of any one or more of the foregoing, and/or a trajectory 914 of any one or more of the foregoing. Without limitation to any other aspect of the present disclosure, a trajectory may include providing values of the any one or more of the foregoing over a period of time, such as per day, per month, according to a schedule, etc.

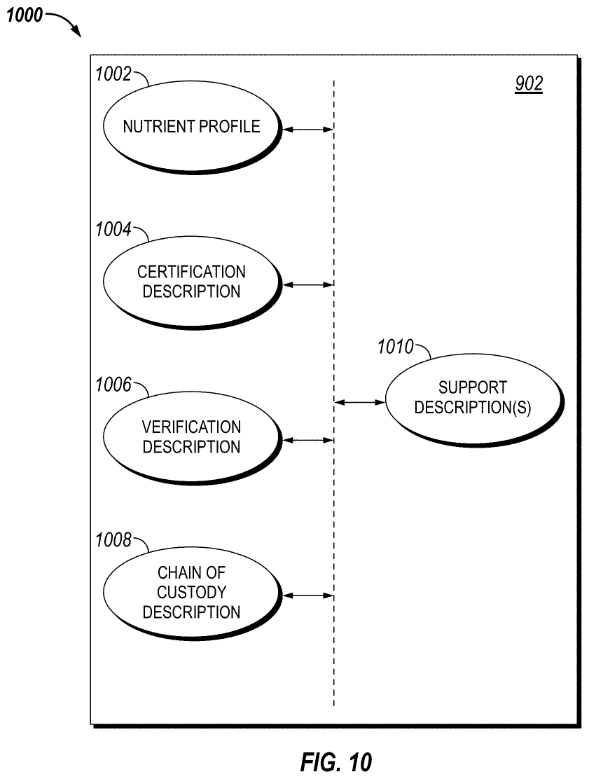

With reference to the example embodiment 1000 of FIG. 10, which depicts an illustrative and non-limiting example of a harvest characteristic 902, the harvest characteristic 902 may include at least one value selected from the values consisting of: a nutrient profile 1002 (e.g., a specified concentration of one or more nutrients, including acceptable ranges, optimal values, minimum values, and/or maximum values), a certification description 1004 (e.g., operations indicated due to a certification related to a group of plants 108 associated with the harvest characteristic 902), a verification description 1006 (e.g., data and/or observations to be taken to verify a certification, regulatory compliance, etc.), a chain-of-custody description 1008 (e.g., confirming access and/or engagement with the plants, related enclosures or components, etc.), and/or a support description 1010 relating to any one or more of the foregoing. Some of these values, such as the nutrient profile 1002, may relate to plant and/or growth features, and may include, for example, low nitrate values, while others of these values, such as the certification description 1004, verification description 1006, and chain-of-custody description 1008, may relate to harvested features. The support description 1010 may include, for example, shelf space, a sensor package, a personnel package, inventory description, or any other supply aspect to be confirmed and/or enhanced to support the harvest characteristic 902—for example, Kosher certification, low nitrate, or other aspect that may require additional personnel, more shelf space, more responsive sensor interrogation, etc., and which may also lead to other aspects such as enhanced growing speed, etc.

With reference to FIG. 8, which depicts an illustrative and non-limiting example of a farm management system 800, the farm manager circuit 802 may be structured to provide a supplier user interface 112 (see FIG. 1) that is structured to display the growing capacity description 204 to the supply user, to receive the input 806 from the supply user in response to the growing capacity description 204, and to adjust the planting instruction value 318 in response to the input 806 from the supply user.

In some embodiments, the farm manager circuit 802 may be further structured to determine and display—e.g., via the supplier user interface 112—at least one recommendation 804 for the planting instruction value 318 to the supply user. In some examples, the farm manager circuit 802 may be further structured to determine and display—e.g., via the supplier user interface 112—a plurality of recommendations 804 for the planting instruction value 208/318 to the supply user. Additionally, the farm manager circuit 802 may be structured to receive the input 806 from the supply user via the supplier user interface 112. Receiving the input 806 may include receiving a selection from the supply user of recommendation(s) 804 for the planting instruction value 318.

In some embodiments, the farm manager circuit 802 may be further structured to determine and display—e.g., via the supplier user interface 112—an outcome description value 808 corresponding to each of the plurality of recommendations 804 for the planting instruction value 318 to the supply user. The outcome description value 808 may include predicted consequences of the planting instruction value 318, such as economic results, capacity utilization or results, change in sensitivity (e.g., close to capacity, more sensitive to a range of possible disturbances, stress on a supplier, etc.), change in another deliverable (e.g., a different growing target from the one being considered), effects on the system (e.g., utilization of power, water, CO₂ emissions, impact on personnel, etc.) that may be for purposes other than meeting the growing targets, or the like.

In some embodiments, the farm manager circuit 802 may be further structured to determine and display—e.g., via the supplier user interface 112—an adjusted outcome description value 810 in response to one of the selection from the supply user or an entry from the supply user as the supplier user input 806. The entry from the supply user may include a user-entered planting instruction value or a user-adjusted planting instruction value.

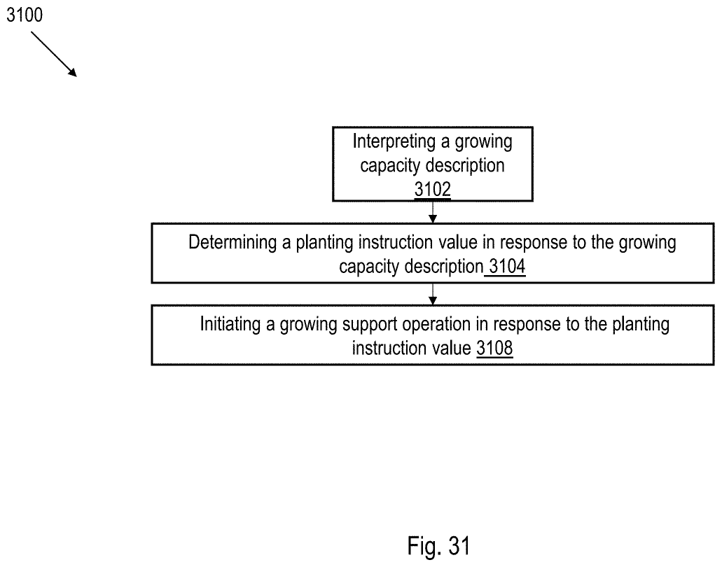

With reference to FIG. 31, an illustrative and non-limiting example method 3100 of initiating a growing support operation is depicted. The method 3100 may include an operation 3102 of interpreting a growing capacity description, an operation 3104 of determining a planting instruction value in response to the growing capacity description, and an operation 3108 of initiating a growing support operation in response to the planting instruction value.

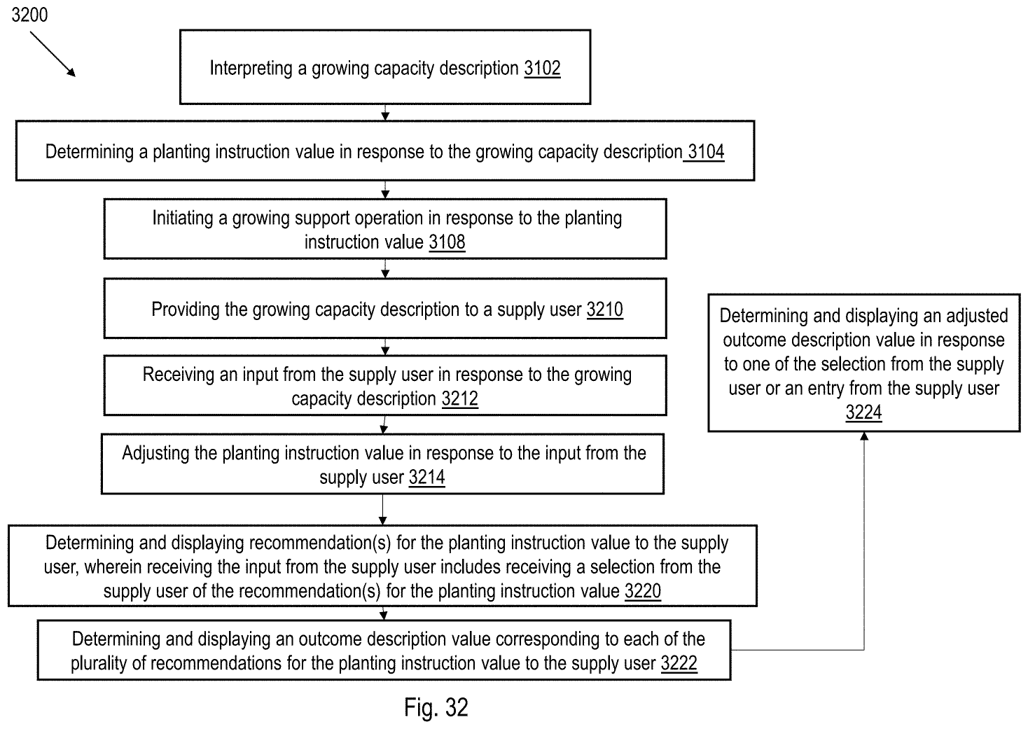

With reference to FIG. 32, an illustrative and non-limiting example method 3200 of initiating a growing support operation is depicted. The method 3200 may include the operation 3102 of interpreting the growing capacity description, the operation 3104 of determining the planting instruction value in response to the growing capacity description, and the operation 3108 of initiating the growing operation in response to the planting instruction value. Furthermore, the method 3200 may include an operation 3210 of providing—e.g., via a supplier user interface—the growing capacity description to a supply user, an operation 3212 of receiving—e.g., via a supplier user interface—an input from the supply user in response to the growing capacity description, and an operation 3214 of adjusting the planting instruction value in response to the input from the supply user.

In some embodiments of method 3200, the operation 3108 to initiate the growing operation in response to the planting instruction value may include performing at least one operation selected from the operations consisting of: providing a capacity indication related to an indoor vertical farm, adjusting a capacity related to an indoor vertical farm, directing a planting operation, directing a transplanting operation, directing a supply operation, directing a cleaning operation, adjusting a growth rate, adjusting a nutrient solution transfer or monitoring schedule, adjusting a trajectory of any one or more of the foregoing, providing a report related to any one or more of the foregoing, and validating any one or more of the foregoing.

Also, in some embodiments, the method 3200 may further include an operation 3220 of determining and displaying—e.g., via a supplier user interface—a plurality of recommendations for the planting instruction value to the supply user. Furthermore, in some embodiments of operation 3212, receiving the input from the supply user includes receiving—e.g., via a supplier user interface—a selection from the supply user of the plurality of recommendations for the planting instruction value. However, embodiments are not limited thereto, and the method 3200 may include an operation of determining and displaying at least one recommendation for the planting instruction value to the supply user.

Also, in some embodiments, the method 3200 may further include an operation 3222 of determining and displaying—e.g., via a supplier user interface—an outcome description value corresponding to each of the plurality of recommendations for the planting instruction value to the supply user.

Also, in some embodiments, the method 3200 may further include an operation 3224 of determining and displaying—e.g., via a supplier user interface—an adjusted outcome description value in response to one of the selection from the supply user or an entry from the supply user. The entry from the supply user may include one of a user-entered planting instruction value or a user-adjusted planting instruction value.

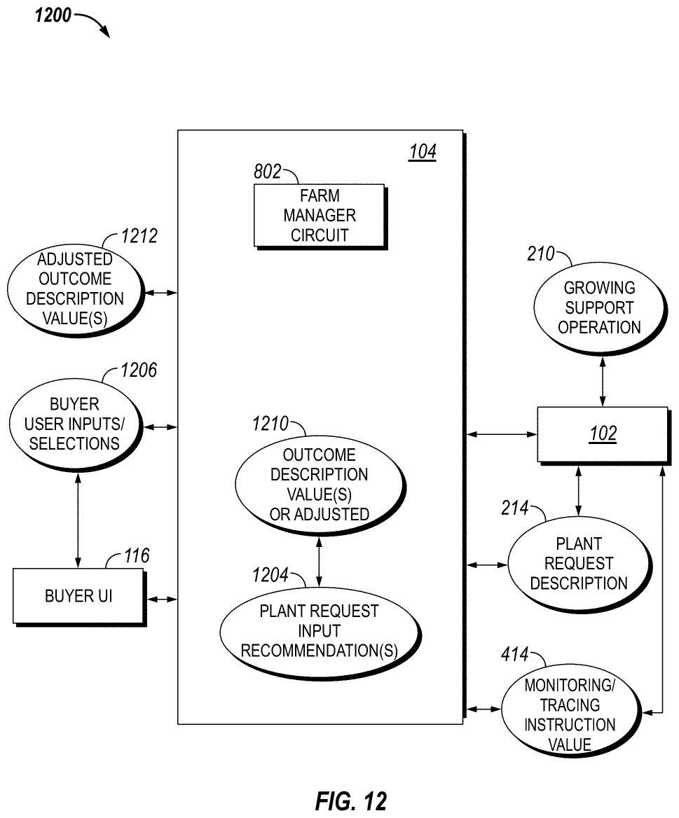

With reference again to FIG. 2, an illustrative and non-limiting farm management system 200 is depicted. The system 200 may include a demand request circuit 212 structured to interpret a plant request description 214 (e.g., a number of plants, a harvest product, specific cultivars requested, and/or specific varieties requested), a capacity control circuit 202 structured to determine a planting instruction value 208 (e.g., a number and/or placement of plants to be initiated for growth) in response to the plant request description 214, and a delivery implementation circuit 216 structured to provide a growing support operation command 218 in response to the plant request description 214. In some embodiments, the system 200 may also include a farm manager circuit 110 (see FIG. 1) structured to provide a buyer user interface (UI) 116 structured to receive an input 1206 (which may be a plant request input, a user-entered plant request input, or a user-adjusted plant request input—see FIG. 12, discussed below) from a buyer user, and to determine the plant request description 214 in response to the plant request input 1206.

In some embodiments, the growing support operation command 218 may include a growing capacity description 204.

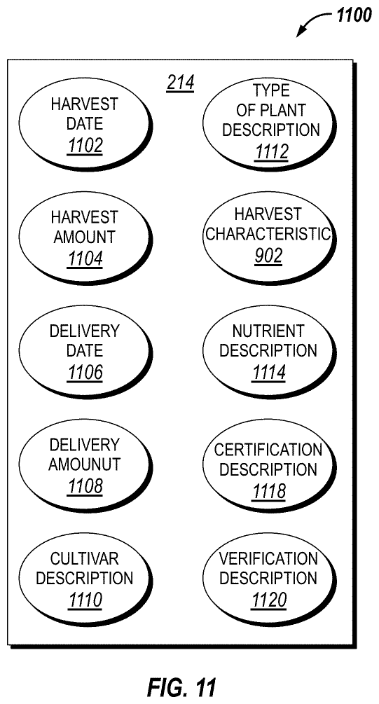

With reference to the example embodiment 1100 of FIG. 11, which depicts an illustrative and non-limiting example of a plant request description 214, the plant request description 214 may include at least one value selected from the values consisting of: a harvest date 1102, a harvest amount 1104, a delivery date 1106, a delivery amount 1108, a cultivar description 1110, a type of plant description 1112, a harvest characteristic 902, a nutrient description 1114, a certification description 1118, and a verification description 1120. In certain embodiments, a harvest product and/or harvest product target includes one or more of a harvest date 1102, a harvest amount 1104, and/or a harvest characteristic 902. In certain embodiments, a harvest product may be associated, for example by controller 104, with a set of plants 108 that are utilized to service an order (e.g., provided by the plant request description 214). In certain embodiments, a nutrient description 1114 includes a range and/or target concentration of one or more nutrients in a nutrient solution; a nutrient minimum or maximum value; a nutrient exclusion value (e.g., do not use); and/or a trajectory of these.

With reference to FIG. 12, which depicts an illustrative and non-limiting example of a farm management system 1200, the farm manager circuit 802 may be further structured to determine and display—e.g., via the buyer user interface 116—at least one recommendation 1204 for the plant request input 1206 to the buyer user. The farm manager circuit 802 may be further structured to determine and display—e.g., via the buyer user interface 116—a plurality of recommendations 1204 for the plant request input 1206 to the buyer user. Receiving the plant request input 1206 from the buyer user may include receiving—e.g., via the buyer user interface 116—a selection from the buyer user of the plurality of recommendations 1204 for the plant request input 1206. For example, the recommendations 1204 may include alternate selections for dates, alternate selections of varieties and/or cultivars, and/or any other buyer options related to the order, which may be determined in response to a capacity value of the physical growing unit 102, a cost resulting from certain aspects of the order, or the like. In certain embodiments, a recommendation 1204 may include one or more operational adjustments, for example to adjust a capacity of the physical growing unit 102 responsive to the order or plant request input 1206. In certain embodiments, operational adjustments (if present) are provided to the operator interface 114, additionally or alternatively to providing operational adjustments to the buyer interface 116. Without limitation to any other aspect of the present disclosure, a buyer user may be a consumer, a consuming entity (e.g., a food bank), a wholesaler and/or distributor, or the like. In certain embodiments, for example where a physical growing unit 102 produces in cooperation with an offset physical growing unit, a harvest product and/or harvest product target may service only a portion of an order, for example where the harvest product to service the order is shared between physical growing units, and/or where only a best possible delivery of a part of the order is scheduled (e.g., due to capacity limitations). In certain embodiments, for example where a physical growing unit 102 produces in cooperation with an offset physical growing unit, an operator user of one of the cooperating growing units may interface with the farm manager circuit 802 using the buyer user interface 116.

In some embodiments, the farm manager circuit 802 may be further structured to determine and display—e.g., via the buyer user interface 116—an outcome description value 1210 corresponding to each of the plurality of recommendations 1204 for the plant request input 1206 to the buyer user. Example and non-limiting outcome description value(s) 1210 include values such as: a predicted harvest product delivery; a confirmation of an order; a confirmation interface for operational and/or order adjustments responsive to the recommendation(s) 1204, an operational adjustment for the physical growing unit 102; and/or a planting operation 320 for the physical growing unit 102.

In some embodiments, the farm manager circuit 802 may be further structured to determine and display—e.g., via the buyer user interface 116—an adjusted outcome description value 1212 in response to one of the selection from the buyer user or an entry from the buyer user as the input 1206. The entry from the buyer user may include one of a user-entered plant request input or a user-adjusted plant request input. Example and non-limiting adjusted outcome description value(s) 1212 include values such as: a resulting change to the outcome description value 1210 based on monitored information since the determination of the outcome description value 1210; and/or an adjusted outcome description value 1212 based on changes to a pending order and/or selections of the buyer user via the buyer user interface 116. In certain embodiments, the farm manager circuit 802 updates the buyer user interface 116, and/or sends a notification to the buyer, in response to the adjusted outcome description value(s) 1212—for example where a change in conditions of the physical growing unit 102 produces a specified change in the adjusted outcome description value(s) 1212 (e.g., harvest product reduction by a threshold amount; harvest product reduction by a threshold fraction; harvest product delay greater than a threshold time; etc.).

In some embodiments, the capacity control circuit 202 may be further structured to interrogate at least one of a sensor or controller communicatively coupled to or incorporated in the physical growing unit 102. For example, the capacity control circuit 202 may be further structured to interrogate at least one sensor shown in the example physical growing unit 102 depicted in FIG. 5. Also, the farm manager circuit 802 may be further structured to determine the outcome description value 1210 in response to the interrogating.

In some embodiments, the system 1200 may further include the physical growing unit 102, which is responsive to the plant request description 214.

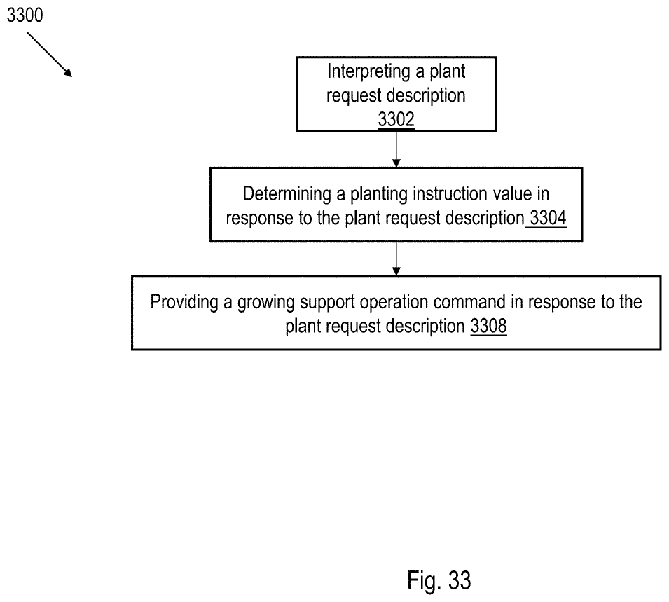

With reference to FIG. 33, an illustrative and non-limiting example method 3300 of providing a growing support operation command is depicted. The method 3300 may include an operation 3302 of interpreting a plant request description, an operation 3304 of determining a planting instruction value in response to the plant request description, and an operation 3308 of providing a growing support operation command in response to the plant request description.

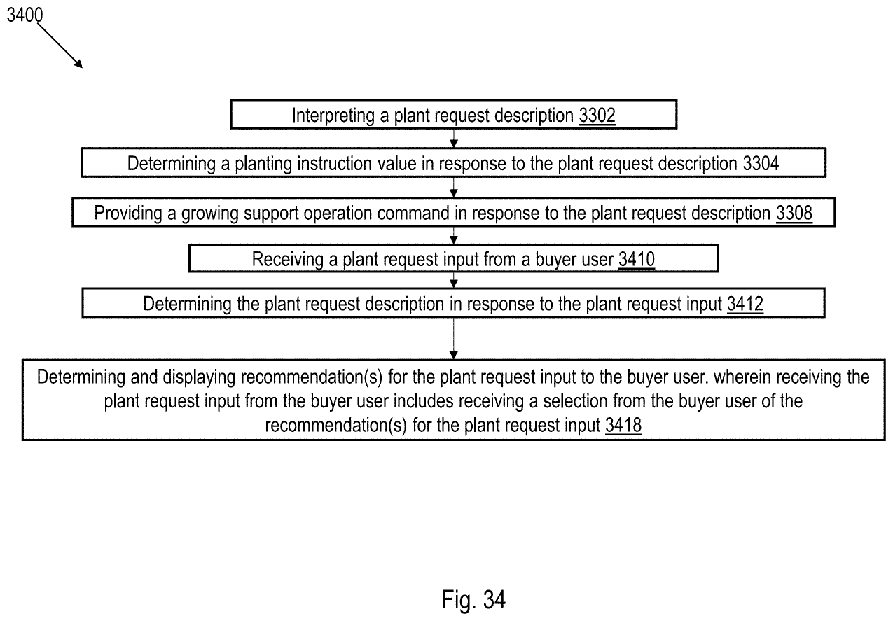

With reference to FIG. 34, an illustrative and non-limiting example method 3400 of providing a growing support operation command is depicted. The method 3400 may include the operation 3302 of interpreting a plant request description, the operation 3304 of determining a planting instruction value in response to the plant request description, the operation 3308 of providing a growing support operation command in response to the plant request description, an operation 3410 of receiving, via a buyer user interface, a plant request input from a buyer user, an operation 3412 of determining the plant request description in response to the plant request input, and an operation 3418 of determining and displaying one or more recommendation(s) for the plant request input to the buyer user. In some embodiments of method 3400, the operation 3410 of receiving the plant request input from the buyer user may include receiving a selection from the buyer user of the one or more recommendations for the plant request input.

In some embodiments of method 3400, the plant request description comprises at least one value selected from the values consisting of: a harvest date, a harvest amount, a delivery date, a delivery amount, a cultivar description, a type of plant description, a harvest characteristic, a nutrient description, a certification description, and a verification description.

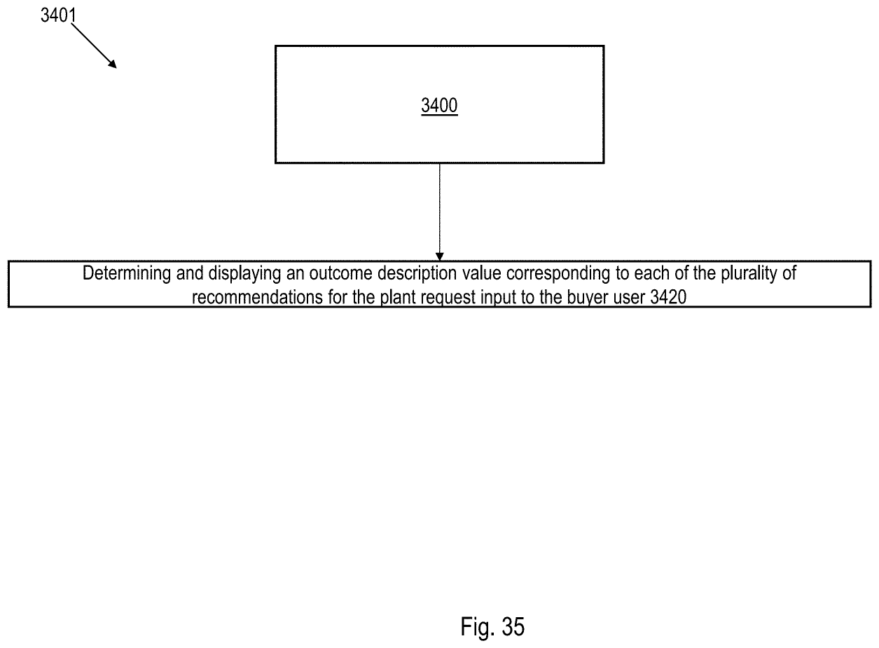

With reference to FIG. 35, an illustrative and non-limiting example method 3401 of providing a growing support operation command is depicted. In some embodiments, the method 3401 may include the operations of method 3400, as may be described and depicted herein. Furthermore, the method 3401 may include an operation 3420 of determining and displaying an outcome description value corresponding to each of the plurality of recommendations for the plant request input to the buyer user.

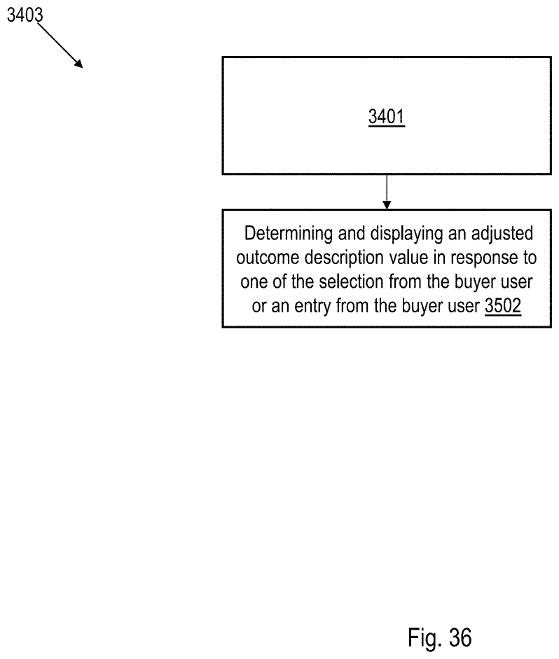

With reference to FIG. 36, an illustrative and non-limiting example method 3403 of providing a growing support operation command is depicted. In some embodiments, the method 3403 may include the operations of method 3401, as may be depicted and described herein. Furthermore, the method 3403 may include an operation 3502 of determining and displaying an adjusted outcome description value in response to one of the selection from the buyer user or an entry from the buyer user. In some embodiments of method 3403, the entry from the buyer user may include one of a user-entered plant request input or a user-adjusted plant request input.

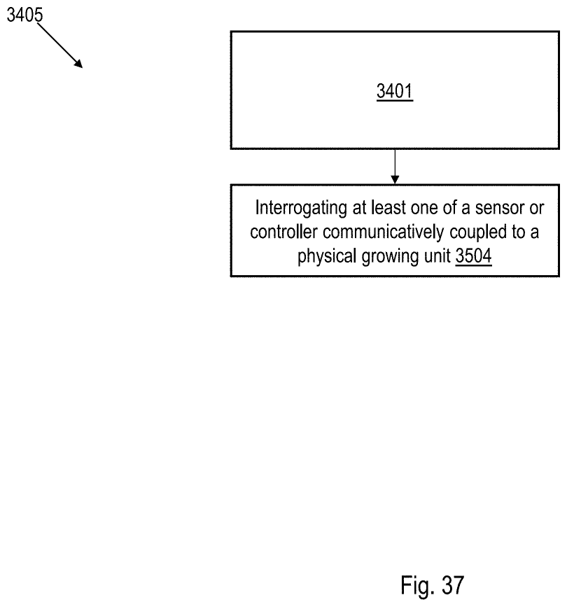

With reference to FIG. 37, an illustrative and non-limiting example method 3405 of providing a growing support operation command is depicted. In some embodiments, the method 3405 may include the operations of method 3401, as may be depicted and described herein. Furthermore, the method 3405 may include an operation 3504 of interrogating at least one of a sensor or controller communicatively coupled to a physical growing unit, and determining the outcome description value in response to the interrogating.

Also, in some embodiments, the growing support operation command of method 3400 may include a growing capacity description.

With reference again to FIG. 2, an illustrative and non-limiting farm management system 200 is depicted. The system 200 may include a plurality of plant growing units 106 (as shown by example in FIG. 1), which may be part of a physical growing unit 102, a plant definition circuit 220 structured to interpret an outcome description value 222 for each corresponding one of the plurality of plant growing units 106. The outcome description value 222 may be any type of outcome description value as set forth throughout the present disclosure. The example farm management system 200 includes a nutrient definition circuit 224 structured to determine a nutrient mix value 226 for each one of the plurality of plant growing units 106 in response to the corresponding outcome description value 222 for each one of the plurality of plant growing units 106.

In some embodiments, the nutrient mix value 226 may include quantitative and qualitative values, such as error bars, sensitivity, must-not-exceed limits, minimums, sourcing and/or confirmation, statistical descriptions, and isolation requirements (e.g., operation to ensure no fluid transfer with other plant growing units, which may be more expensive). Furthermore, the nutrient mix value 226 may include targets, trajectories, and/or time frames for limitations/mix selections. Additionally, the nutrient mix value 226 may include subsets of the plant growing units 106 that may have relaxed boundaries within the subset relative to the rest of the plant growing units 106.

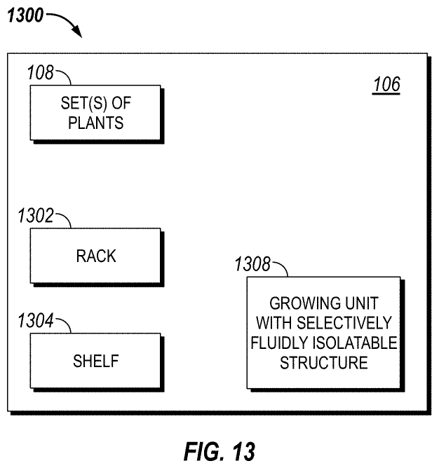

With reference to the example embodiment 1300 of FIG. 13, which depicts an illustrative and non-limiting example of a plant growing unit 106, each one of the plurality of plant growing units 106 may include one or more grouped set(s) of plants 108, and each grouped set of plants 108 may be positioned in at least one corresponding structure selected from a rack 1302, a shelf 1304, and a growing unit 1308 having a selectively fluidly isolatable structure. In an example, a plant growing unit 106 may have multiple racks, shelves, and/or trays, and the selectively fluidly isolatable structure may enable treatment of the group of multiple trays and/or shelves together, thereby permitting the mixing and/or monitoring among the group of shelves. However, embodiments are not limited thereto, and in other examples, a growing unit 106 may be limited to a single shelf and/or a single tray.

In some embodiments, the system 200 may further include a vertical indoor farm 518 (see FIG. 5) that includes the plurality of plant growing units 106.

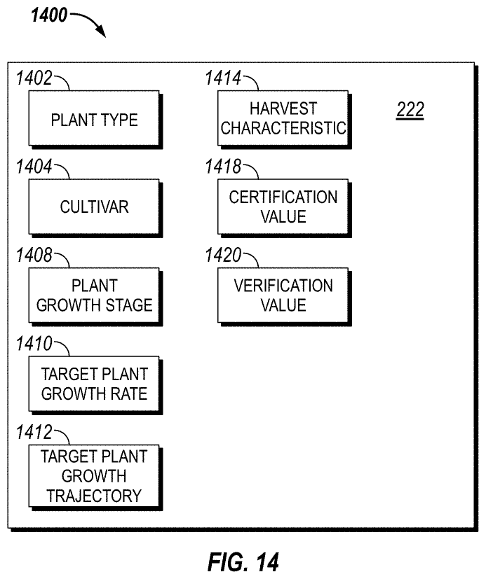

With reference to the example embodiment 1400 of FIG. 14, which depicts an illustrative and non-limiting example of an outcome description value 222, the outcome description value 222 may include at least one value selected from the values consisting of: a plant type 1402, a cultivar 1404, a plant growth stage 1408, a target plant growth rate 1410, a target plant growth trajectory 1412, a harvest characteristic 1414, a certification value 1418, and a verification value 1420.

With reference to FIG. 2, in some embodiments, the nutrient definition circuit 224 may be further structured to interpret a planting instruction value 208, and to determine the nutrient mix value 226 for each one of the plurality of plant growing units 106 further in response to the planting instruction value 208.

With reference to FIG. 9, in some embodiments, the planting instruction value 208 may include at least one value selected from the values consisting of: a type of harvested plant 904, a specified cultivar 906, a set of acceptable cultivars 908, a harvest characteristic 902, a time value 910 of any one or more of the foregoing, a quantity 912 of any one or more of the foregoing, and a trajectory 914 of any one or more of the foregoing. Furthermore, with reference to FIG. 10, and in an example embodiment where the planting instruction value 208 includes the harvest characteristic 902, the harvest characteristic 902 may include at least one value selected from the values consisting of: a nutrient profile 1002, a certification description 1004, a verification description 1006, a chain-of-custody description 1008, and a support description 1010 relating to any one or more of the foregoing. Some of these values, such as the nutrient profile 1002, may relate to plant and/or growth features, and may include, for example, low nitrate values, while others of these values, such as the certification description 1004, verification description 1006, and chain-of-custody description 1008, may relate to harvested features and/or harvest characteristics. The support description 1010 may include, for example, shelf space, a sensor package, a personnel package, or any other supply aspect that may need to be enhanced to support the harvest characteristic 902—for example, Kosher certification, low nitrate, or other aspect that may require additional personnel, more shelf space, more responsive sensor interrogation, etc. which may also lead to other aspects such as enhanced growing speed, etc.

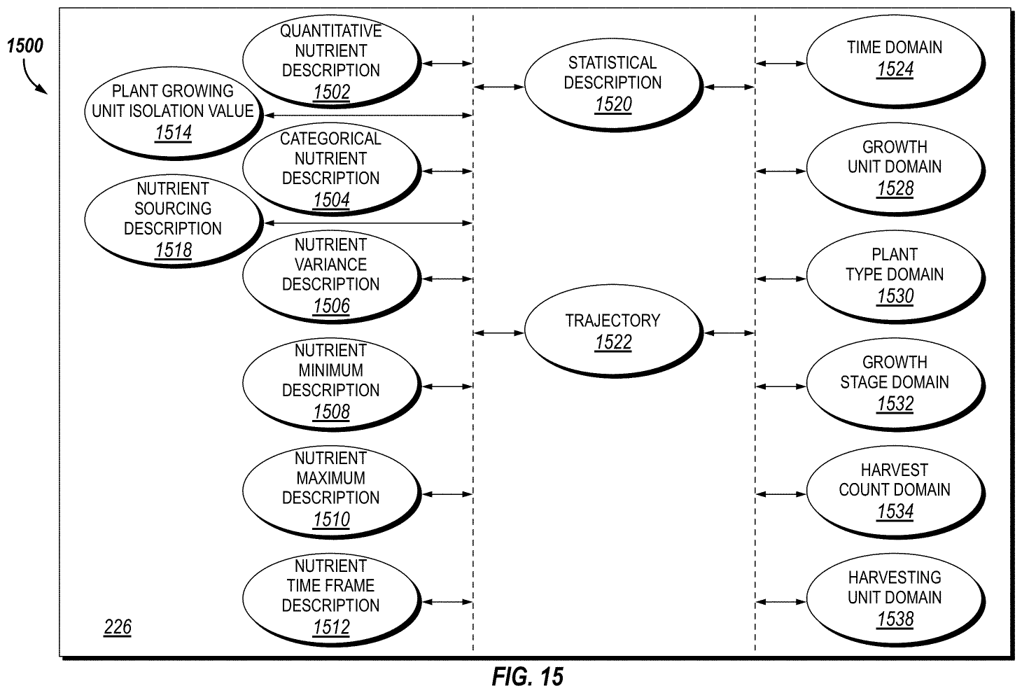

With reference to the example embodiment 1500 of FIG. 15, which depicts an illustrative and non-limiting example of a nutrient mix value 226, the nutrient mix value 226 may include at least one parameter selected from the parameters consisting of: a quantitative nutrient description 1502 (e.g., ranges, limits, and/or target values), a categorical nutrient description 1504 (e.g., the inclusion or exclusion of a nutrient, allowability for substitutions, etc.), a nutrient variance description 1506 (e.g., options, changes from a nominal formulation, etc.), a nutrient minimum description 1508, a nutrient maximum description 1510, a nutrient time frame description 1512, a plant growing unit isolation value 1514 (e.g., to support certain certification types, including separation by enclosures, enclosure integrity, separation by racks, separation by shelves, and/or separation by trays), a nutrient sourcing description 1518, and/or a statistical description 1520 of any one or more of the foregoing (e.g., averages such as mean, median, or mode values; statistical values such as standard deviations and/or volatility descriptions; rolling average values; filtered values (e.g. to reduce noise, focus on events having selected frequencies, and/or to highlight unusual events quickly); sensitivity parameters—e.g., based on a correlation and/or determined causal relationship between parameters; etc.). An example nutrient mix value includes any one or more of the foregoing values, trajectories 1522 thereof, and/or statistical descriptions thereof, utilizing a time domain 1524 (e.g., progression of the value over time), a growth unit domain 1528 (e.g., correlation and/or progression of the value with operations of a growth unit 106), a plant type domain 1530 (e.g., correlation and/or progression of the value with inclusion of certain cultivars and/or varieties), a growth stage domain 1532 (e.g., correlation and/or progression of the value with plant growth stage, such as germination, seedling, plantlet, etc.), a harvest count domain 1534 (e.g., correlation and/or progression of the value with a cut count related to a harvest event, for example allowing separate planting/growth responses to group of plants 108 having distinct “cut generation” values), and/or a harvesting unit domain 1538 (e.g., correlation and/or progression of the value with a target customer, a target crop which may be a mix of plant types, harvesting personnel, harvest product amount, harvesting time of day, etc.).

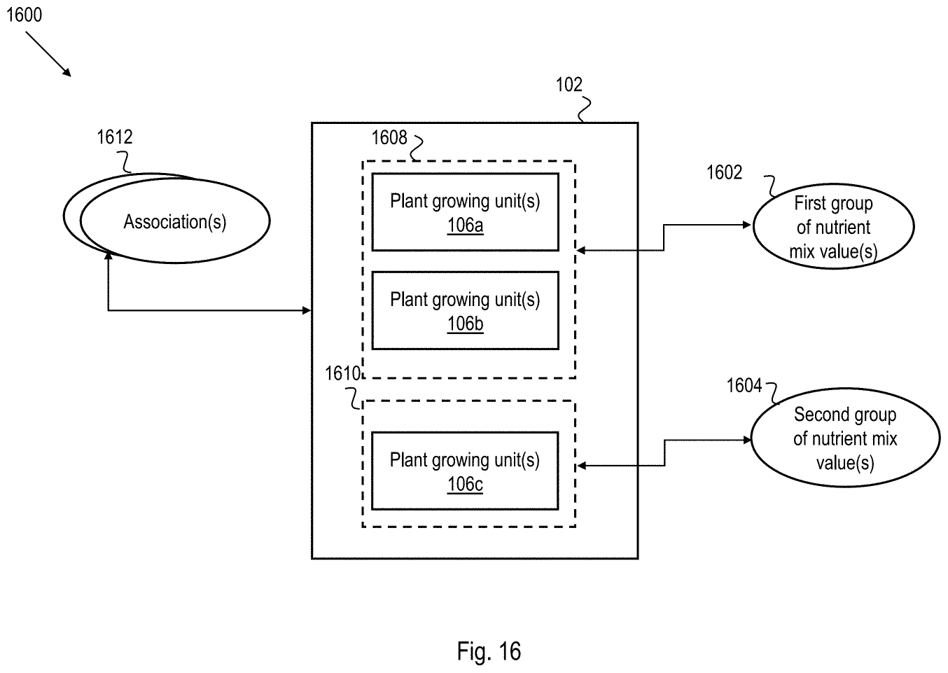

With reference to the example embodiment 1600 of FIG. 16, which depicts an illustrative and non-limiting example of a physical growing unit 102, a first group of nutrient mix values 1602 may correspond to a subset 1608 of the plurality of plant growing units 106a, 106b. Furthermore, the nutrient mix values within the first group of nutrient mix values 1602 may further include associations 1612 including a first association between members within the first group of nutrient mix values 1602, and a second association between each member of the first group of nutrient mix values 1602 and a second group of nutrient mix values 1604 that are not within the first group of nutrient mix values 1602. The first association may be distinct from the second association. In embodiments, a second group of nutrient mix values 1604 may correspond to a subset 1610 of the plurality of plant growing units 106c. The example of FIG. 16 allows for any group of plants 108 to receive a distinct nutrient mix relative to another group of plants 108. In certain embodiments, the nutrient mix values 1602 are each associated with a particular rack, shelf, and/or tray, in addition to or alternatively to an association with a group of plants 108. Accordingly, nutrient mix values can be adjusted for each group of plants, rack, shelf, and/or tray, depending upon the arrangement of the nutrient delivery unit and available fluid isolation (e.g., reference FIG. 18) in the physical growing unit, and the arrangement of the group of plants 108. In certain embodiments, each rack of an enclosure is at least selectively fluidly isolated from each other rack. In the example, a rack includes a number of vertically arranged shelves, each shelf capable to hold one or more trays. Further to the example, the trays hold the nutrient solution, the plants, and position the plants in proximity to lighting components, air flow components, and the like. In certain embodiments, each shelf of each rack of an enclosure is at least selectively fluidly isolated from each other shelf. In certain embodiments, each tray of each shelf of each rack of an enclosure is at least selectively fluidly isolated from each other tray. In certain embodiments, for example to reduce costs and/or provide for variable capability, an enclosure may have a mix of fluidly isolated components—for example one or more racks having full isolation capability, and other racks having a reduced isolation capability.

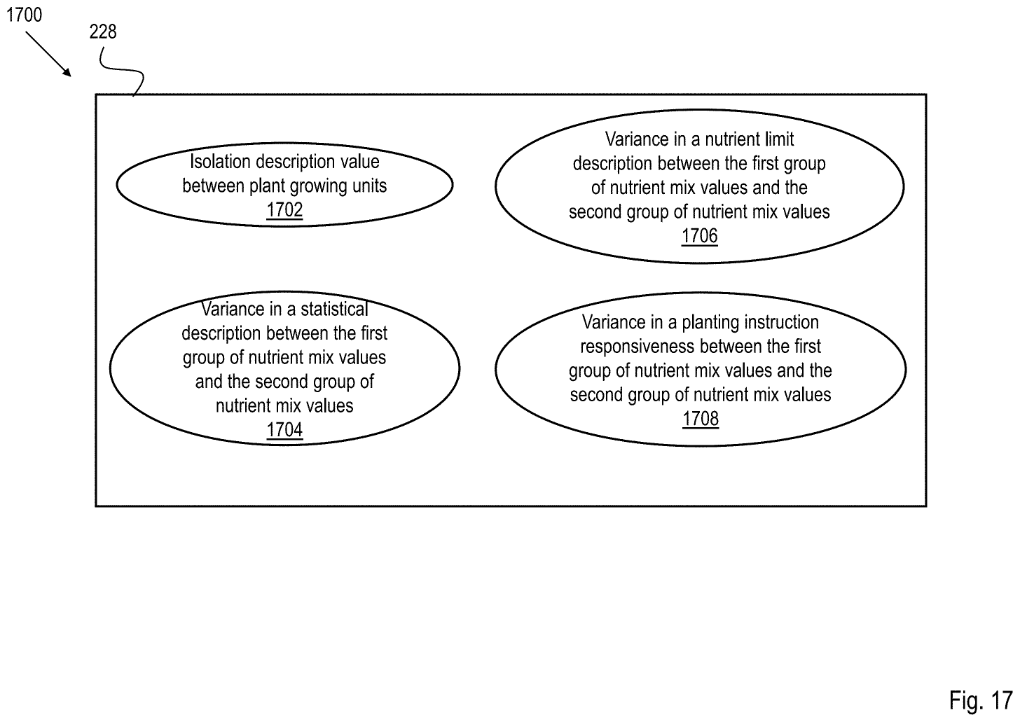

With reference to the example embodiment 1700 of FIG. 17, which depicts an illustrative and non-limiting example of distinctions 228 of a nutrient mix value, a distinction 228 between the first association 1612 and the second association 1612 may include at least one parameter selected from the parameters consisting of: an isolation description value 1702 between the plant growing units (e.g., plant growing units 106 that have an isolation requirement, such as limiting shared nutrient fluid, shared air volumes, shared trays, etc.), a variance 1704 in a statistical description between the first group of nutrient mix values and the second group of nutrient mix values (e.g., nutrient mix values that share one or more nominal values, but have a distinct statistical description), a variance 1706 in a nutrient limit description between the first group of nutrient mix values and the second group of nutrient mix values (e.g., utilizing a nutrient mix as a reference, with adjustments), and a variance 1708 in a planting instruction value responsiveness between the first group of nutrient mix values and the second group of nutrient mix values (e.g., allowing for faster or slower response based on nutrient mix, due to plant handling constraints, plant stress considerations, capacity management, etc.).

With reference again to FIG. 2, in some embodiments, the nutrient definition circuit 224 may be further structured to interpret a growing support operation command 218, and to determine the nutrient mix value 226 for each one of the plurality of plant growing units 106 further in response to the growing support operation command 218. In some embodiments, the growing support operation command 218 may include a growing capacity description 204.

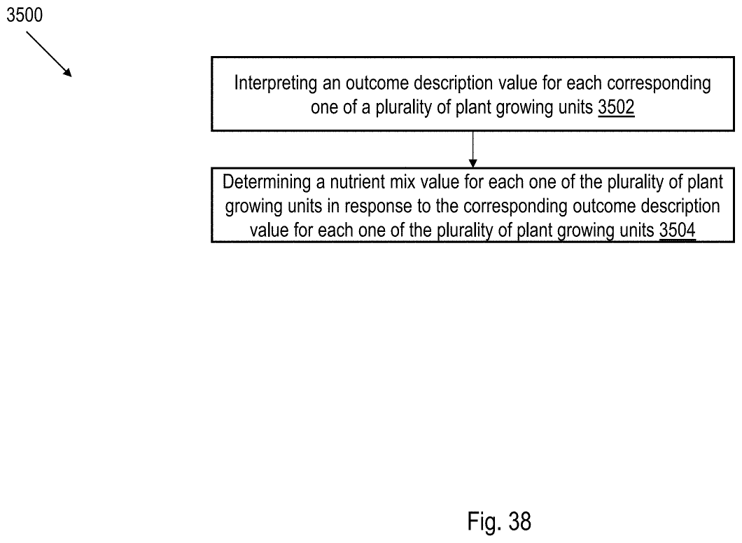

With reference to FIG. 38, an illustrative and non-limiting example method 3500 of determining a nutrient mix value is depicted. The method 3500 may include an operation 3502 of interpreting an outcome description value for each corresponding one of a plurality of plant growing units, and an operation 3504 of determining a nutrient mix value for each one of the plurality of plant growing units in response to the corresponding outcome description value for each one of the plurality of plant growing units.

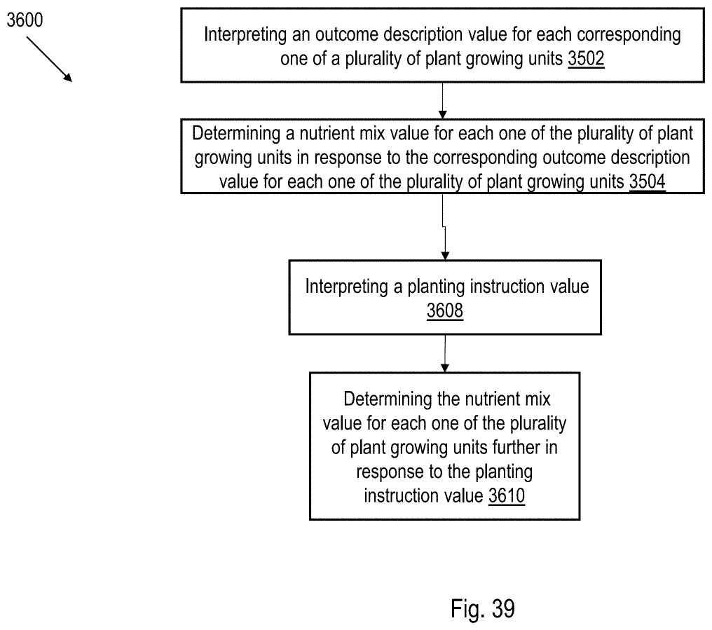

With reference to FIG. 39, an illustrative and non-limiting example method 3600 of determining a nutrient mix value is depicted. The method 3600 may include the operation 3502 of interpreting the outcome description value for each corresponding one of a plurality of plant growing units, and the operation 3504 of determining the nutrient mix value for each one of the plurality of plant growing units in response to the corresponding outcome description value for each one of the plurality of plant growing units. Furthermore, the method 3600 may include an operation 3608 of interpreting a planting instruction value, and an operation 3610 of determining the nutrient mix value for each one of the plurality of plant growing units further in response to the planting instruction value.

In some embodiments of method 3600, each one of the plurality of plant growing units may include a grouped set of plants, and each grouped set of plants may be positioned in at least one corresponding structure selected from: a rack, a shelf, and a growing unit comprising a selectively fluidly isolatable structure.

In some embodiments of method 3600, a vertical farm may include the plurality of plant growing units.

In some embodiments of method 3600, the outcome description value may include at least one value selected from the values consisting of: a plant type, a cultivar, a plant growth stage, a target plant growth rate, a target plant growth trajectory, a harvest characteristic, a certification value, and a verification value.

In some embodiments of method 3600, the planting instruction value may include at least one value selected from the values consisting of: a type of harvested plant, a specified cultivar, a set of acceptable cultivars, a harvest characteristic, a time value of any one or more of the foregoing, a quantity of any one or more of the foregoing, and a trajectory of any one or more of the foregoing. Furthermore, in some embodiments of method 3600, the harvest characteristic may include at least one value selected from the values consisting of: a nutrient profile, a certification description, a verification description, a chain-of-custody description, and a support description relating to any one or more of the foregoing. Some of these values, such as the nutrient profile, may relate to plant features, and may include, for example, low nitrate values, while others of these values, such as the certification description, verification description, and chain-of-custody description, may relate to harvested features. The support description may include, for example, shelf space, a sensor package, a personnel package, or any other supply aspect that may need to be enhanced to support the harvest characteristic—for example, Kosher certification, low nitrate, or other aspect that may require additional personnel, more shelf space, more responsive sensor interrogation, etc. which may also lead to other aspects such as enhanced growing speed, etc.

In some embodiments of method 3600, the nutrient mix value may include at least one parameter selected from the parameters consisting of: a quantitative nutrient description, a categorical nutrient description, a nutrient variance description, a nutrient minimum description, a nutrient maximum description, a nutrient time frame description, a plant growing unit isolation value, a nutrient sourcing description, a statistical description of any one or more of the foregoing within one or more domains including a time domain, a growth unit domain, a plant type domain, a growth stage domain, a harvest count domain, and/or a harvesting unit domain, and/or a trajectory of any one or more of the foregoing within one or more domains including a time domain, a growth unit domain, a plant type domain, a growth stage domain, a harvest count domain, and/or a harvesting unit domain.

In some embodiments of method 3600, a first group of nutrient mix values may correspond to a subset of the plurality of plant growing units.

In some embodiments of method 3600, the nutrient mix values within the first group of nutrient mix values may further include a first association between members within the first group of nutrient mix values, and a second association between each member of the first group of nutrient mix values and a second group of nutrient mix values that are not within the first group of nutrient mix values. The first association may be distinct from the second association.

In some embodiments of method 3600, a distinction between the first association and the second association may include at least one parameter selected from the parameters consisting of: an isolation description value between the plant growing units, variance in a statistical description between the first group of nutrient mix values and the second group of nutrient mix values, variance in a nutrient limit description between the first group of nutrient mix values and the second group of nutrient mix values, and variance in a planting instruction value responsiveness between the first group of nutrient mix values and the second group of nutrient mix values.

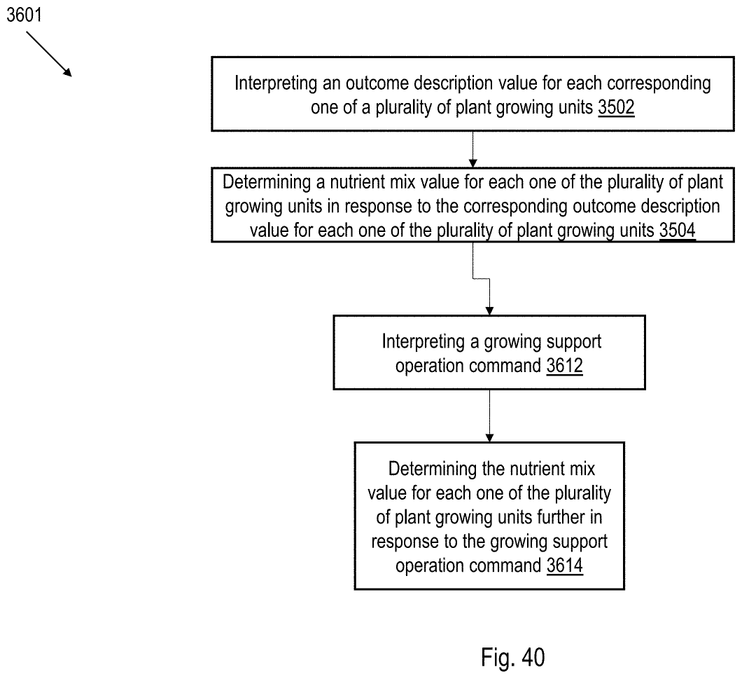

With reference to FIG. 40, an illustrative and non-limiting example method 3601 of determining a nutrient mix value is depicted. The method 3601 may include the operation 3502 of interpreting the outcome description value for each corresponding one of a plurality of plant growing units, and the operation 3504 of determining the nutrient mix value for each one of the plurality of plant growing units in response to the corresponding outcome description value for each one of the plurality of plant growing units. Furthermore, the method 3601 may include the operation 3612 of interpreting a growing support operation command, and an operation 3614 of determining the nutrient mix value for each one of the plurality of plant growing units further in response to the growing support operation command.

In some embodiments of method 3600, the growing support operation command may include a growing capacity description.

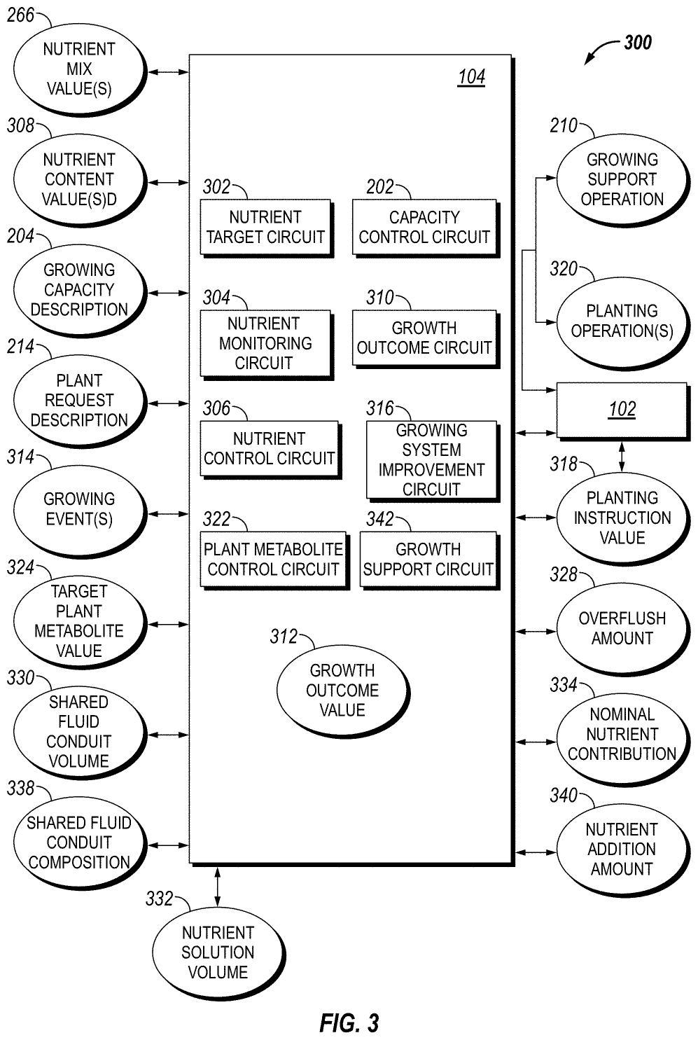

With reference to FIG. 3, an illustrative and non-limiting farm management system 300 is depicted. The system 300 may include a plant growing unit 106 (e.g., as part of a physical growing unit 102 such as depicted in FIG. 1), a nutrient target circuit 302 structured to interpret a nutrient mix value 226 for the plant growing unit 106, a nutrient monitoring circuit 304 structured to determine at least one nutrient content value 308 for the plant growing unit 106, and a nutrient control circuit 306 structured to adjust the at least one nutrient content value 308 in response to the nutrient mix value 226.

In some embodiments, the system 300 may further include a nutrient monitoring sensor 550 (see, e.g., FIG. 5 and description thereof) structured to provide the at least one nutrient content value 308. The nutrient monitoring sensor 550 may be selectively fluidly coupled to the plant growing unit 106.

In some embodiments, the nutrient target circuit 302 may be further structured to interpret a plurality of nutrient mix values 226 each corresponding to one of a plurality of plant growing units 106. Furthermore, the nutrient monitoring sensor 550 may be selectively fluidly coupled to each of the plurality of plant growing units 106.

With reference to FIG. 18, which depicts an illustrative and non-limiting example 1800 of fluid paths between a nutrient monitoring sensor and a plurality of plant growing units as part of the system 300, the fluids paths may include a first fluid path 1810 between the nutrient monitoring sensor 550 and a first one of the plurality of plant growing units 106A, and a second fluid path 1812 between the nutrient monitoring sensor 550 and a second one of the plurality of plant growing units 106B. The first fluid path 1810 and the second fluid path 1812 may include a shared fluid conduit portion 1802 coupled to the nutrient monitoring sensor 550. Each of the first fluid path 1810 and the second fluid path 1812 may include one or more valves 1808 between the respective plant growing units 106A and 106B and the shared fluid conduit portion 1802. The valves provide fluid isolation of the growing units 106A, 106B. A given system may not include the valves, may not include all of the valves (e.g., accepting some isolation that may be of lower quality), and/or may include additional valves. Furthermore, the first one of the plurality of plant growing units 106A may be coupled (e.g., fluidly coupled) to a nutrient provider 1804 through one or more valves 1808, and likewise, the second one of the plurality of plant growing units 106B may be coupled (e.g., fluidly coupled) to the nutrient provider 1804 through one or more valves 1808. The example of FIG. 18 allows for a single nutrient monitoring sensor 550 to provide monitoring operations for multiple growing units 106A, 106B, while still sampling individual fluid for the separate growing units 106A, 106B. Similarly, a single nutrient provider 1804 to deliver nutrients to multiple growing units 106A, 106B (e.g., including continuous pump operations into the circulating fluid with the growing unit 106A, 106B, and/or including a batch operation such as a tank and mixer, to provide discrete nutrient delivery operations to the growing unit 106A, 106B). In certain embodiments, for example depending upon the type of devices utilized to perform the nutrient monitoring and nutrient providing operations, the nutrient monitoring sensor and/or nutrient provider are devices that incur significant costs, such as: high capital investment, high operating costs, high training cost for operators, and/or high integration costs such as fluid line installations and/or large physical device size.

In some embodiments, the nutrient monitoring circuit 304 may be communicatively coupled to the nutrient monitoring sensor 550, and may be structured to switch from monitoring the first one of the plurality of plant growing units 106A to the second one of the plurality of plant growing units 106B. The monitoring by nutrient monitoring sensor 550 of each of the plurality of plant growing units 106A and 106B may include sampling a nutrient solution from a respective one of each of the first one of the plurality of plant growing units 106A and the second one of the plurality of plant growing units 106B. Example and non-limiting nutrient monitoring sensor(s) 550 may utilize any known composition determination technology, including technologies that are constrained within known bounds according to likely disturbances (e.g., a lower cost optical sensor that can distinguish an amount of a constituent, assuming that some other constituent having a similar optical peak is not present—which may be acceptable where confounding constituents are not a concern). Example and non-limiting nutrient monitoring sensor(s) 550 include electrical conductivity sensors, viscosity sensors, density sensors, pH sensors, salinity sensors, ultrasonic sensors, chromatography based sensors, and/or optical sensors.

In some embodiments, the nutrient monitoring circuit 304 may be further structured to selectively overflush the shared fluid conduit portion 1802. Furthermore, in some embodiments, the nutrient monitoring circuit 304 may be further structured to determine an overflush amount 328 in response to a volume of the shared fluid conduit portion 1802. For example, the nutrient monitoring circuit 304, when monitoring and/or providing nutrients to growing unit 106A, may isolate growing unit 106B (e.g., closing fluid path 1812), circulate fluid with growing unit 106A, which may include an overflush (e.g., greater than a plug-flow estimated amount of fluid that would fully displace the shared fluid conduit portion 1802), and command nutrient monitoring operations after the circulating fluid with growing unit 106A. The overflush may be a fixed amount—for example one gallon more than the minimum, a ratio such as a multiple of the minimum, and/or an adjusted amount based on changes to the minimum (e.g., where different growing units 106A, 106B have a different shared volume, such as when 3 or more growing units 106 are present). The operations of the example of FIG. 18 allow for a single nutrient monitoring circuit 304 and/or nutrient provider 1804 to service multiple growing units 106, while still allowing for individualized determination and control of nutrient fluid.

In some embodiments, the nutrient monitoring circuit 304 may be communicatively coupled to the nutrient monitoring sensor 550, and may be structured to compensate the at least one nutrient content value 308 of the second one of the plurality of plant growing units 106B in response to at least one of a volume 330 of the shared fluid conduit portion 1802 or a volume 332 of the nutrient solution of the second one of the plurality of plant growing units 106B. For example, the nutrient monitoring circuit 304 may estimate an effect of residual fluid within the shared fluid conduit portion 1802 on a measured parameter, and compensate the parameter accordingly. The effect of the shared volume may be greater based on the ratio of the shared fluid volume and the nutrient solution volume of the growing unit. Further, the effect may be compensated based on a difference in nutrient solution composition between the growing units—for example where a large difference between the units will produce a greater change in the shared fluid conduit portion relative to the intended measured fluid. In certain embodiments, the compensation may be scheduled according to time, circulated fluid volume, overflush amount, etc.

In some embodiments, the nutrient monitoring circuit 304 may be further structured to compensate the at least one nutrient content value 308 of the second one of the plurality of plant growing units 106B by performing at least one operation selected from the operations consisting of: performing a statistical analysis over several measurements of the at least one nutrient content value 308 of the second one of the plurality of plant growing units 106B (e.g., to determine a rate of change, convergence value, or the like indicating that the value is settling to the real value), determining a nominal nutrient contribution 334 in response to at least one of the volume 330 of the shared fluid conduit portion 1802 and an estimated composition 338 of the 330 volume of the shared fluid conduit portion 1802 and compensating the at least one nutrient content value 308 of the second one of the plurality of plant growing units 106B in response to the nominal nutrient contribution 334, and compensating the at least one nutrient content value 308 of the second one of the plurality of plant growing units 106B further in response to an overflush amount 328. In some embodiments, an example of performing the statistical analysis over the several measurements of the at least one nutrient content value 308 of the second one of the plurality of plant growing units 106B may include performing the statistical analysis over three or more measurements of the at least one nutrient content value 308 of the second one of the plurality of plant growing units 106B. However, embodiments are not limited thereto.

The nutrient control circuit 306 may be further structured to compensate the adjustment of the at least one nutrient content value 308 for the second one of the plurality of plant growing units 106B in response to at least one of a volume 330 of the shared fluid conduit portion 1802 or a volume 332 of the nutrient solution of the second one of the plurality of plant growing units 106B.

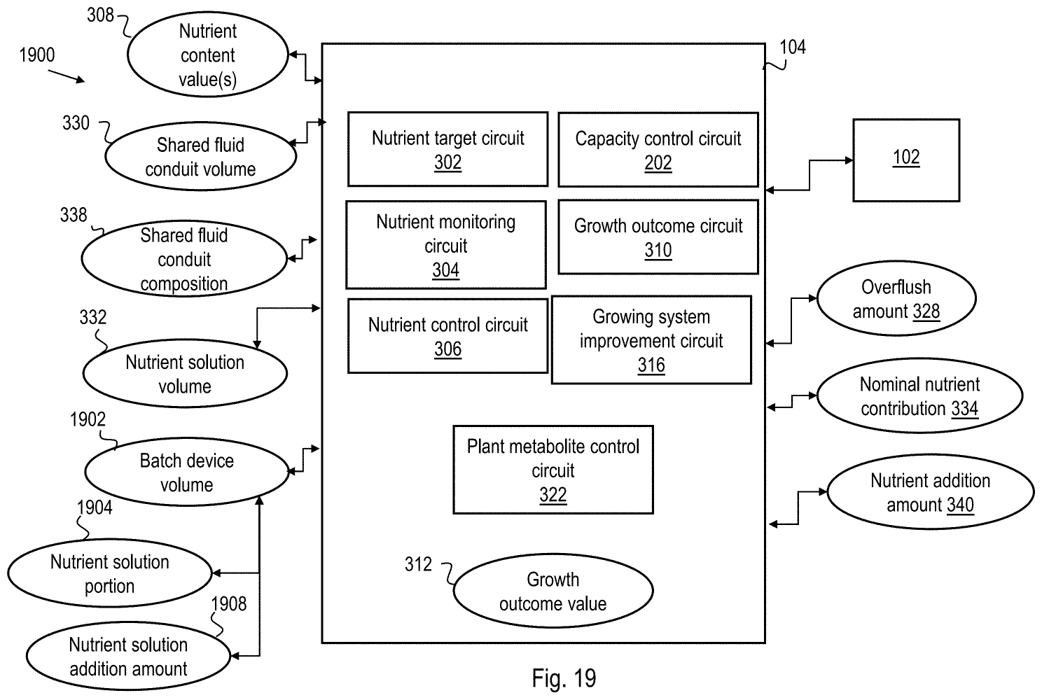

With reference to FIG. 19, an illustrative and non-limiting farm management system 1900 is depicted. As shown in FIG. 19, the nutrient control circuit 306 may be further structured to compensate the adjustment of the at least one nutrient content value 308 for the second one of the plurality of plant growing units 106B by performing at least one operation selected from the operations consisting of: 1) determining a nutrient addition amount 340 in response to at least one of: a volume of a batch device 1902 holding one of: a portion 1904 of a nutrient solution taken from the second one of the plurality of plant growing units 106B, or a nutrient solution addition amount 1908 to be added to the nutrient solution of the second one of the plurality of plant growing units 106B; 2) determining a nominal nutrient contribution 334 in response to at least one of the volume 330 of the shared fluid conduit portion 1802 and an estimated composition 338 of the volume 330 of the shared fluid conduit portion 1802, and compensating the at least one nutrient solution addition amount 1908 of the second one of the plurality of plant growing units 106B in response to the nominal nutrient contribution 334; and 3) providing the nutrient addition amount 340 divided over several nutrient addition operations, where a nutrient monitoring circuit 304 that may be communicatively coupled to the nutrient monitoring sensor 550 may be further structured to update the at least one nutrient content value 308 between at least two of the several nutrient addition operations. In some embodiments, an example of providing the nutrient addition amount 340 divided over several nutrient addition operations may include providing the nutrient addition amount 340 divided over three or more nutrient addition operations. However, embodiments are not limited thereto.

In some embodiments, the nutrient control circuit 306 may be further structured to compensate the adjustment of the at least one nutrient content value 308 for the second one of the plurality of plant growing units 106B in response to at least one of: the volume 330 of the shared fluid conduit portion 1802, a volume 332 of the nutrient solution of the second one of the plurality of plant growing units 106B, or the compensated at least one nutrient content value 308 of the second one of the plurality of plant growing units 106B.

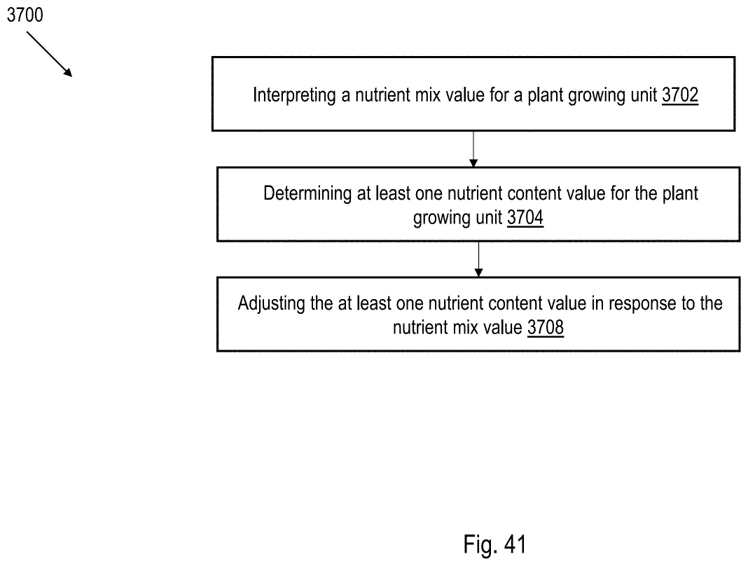

With reference to FIG. 41, an illustrative and non-limiting example method 3700 of adjusting a nutrient content value is depicted. The method 3700 may include an operation 3702 of interpreting a nutrient mix value for a plant growing unit, an operation 3704 of determining at least one nutrient content value for the plant growing unit, and an operation 3708 of adjusting the at least one nutrient content value in response to the nutrient mix value.

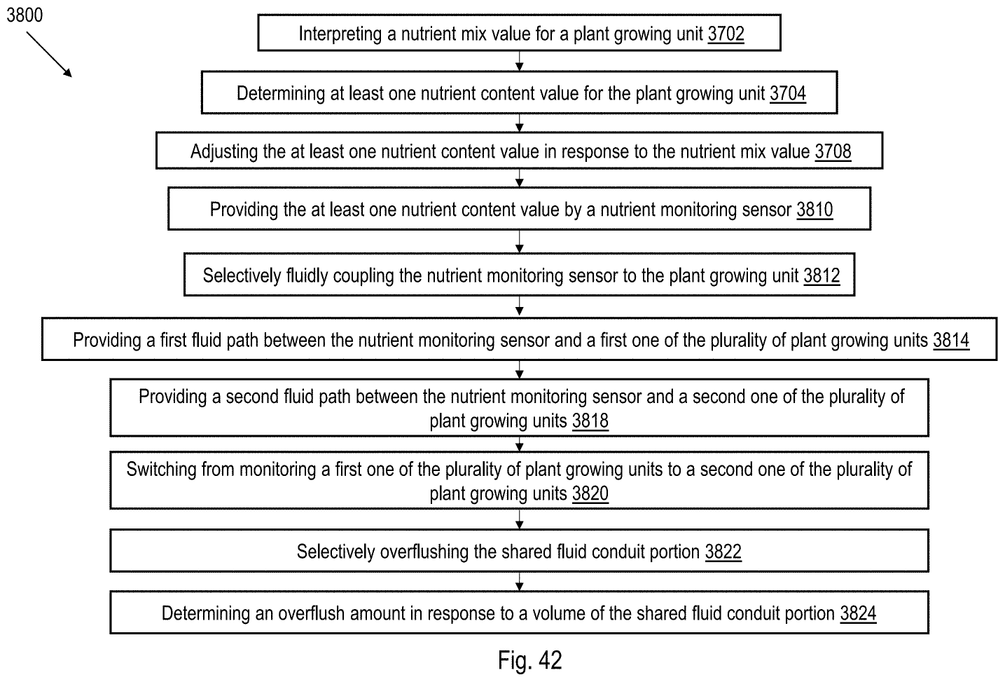

With reference to FIG. 42, an illustrative and non-limiting example method 3800 of adjusting a nutrient content value is depicted. The method 3800 may include the operation 3702 of interpreting the nutrient mix value for a plant growing unit, the operation 3704 of determining at least one nutrient content value for the plant growing unit, and the operation 3708 of adjusting the at least one nutrient content value in response to the nutrient mix value. Furthermore, the method 3800 may include an operation 3810 of providing the at least one nutrient content value by a nutrient monitoring sensor, and an operation 3812 of selectively fluidly coupling the nutrient monitoring sensor to the plant growing unit.

Also, in some embodiments, operation 3702 of the method 3800 may include interpreting a plurality of nutrient mix values each corresponding to one of a plurality of plant growing units, and operation 3812 of the method 3800 may include selectively fluidly coupling the nutrient monitoring sensor to each of the plurality of plant growing units.

Also, in some embodiments, the method 3800 may further include an operation 3814 of providing a first fluid path between the nutrient monitoring sensor and a first one of the plurality of plant growing units, and an operation 3818 of providing a second fluid path between the nutrient monitoring sensor and a second one of the plurality of plant growing units. The first fluid path and the second fluid path may include a shared fluid conduit portion.

Also, in some embodiments, the method 3800 may further include an operation 3820 of switching from monitoring a first one of the plurality of plant growing units to a second one of the plurality of plant growing units. The monitoring of each of the plurality of plant growing units may include sampling a nutrient solution from a respective one of each of the first one of the plurality of plant growing units and the second one of the plurality of plant growing units.

Also, in some embodiments, the method 3800 may further include an operation 3822 of selectively overflushing the shared fluid conduit portion.

Also, in some embodiments, the method 3800 may further include an operation 3824 of determining an overflush amount in response to a volume of the shared fluid conduit portion.

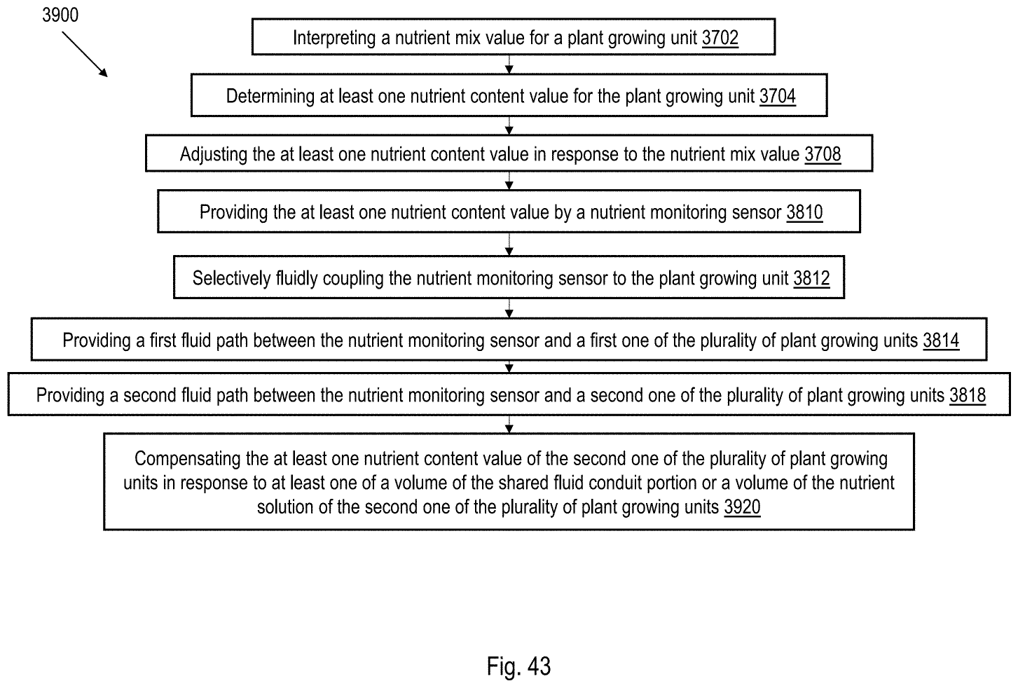

With reference to FIG. 43, an illustrative and non-limiting example method 3900 of adjusting a nutrient content value is depicted. The method 3900 may include the operation 3702 of interpreting the nutrient mix value for a plant growing unit, the operation 3704 of determining at least one nutrient content value for the plant growing unit, the operation 3708 of adjusting the at least one nutrient content value in response to the nutrient mix value, the operation 3810 of providing the at least one nutrient content value by the nutrient monitoring sensor, the operation 3812 of selectively fluidly coupling the nutrient monitoring sensor to the plant growing unit, the operation 3814 of providing the first fluid path between the nutrient monitoring sensor and a first one of the plurality of plant growing units, and the operation 3818 of providing the second fluid path between the nutrient monitoring sensor and the second one of the plurality of plant growing units. Furthermore, the method 3900 may include an operation 3920 of compensating the at least one nutrient content value of the second one of the plurality of plant growing units in response to at least one of a volume of the shared fluid conduit portion or a volume of the nutrient solution of the second one of the plurality of plant growing units.

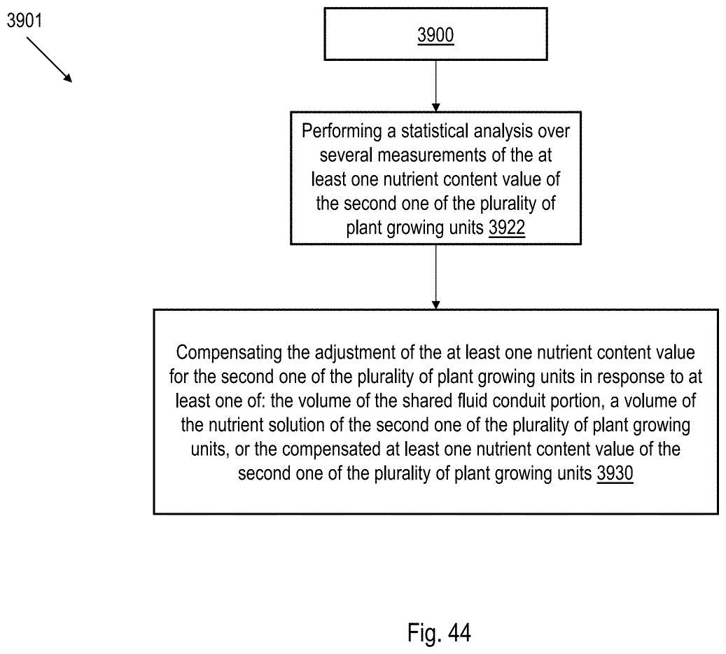

With reference to FIG. 44, an illustrative and non-limiting example method 3901 of adjusting a nutrient content value is depicted. The method 3901 may include the operations of method 3900, as may be described and depicted herein. Furthermore, method 3901 may include an operation 3922 of performing a statistical analysis over several measurements of the at least one nutrient content value of the second one of the plurality of plant growing units.

In some embodiments, the method 3901 may further include an operation 3930 of compensating the adjustment of the at least one nutrient content value for the second one of the plurality of plant growing units in response to at least one of: the volume of the shared fluid conduit portion, a volume of the nutrient solution of the second one of the plurality of plant growing units, or the compensated at least one nutrient content value of the second one of the plurality of plant growing units.

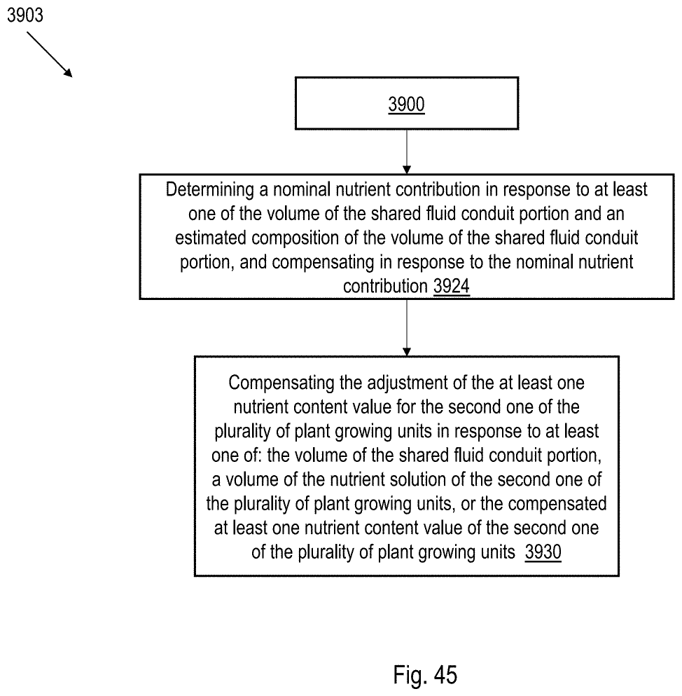

With reference to FIG. 45, an illustrative and non-limiting example method 3903 of adjusting a nutrient content value is depicted. The method 3903 may include the operations of method 3900, as may be described and depicted herein. Furthermore, the method 3901 may further include an operation 3924 of determining a nominal nutrient contribution in response to at least one of the volume of the shared fluid conduit portion and an estimated composition of the volume of the shared fluid conduit portion, and compensating the at least one nutrient content value of the second one of the plurality of plant growing units in response to the nominal nutrient contribution.

In some embodiments, the method 3903 may further include the operation 3930 of compensating the adjustment of the at least one nutrient content value for the second one of the plurality of plant growing units in response to at least one of: the volume of the shared fluid conduit portion, a volume of the nutrient solution of the second one of the plurality of plant growing units, or the compensated at least one nutrient content value of the second one of the plurality of plant growing units.

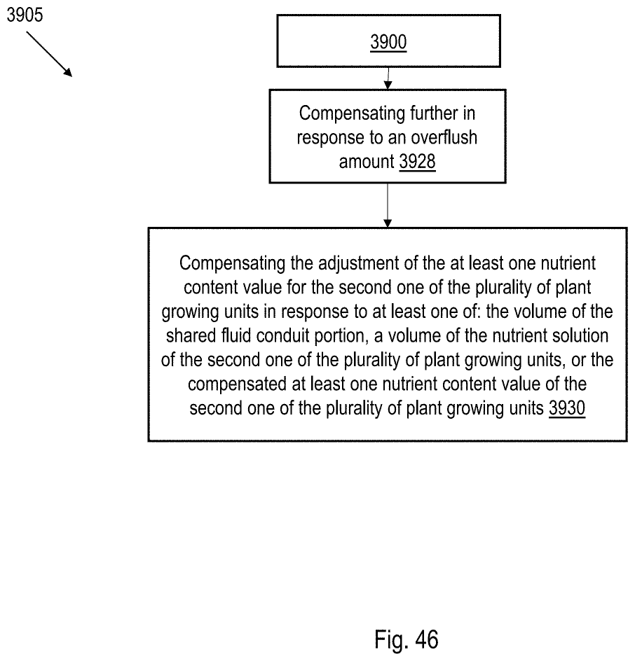

With reference to FIG. 46, an illustrative and non-limiting example method 3905 is depicted. The method 3905 may include the operations of method 3900, as may be depicted and described herein. Furthermore, method 3905 may include an operation 3928 of compensating the at least one nutrient content value of the second one of the plurality of plant growing units further in response to an overflush amount.

In some embodiments, the method 3905 may further include the operation 3930 of compensating the adjustment of the at least one nutrient content value for the second one of the plurality of plant growing units in response to at least one of: the volume of the shared fluid conduit portion, a volume of the nutrient solution of the second one of the plurality of plant growing units, or the compensated at least one nutrient content value of the second one of the plurality of plant growing units.

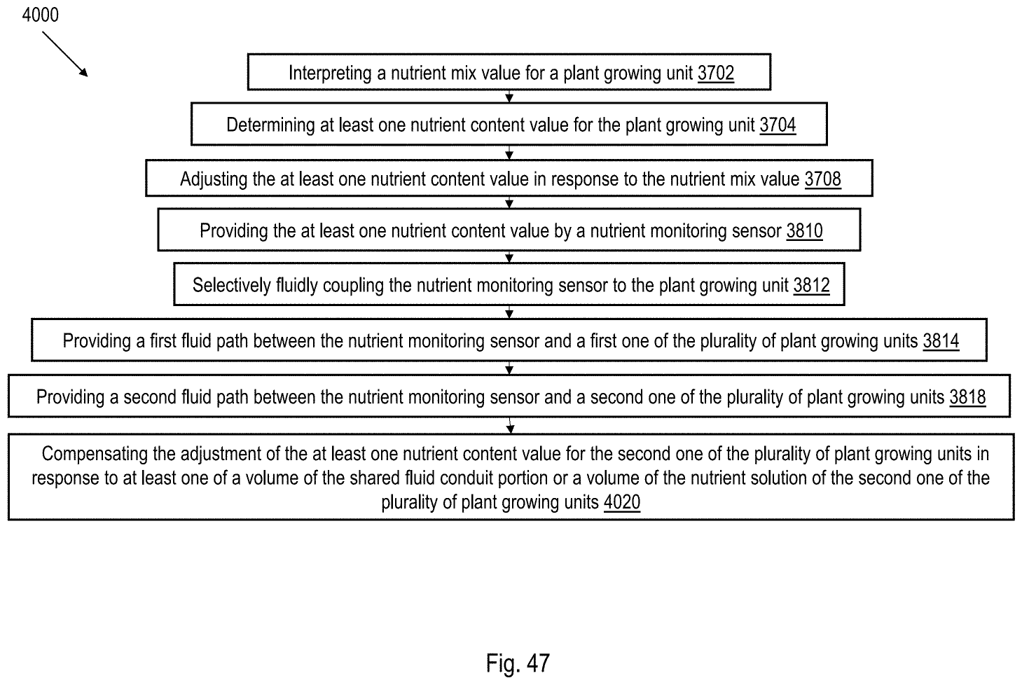

With reference to FIG. 47, an illustrative and non-limiting example method 4000 of adjusting a nutrient content value is depicted. The method 4000 may include the operation 3702 of interpreting the nutrient mix value for a plant growing unit, the operation 3704 of determining at least one nutrient content value for the plant growing unit, the operation 3708 of adjusting the at least one nutrient content value in response to the nutrient mix value, the operation 3010 of providing the at least one nutrient content value by the nutrient monitoring sensor, the operation 3812 of selectively fluidly coupling the nutrient monitoring sensor to the plant growing unit, the operation 3814 of providing the first fluid path between the nutrient monitoring sensor and a first one of the plurality of plant growing units, the operation 3818 of providing the second fluid path between the nutrient monitoring sensor and the second one of the plurality of plant growing units, and the operation 4020 of compensating the adjustment of the at least one nutrient content value for the second one of the plurality of plant growing units in response to at least one of a volume of the shared fluid conduit portion or a volume of the nutrient solution of the second one of the plurality of plant growing units.

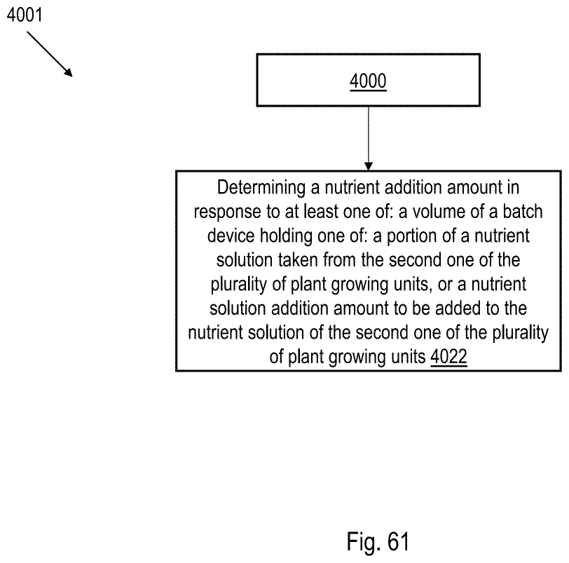

With reference to FIG. 61, an illustrative and non-limiting example method 4001 of adjusting a nutrient content value is depicted. The method 4001 may include the operations of method 4000, as may depicted and described herein. Furthermore, the method 4001 may include an operation 4022 of determining a nutrient addition amount in response to at least one of: a volume of a batch device holding one of: a portion of a nutrient solution taken from the second one of the plurality of plant growing units, or a nutrient solution addition amount to be added to the nutrient solution of the second one of the plurality of plant growing units.

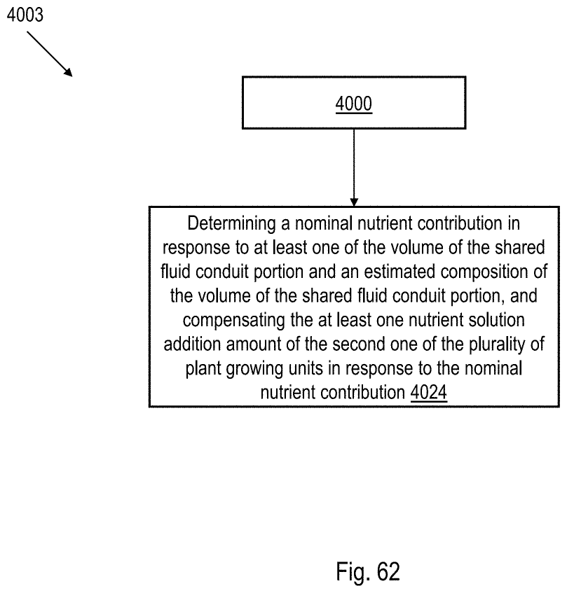

With reference to FIG. 62, an illustrative and non-limiting example method 4003 of adjusting a nutrient content value is depicted. The method 4003 may include the operations of method 4000, as may be depicted and described herein. Furthermore, the method 4003 may include an operation 4024 of determining a nominal nutrient contribution in response to at least one of the volume of the shared fluid conduit portion and an estimated composition of the volume of the shared fluid conduit portion, and compensating the at least one nutrient solution addition amount of the second one of the plurality of plant growing units in response to the nominal nutrient contribution.

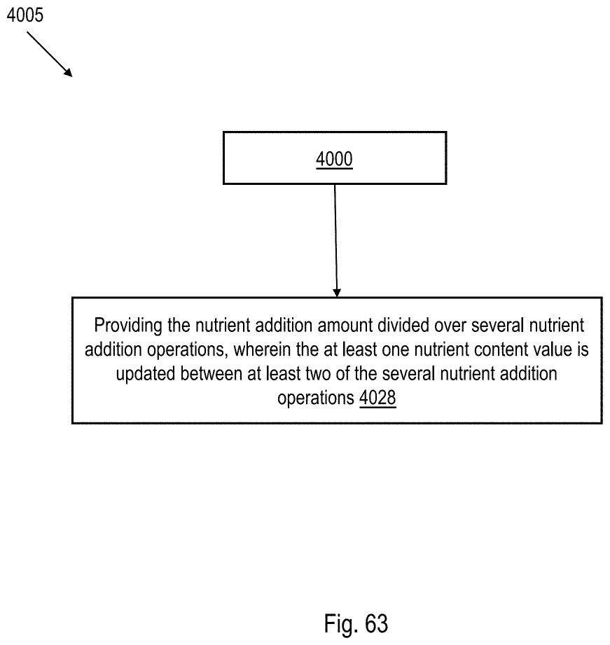

With reference to FIG. 63, an illustrative and non-limiting example method 4005 of adjusting a nutrient content value is depicted. The method 4005 may include the operations of method 4000, as may be depicted and described herein. Furthermore, the method 4005 may include an operation 4028 of providing the nutrient addition amount divided over several nutrient addition operations, wherein the at least one nutrient content value is updated between at least two of the several nutrient addition operations.

Referencing FIG. 71, an example apparatus 7100 is depicted for performing certain operations to iteratively improve growth outcome value(s) 312 for a physical growing unit 102, such as depicted in reference to FIG. 1, and which may include one or more enclosures and/or indoor vertical farm units. The example of FIG. 71 is utilizable with regard to any systems, apparatuses, assemblies, or other embodiments set forth herein. Additionally or alternatively, the example of FIG. 71 may be utilized, in whole or part, to implement operations of any methods, procedures, or operational descriptions set forth herein. Without limitation to any other aspect of the present disclosure, a growth outcome value 312 may relate to parameters such as: a cost of producing a harvest product, product for an order, and/or a specific cost per unit (e.g., plant count, harvest weight, harvest volume, etc.); a cost to achieve a certification and/or verification target for a harvest product; a resource utilization to produce a harvest product, product for an order, and/or a specific utilization per unit (e.g., where resource utilization may include any resource, such as power consumption, shelf space/time, nutrient stock consumption, water consumption, personnel resources, storage resources such as supplies, inventory, and/or tank utilization, and/or computing resources); a yield of a harvest product; a rejection rate of a harvest product; a harvest characteristic conformity (e.g., whether a certification and/or verification will be achieved); and/or a delivery time conformity (e.g., on-time, early, or late) of a harvest product. In certain embodiments, operations of the apparatus 7100 provides for iterative improvement to any one or more of the growth outcome value(s) 312, and/or to a combined basket (e.g., weighted, unweighted, and/or normalized) of growth outcome values 312. Without limitation to any other aspect of the present disclosure, a growth outcome value 312 includes one or more parameters such as: a power intensity of the growing event; a nutrient intensity of the growing event; a water intensity of the growing event; a personnel utilization intensity of the growing event; a yield of the growing event; a capacity utilization contribution of the growing event to the physical growing unit; a match of a set of plants related to the growing event to the plant request description; a match of a set of plants related to the growing event to the growing capacity description; and/or a success value entered by a user utilizing a user interface implemented by the growing system improvement circuit in response to the growing event.

The example apparatus 7100 includes a capacity control circuit 202 structured to interpret at least one of a growing capacity description 204 or a plant request description 214, a growth outcome circuit 310 that determines a growth outcome value 312, and a growing system improvement circuit 316 that iteratively adjusts a planting instruction value 208 in response to at least one of the growing capacity description 204 or the plant request description 214, and further in response to the growth outcome value 312 for the growing event 314. A growing event 314, as utilized herein, references a growing progression through at least selected stages (e.g., germination, plantlet development, harvest, etc.) for a selected group of plants 108. An example growing event 314 includes a group of plants 108 responsive to an order or plant request description 214. An example growing event 314 includes, without limitation, a group of plants 108 associated with the entire physical growing unit 102 for a predetermined period, and/or a group of plants 108 associated with a cultivar, specified enclosure(s), and/or specified buyers/customers.

An example growing capacity description 204 includes a delivery target value for at least one aspect of an indoor vertical farm of the physical growing unit, for example a plant weight, plant growth progression, readiness to move on to a next enclosure, readiness for harvest, etc. In certain embodiments, a delivery target value includes one or more of: a personnel value (e.g., specific targeted personnel, and/or personnel criteria such as qualifications, shift length, etc.); a seedling value (e.g., a number and/or type of seedlings); a plantlet value (e.g., a number and/or type of plantlets); a shelf capacity value (e.g., an acceptable utilization, reserve capacity amount, plant packing limits for a shelf and/or tray, etc.); a nutrient delivery value (e.g., nutrient constituents, delivery rates, etc.); a power value (e.g., power utilization, incremental power utilization, and/or time of power demand in calendar time, time-of-day, etc.); a water value (e.g., water utilization, incremental water utilization, water treatment requirements, etc.); a cleaning capacity value (e.g., based on tray utilization, cleaning, and disposal, and/or based on certification requirements, etc.); a cultivar supplier value (e.g., a capacity, delivery time, or other related value for a supplier of a cultivar, including potentially cultivars having multiple suppliers available); and/or a trajectory of any of these. The example growing capacity description(s) 204 are provided for illustration, and any growing capacity description 204, including at least any growing capacity description 204 set forth throughout the present disclosure, is contemplated for the growing capacity description 204.

An example plant request description 214 includes any one or more of: a harvest date; a harvest amount; a delivery date (e.g., offset from the harvest date, and/or scheduled according to delivery resources and the harvest date); a delivery amount (e.g., accounting for secondary effects of the amount on delivery, for example where a delivery amount indicates that an alternate vehicle, delivery provider, etc. may be required); a cultivar description (e.g., allowing for a learning algorithm 7102 to identify cultivars that drive differences in growth outcome values 312); a type of plant description (e.g., a variety, and/or a category of plant, which may be grouped at a broader level than a specific cultivar); a harvest characteristic (e.g., harvest requirements); a nutrient description (e.g., nutrient listing, concentrations, delivery volumes to support a group of plants 108, etc.); a certification description (e.g., features and/or operations required according to relevant certifications related to the group of plants 108); and/or a verification description (e.g., parameters to be monitored, for example to meet a certification, regulatory compliance, and/or for process management). In certain embodiments, a harvest characteristic includes any one or more of: a nutrient profile; a certification description; a verification description; a chain-of-custody description; and/or a support description relating to any one or more of the foregoing. The example plant request description(s) 214 are provided for illustration, and any plant request description 214, including at least any plant request description 214 set forth throughout the present disclosure, is contemplated for the plant request description 214.

An example growing system improvement circuit iteratively adjust the planting instruction value by performing any one or more operations such as: providing a capacity indication related to an indoor vertical farm of the physical growing unit; adjusting a capacity related to an indoor vertical farm of the physical growing unit; directing a planting operation; directing a transplanting operation; directing a supply operation; directing a cleaning operation; adjusting a growth rate; adjusting a nutrient solution transfer or monitoring schedule; adjusting a trajectory of any one or more of the foregoing; providing a report related to any one or more of the foregoing; and validating any one or more of the foregoing. The example operations to iteratively adjust the planting instruction value are illustrative, and any operations described throughout the present disclosure to adjust planting operations are contemplated herein, including at least operations to adjust a capacity of the physical growing unit and/or to adjust a growth rate of a group of plants 108.

An example growing system improvement circuit 316 iteratively adjusts the planting instruction value by operating a learning algorithm 7102, where the learning algorithm 7102 utilizes the growth outcome value 312 as an output (e.g., as the benefit value, or the value to be improved) and utilizes the growing capacity description 204 and/or the plant request description 214 as an input (e.g., setting constraints for the operating space of the learning algorithm 7102, subject to operations that can, for example, increase the growing capacity description 204, and/or operations that can reduce aspects of the plant request description 214, for example with a shared offset physical growing unit, and/or providing a partial delivery of a harvest product). Example and non-limiting learning algorithms 7102 may include one or more of: a machine learning algorithm; a neural network; a trained neural network; a plant model of the physical growing unit (e.g., a simplified and/or at least partially defined model); an undefined model (e.g., which may be built by a neural network, and which may be accessible to an operator, or not); a supervised neural network; a genetic algorithm; a fuzzy logic algorithm; and/or a Bayesian network. In certain embodiments, elements may be combined—for example a fuzzy logic controller that determines optimal planting schedules according to a modeled range of uncertainties, where the probabilistic elements of the fuzzy logic controller are iteratively improved by another element such as a neural network and/or machine learning algorithm. The example learning algorithms 7102 are non-limiting and provided for illustration. The implementation of a learning algorithm 7102 for embodiments of the present disclosure provides for a number of benefits relative to previously known systems. For example, the physical growing unit operating in a complex environment (e.g., with ordering and production changes, distinct constraints and environments for varying cultivars, and sequential processes with a complex delay interaction) includes a number of interactions that are not intuitive, and that may vary according to unmonitored parameters that may nevertheless be correlated to monitored parameters through the operations of the learning algorithm 7102. In certain embodiments, the learning algorithm 7102 is not constrained to expected parameters, but can monitor any information available to the controller 104 to determine parameters correlating to the desired outputs. For example, input water quality to a facility may vary according to the time of year (e.g., where the source and/or treatment varies with the seasons or other parameters), which may not be measured by the system and may cause seasonal variations in performance of the physical growing unit. In the example, the learning algorithm 7102 can determine a correlating parameter to the water quality variation, for example using calendar date, ambient temperature, or another correlating parameter, and determine appropriate responses to the varying water quality, without the operator or the learning algorithm 7102 necessarily identifying the root cause of the process variability. The example operations are a non-limiting illustration. A learning algorithm 7102 utilizing any available inputs to adjust operations and iteratively improve outputs is contemplated herein. It can be seen that the operations of the learning algorithm 7102 allow for iterative improvements whether the physical growing unit is fully modeled or not, and further allows for improving response to system disturbances that were not anticipated, or in certain embodiments allows for improving response to system disturbances that are not detected.

An example learning algorithm 7102 utilizes any one or more inputs such as: any sensor communicatively coupled to the physical growing unit; any data stored related to the physical growing unit; inventory values corresponding to plants, seedlings, seeds, or cultivars of the physical growing unit; personnel information related to the physical growing unit; capacity information related to the physical growing unit; external pricing information such as power prices, water prices, nutrient prices, or cultivar prices; supplier information including at least one of capacities, capabilities, or inventories; certification information for plants related to the physical growing unit; customer requests for plants related to the physical growing unit; historical information for any of the foregoing; and/or trajectories of any of the foregoing. In certain embodiments, a learning algorithm 7102 utilizes a processed version of any one or more of the foregoing, such as a filtered version, a frequency component analysis (e.g., to detect cyclical behavior, and/or multiple competing behaviors), and/or a statistical description of any of the foregoing. The example input values are provided for illustration, but any input value may be utilized, including at least any input value set forth throughout the present disclosure.

Without limitation to any other aspect of the present disclosure, example and non-limiting planting instruction value(s) 208 include one or more outputs such as: commands to any actuator operatively coupled to the physical growing unit; personnel scheduling related to the physical growing unit; inventory scheduling related to the physical growing unit; ordering of any supply aspect of the physical growing unit, including at least one of seeds, cultivars, power, water, nutrients; ordering of capital components of the physical growing unit (e.g., including at least additional components, replacement components, component requirements, an enclosure, a rack, a shelf, a tray, a lighting unit, a pump, a fan, and/or a water treatment and/or storage component); personnel hiring decisions or recommendations related to the physical growing unit (e.g., a distribution of personnel by shift, a personnel increase target to support operations, and/or a training recommendation for one or more persons); nutrient solution transfer or monitoring pump activity related to the physical growing unit; lighting schedules related to the physical growing unit; time relationships for modeled parameters of the learning algorithm; time relationships of any one or more of the foregoing; and/or trajectories of any one or more of the foregoing.

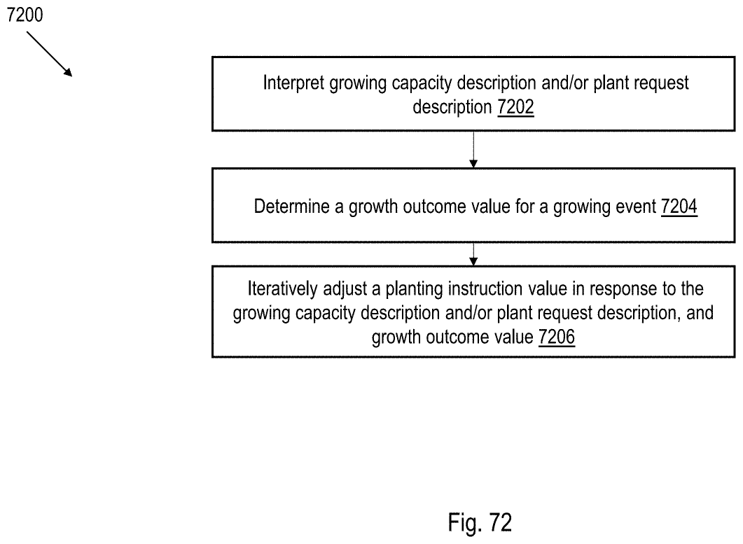

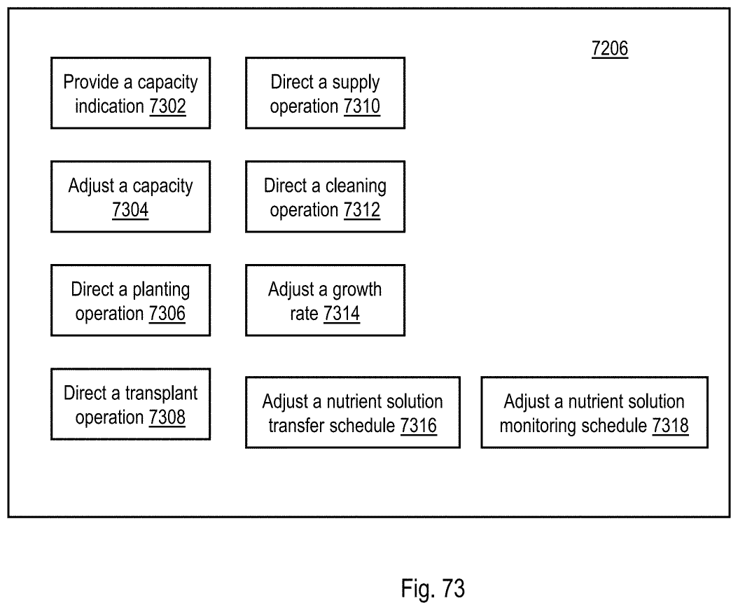

Referencing FIG. 72, an example procedure 7200 for iteratively adjusting a planting instruction value for a physical growing unit is schematically depicted. The example procedure 7200 includes an operation 7202 to interpret at least one of a growing capacity description or a plant request description, an operation 7204 to determine a growth outcome value for a growing event of at least one set of plants related to the physical growing unit, and an operation 7206 to iteratively adjust a planting instruction value in response to the growth outcome value, and further in response to at least one of the growing capacity description or the plant request description. Referencing FIG. 73, example operations 7206 are depicted to adjust the planting instruction value. Operations 7206 may include one or more of: an operation 7302 to provide a capacity indication related to the physical growing unit; an operation 7304 to adjust a capacity of the physical growing unit; an operation 7306 to direct a planting operation; an operation 7308 to direct a transplanting operation; an operation 7310 to direct a supply operation; an operation 7312 to direct a cleaning operation; an operation 7314 to adjust a growth rate; an operation 7316 to adjust a nutrient solution transfer schedule; and/or an operation 7318 to adjust a nutrient monitoring schedule.

It will be seen that numerous embodiments of the present disclosure provide a number of levers to improve growth outcome values, including at least: providing convenient interfaces for appropriate users to engage ordering, supplying, and operating the physical growing unit; allowing for scaled nutrient detection and control according to sets of plants 108, racks, shelves, and/or individual trays; adjustments to the trajectory of seedlings, plantlets, and/or plants through enclosures and/or components of the physical growing unit; adjustments to the growth rate of plants to enhance capacity while maintaining compliance with certifications, with visibility to consequent capacity limitations and/or corresponding adjustments to reduce or eliminate the effect of consequent capacity limitations. Embodiments of the present disclosure provide for mechanisms to monitor improvement operations and results, and to implement adjustments to the physical growing unit and related operations.

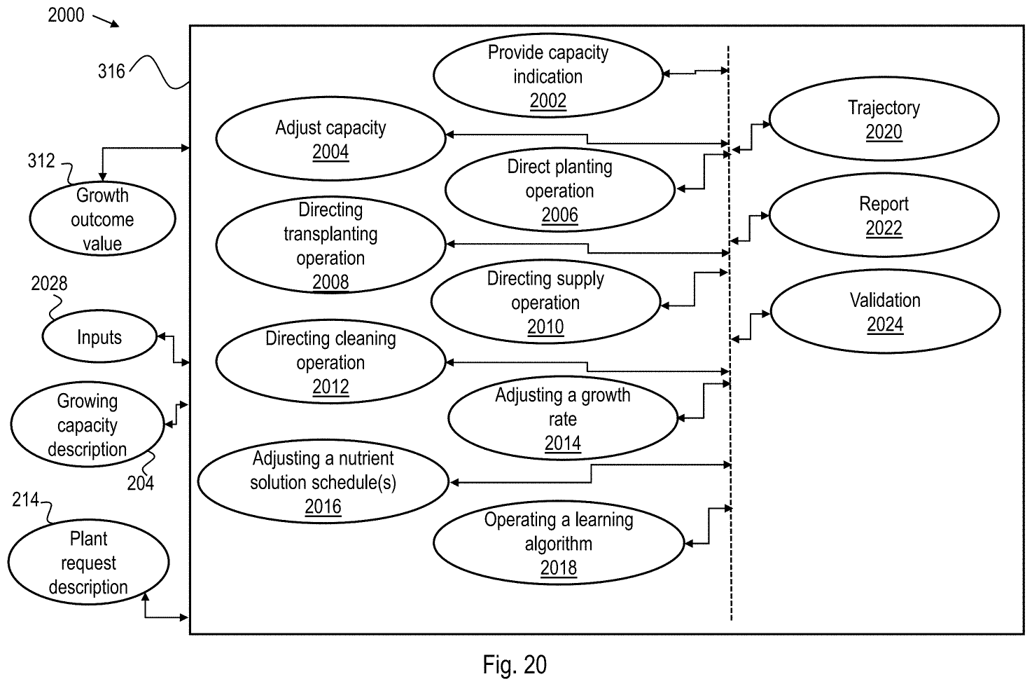

With reference to FIG. 20, an illustrative and non-limiting example apparatus 2000 is depicted. The apparatus 2000 includes a growing system improvement circuit 316 structured to iteratively adjust the planting instruction value by performing at least one operation selected from the operations consisting of: providing a capacity indication 2002 related to an indoor vertical farm; adjusting a capacity 2004 related to an indoor vertical farm; directing a planting operation 2006; directing a transplanting operation 2008; directing a supply operation 2010; directing a cleaning operation 2012; adjusting a growth rate 2014; adjusting a nutrient solution transfer or monitoring schedule 2016; adjusting a trajectory 2020 of any one or more of the foregoing; providing a report 2022 related to any one or more of the foregoing; and validating 2024 any one or more of the foregoing. The growing system improvement circuit 316 may be further structured to iteratively adjust the planting instruction value by operating a learning algorithm 2018 utilizing the at least one of the growing capacity description 204 or the plant request description 214 as inputs 2028, and the growth outcome value 312 as an output.

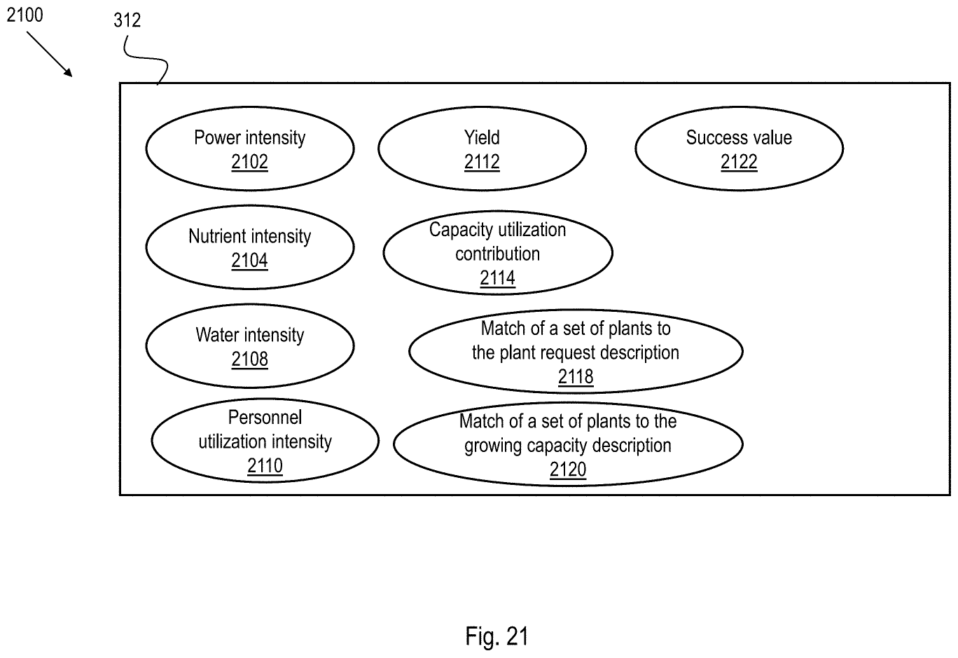

With reference to FIG. 21, an embodiment 2100 of the growth outcome value 312 may include at least one value selected from the values consisting of: a power intensity of the growing event 2102; a nutrient intensity 2104 of the growing event; a water intensity 2108 of the growing event; a personnel utilization intensity 2110 of the growing event; a yield 2112 of the growing event; a capacity utilization contribution 2114 of the growing event to the physical growing unit; a match of a set of plants related to the growing event to the plant request description 2118; a match of a set of plants related to the growing event to the growing capacity description 2120; and a success value 2122 entered by a user utilizing a user interface implemented by the growing system improvement circuit in response to the growing event.

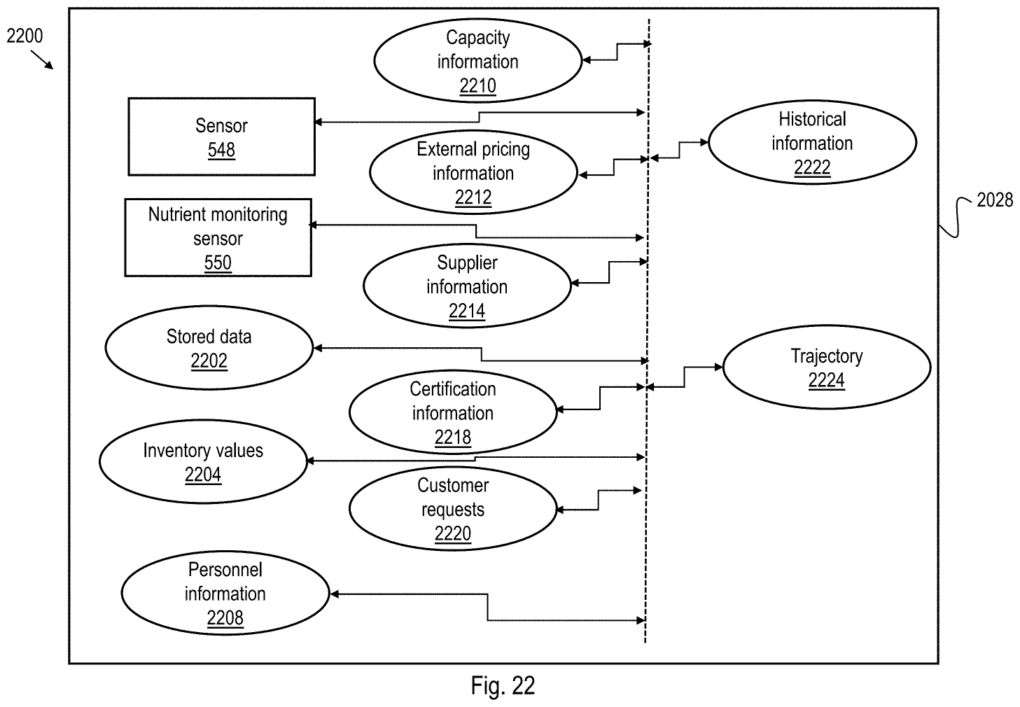

With reference to FIG. 22, an embodiment 2200 of inputs 2028 is depicted. The learning algorithm may have authority to implement any inputs 2028 comprising at least one input selected from the inputs consisting of: any sensor 548, 550 communicatively coupled to the physical growing unit; any data stored 2202 related to the physical growing unit; inventory values 2204 corresponding to plants, seedlings, seeds, or cultivars of the physical growing unit; personnel information 2208 related to the physical growing unit; capacity information 2210 related to the physical growing unit; external pricing information 2212 such as power prices, water prices, nutrient prices, or cultivar prices; supplier information 2214 including at least one of capacities, capabilities, or inventories; certification information 2218 for plants related to the physical growing unit; customer requests 2220 for plants related to the physical growing unit; historical information 2222 for any of the foregoing; and trajectories 2224 of any of the foregoing.

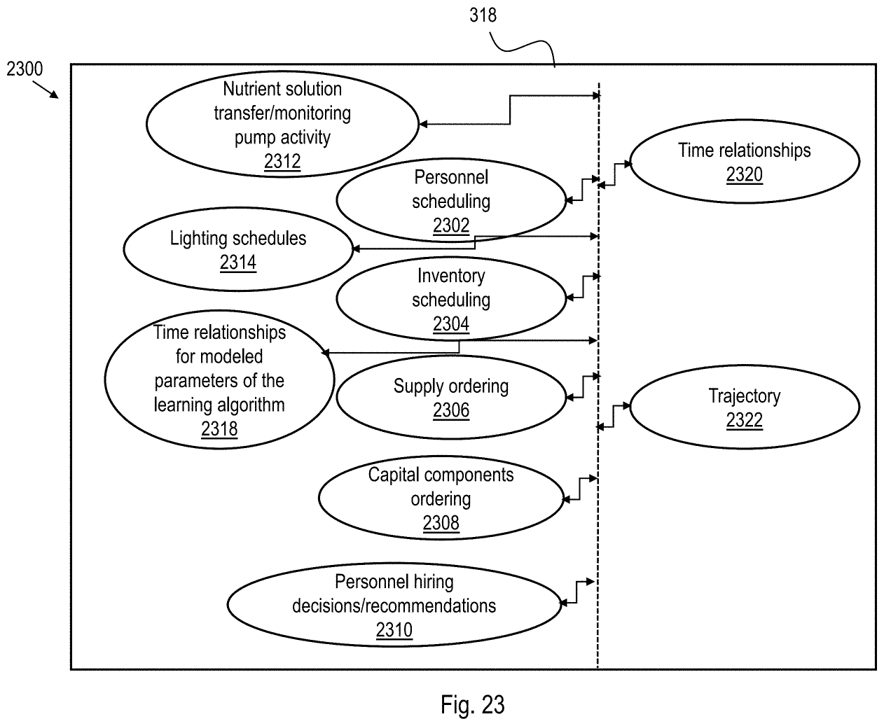

With reference to FIG. 23, an embodiment 2300 of a plant instruction value 318 is depicted. The learning algorithm may have authority to implement any plant instruction value 318 comprising at least one output selected from the outputs consisting of: any actuator 552 operatively coupled to the physical growing unit; personnel scheduling 2302 related to the physical growing unit; inventory scheduling 2304 related to the physical growing unit; ordering of any supply 2306 aspect of the physical growing unit, including at least one of seeds, cultivars, power, water, nutrients; ordering of capital components 2308 of the physical growing unit; personnel hiring decisions or recommendations 2310 related to the physical growing unit; nutrient solution transfer or monitoring pump activity 2312 related to the physical growing unit; lighting schedules 2314 related to the physical growing unit; time relationships for modeled parameters of the learning algorithm 2318; time relationships 2320 of any one or more of the foregoing; and trajectories 2322 of any one or more of the foregoing.

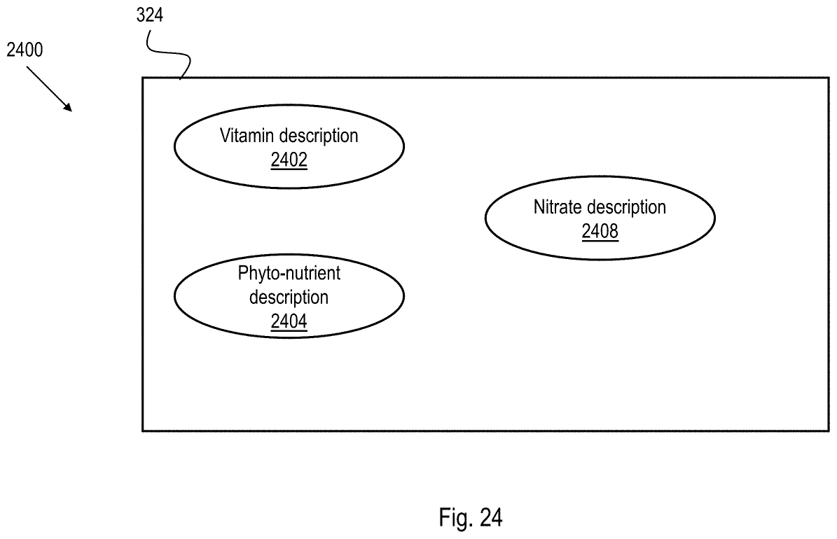

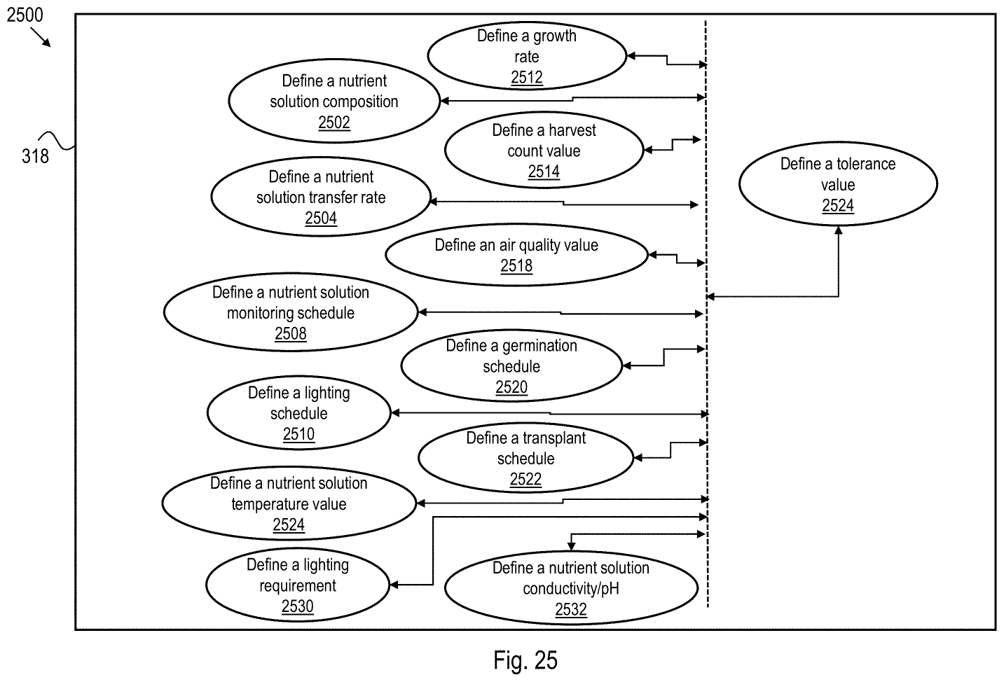

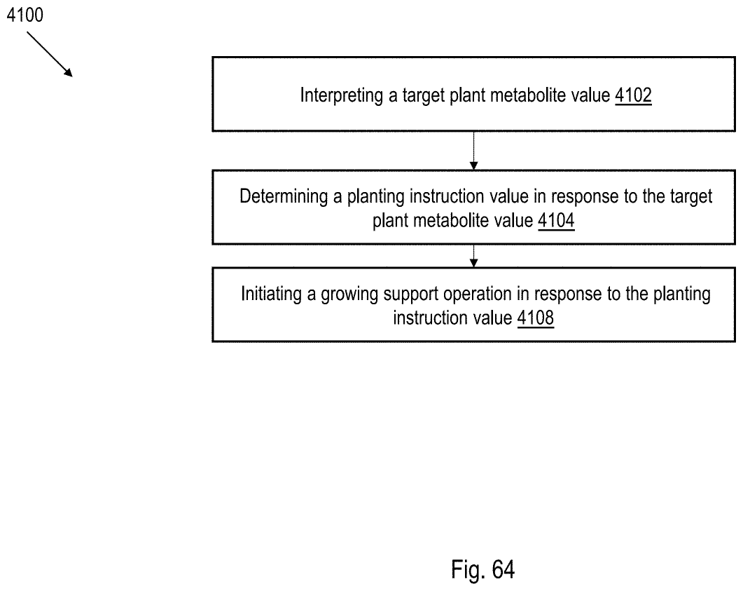

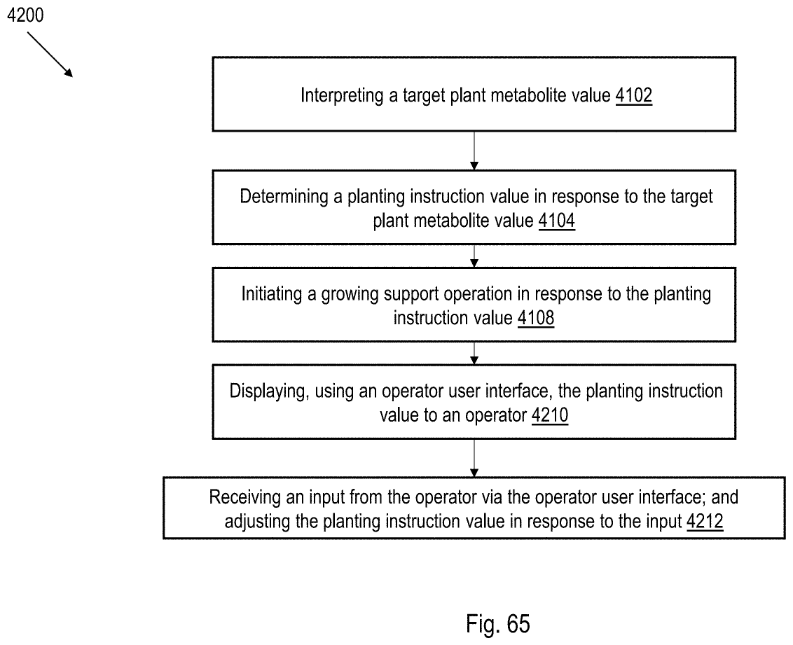

Referring now to FIG. 3, FIG. 24, FIG. 25, FIG. 64, and FIG. 65, a system, procedure, and/or apparatus may facilitate the production of specific plant metabolite compositions, such as specific vitamin levels, nitrate levels, phyto-nutrients (e.g., poly-phenolic), and the like. Referring to FIG. 3, an example system 300 may include a physical growing unit 102, and an apparatus comprising a plant metabolite control circuit 322 structured to interpret a target plant metabolite value 324, and a growth support circuit 342 structured to determine a planting instruction value 318 in response to the target plant metabolite value 324. The physical growing unit 102 may be responsive to the planting instruction value 318 to initiate a growing support operation 210. Referring to FIG. 24, the target plant metabolite value 324 may include at least one value 2400 selected from the values consisting of: a vitamin description 2402, a phyto-nutrient description 2404, or a nitrate description 2408. For example, a specific vitamin description 2402 for a leafy green may be defined, such as to meet the requirements of a labeling standard, to meet the needs of a customer, to meet the needs of an order, or the like. The specific vitamin level may be included as a target plant metabolite value. The plant metabolite control circuit interprets the target plant metabolite value and determines a procedure or an adjustment to an existing procedure that is directed at producing the leafy green with the specified vitamin level. The physical growing unit and various components thereof may be instructed, such as with the planting instruction value, to execute the procedures and/or adjustments that may result in the specified vitamin level of the leafy green. It should be understood that the plant can be monitored throughout the growth cycle and harvest, such as by sampling the plant leaves or stem, sampling the nutrient solution (e.g., to monitor for rate of nutrient absorption by testing for nutrient concentration with an electrical conductivity meter or ion-selective electrode, to monitor the pH of the nutrient solution, to test for macro-, mid-range, and/or trace elements, to monitor for nutrient transients during events such as harvesting), sampling the ambient air around the plant, monitoring a trajectory of the plant's growth in one or more dimensions (e.g., size of root bulb, number of leaves, size of leaves, height of plant, width of plant, branching of plant), monitoring a color or reflectance of the plant (e.g., reflectance decreases with decreasing distance from light source during growth), and/or any other measure directed at monitoring plants (e.g., yield per area, unit time and/or energy use), and that results from the monitoring may be used by the growth support circuit to determine an adjusted planting instruction value. In embodiments, and as discussed further herein, results from the monitoring, in conjunction with the planting instruction value and target plant metabolite value, may be used by a machine learning algorithm to facilitate system operations.

Referring to FIG. 25, the planting instruction value 318 may include instructions to perform at least one operation selected from the operations 2500 consisting of: defining a nutrient solution composition 2502; defining one of a nutrient solution transfer rate 2504 or a nutrient solution monitoring schedule 2508; defining a lighting schedule 2510; defining a lighting requirement 2530 (e.g., wavelength, light placement); defining a growth rate 2512; defining a harvest count value 2514; defining a nutrient solution temperature value 2524; defining an air quality value 2518, defining a nutrient solution electrical conductivity or pH/pH range 2532, or any other operation that is directed at supporting the growth of a plant and/or supporting the growth of a plant with a target plant metabolite value.

For a given target plant metabolite value, a composition of the nutrient solution may be defined and/or adjusted to result in products having the target value. As used herein, defining a nutrient solution composition 2502 may include defining a nutrient solution composition for an early plant growth phase (e.g., phosphorus higher than nitrogen), for a vegetative growth phase (e.g. high nitrogen), and the like. The nutrient solution may be the solution that the plants are placed in or may be the solution(s) stored in one or more reservoirs available for dosing/mixing. Nutrient solution composition may include amounts, concentrations, percentages, weights, volumes, ranges, or required minimum or maximum values for any nutrient, growth medium component, salt, molecule, or the like.

The nutrient solution composition may be re-defined throughout the growth phase or over any time interval such as in response to an input from a sensor or a user, or in response to a defined scheduled. For example, as the weight of the plant increases (e.g., as determined by interim weighing or in-tray scales) or the size of the root bulb increases (e.g., as determined by flow measurements, user observation, in-tray cameras, etc.), the nutrient solution composition may be adjusted to meet the needs of the larger size plant. If the weight and root bulb size suggested delayed growth, the nutrient solution composition may remain unadjusted even if it were scheduled to change. The composition of nutrient solutions may include any known or as yet unknown nutrients/molecules useful for plant growth, including potassium, nitrogen, phosphorus, calcium, magnesium, sulfur, iron, manganese, boron, zinc, copper, or the like.

As used herein, defining a nutrient solution transfer rate 2504 may include defining a speed/duration/frequency of a pump (e.g., nutrient fluid transfer pump 560, a variable speed pump, etc.) for distributing nutrient solution through the plant growing unit or for removing solution from the plant growing unit; defining a valve 1808 actuation time and/or duration; defining a drain size, or the like. As the root bulb gets bigger, such as with increasing plant size and increasing harvests (e.g., additional cuts on a given plant), the pressure of fluid distribution in the plant growing unit may need to be increased to account for root density. As the root bulb density increases, a variable speed pump may be ramped up in speed, for example. For achieving a given target plant metabolite value, maintaining a solution transfer rate may be important in continuing to provide the root bulb access to nutrients.

For a given target plant metabolite value, monitoring aspects of the nutrient solution may facilitate adjustments needed to achieve the target value. As used herein, defining a nutrient solution monitoring schedule 2508 may include determining which aspects of the nutrient solution to monitor (e.g., temperature, composition, pH, electrical conductivity, flow rate) and when to monitor the aspects (e.g., throughout the day, throughout a growth cycle, throughout a harvest cycle). For example, temperature may be monitored on a daily, or more frequent basis, throughout the growth cycle. In another example, phosphorus may be monitored on a weekly basis during the early growth stage, and nitrogen may be monitored twice a day during the later growth stages, and the like. In another example, pH may be monitored hourly regardless of growth stage.

For a given target plant metabolite value, a particular lighting schedule may be used to facilitate achievement of the target value. As used herein, defining a lighting schedule 2510 may include determining when particular wavelengths of light are turned on/off diurnally, when use of particular wavelengths of light are discontinued diurnally or during a growth phase, when use of particular wavelengths of light are commenced diurnally or during a growth phase, how long lights remain on and off, how long particular wavelengths of light remain on/off, and the like.

For a given target plant metabolite value, one or more aspects of lighting may be set or adjusted to facilitate achieving the target value. As used herein, defining a lighting requirement may include determining a wavelength of light required at a particular growth stage, determining a wavelength of light that results in the highest probability of achieving the target value, determining an intensity of light required diurnally, determining an intensity of a particular wavelength of light required diurnally, determining a distance from the plant to place the lighting, determining a number of lights to place corresponding to a plant or plant growing unit, determining a horizontal or a vertical placement of one or more lighting units (such as based on a cultivar), or the like.

For a given target plant metabolite value, the growth rate may be selected to facilitate achievement of the target metabolite value. As used herein, defining a growth rate 2512 may include targeting a particular growth rate in accordance with a best agricultural practice, in accordance with a desired harvest date, in accordance with a desired growth duration (e.g., such as a duration that enhances nutritional content, metabolite content, and/or flavor), in accordance with a desired transplant schedule, in accordance with a personnel availability, in accordance with an energy usage, and the like. Growth rate may be defined quantitatively (e.g., reaching a certain height in an interval of time, achieving a defined root bulb mass in an interval of time).

As used herein, defining a harvest count value 2514 may include defining a target amount of a harvest (e.g., in weight, in volume, in yield, in sales cost) and may include a target schedule and/or target date for achieving the harvest count. For a given target metabolite value, the harvest count value may be reduced or increased in accordance with other parameters and inputs, such as cost or availability of nutrients required to achieve the target metabolite value for a desired harvest count.

As used herein, defining a nutrient solution temperature value 2524 may include defining a temperature or temperature range targeted to facilitate root development and oxygen uptake by the roots, which may facilitate achievement of a target metabolite value. In an example, a cool temperature (e.g., 16° C., 18° C., 17° C., 25° C.) or temperature range (e.g., 16° C. to 24° C., 18° C. to 26° C., 17° C. to 25° C.) is maintained to support healthy growth.

As used herein, defining an air quality value 2518 may include defining a concentration of CO₂/O₂ above a plant, a concentration of CO₂/O₂ below the plants, a concentration of ambient CO₂/O₂ at a distance from the plants, an air circulation rate, a humidity value, and the like. For example, achieving a target plant metabolite value may be facilitated by maintaining a particular humidity, as defined by the air quality value. The planting instruction value may include instructions to cause dehumidification to commence, for example, when the humidity in the physical growing unit exceeds the air quality value 2518.

As used herein, defining a nutrient solution electrical conductivity (EC) may include determining a desired EC in accordance with a growth stage. For example, a seedling may need between 0.8 to 1.3 mSiemens(mS)/cm while a flowering plant may need 1.2 to 2 mS/cm.

As used herein, defining a nutrient solution pH or pH range includes defining a pH range that will maintain dissolution of nutrients in the solution under the desired conditions (e.g., temperature, fluid pressure) and promote absorption of the nutrients by plants (e.g., <6.5, <6.0, 4.0-6.5, 1.0-6.5).

The system 300 may further include a farm manager circuit 110 structured to provide an operator user interface 114 structured to display the planting instruction value 318 to an operator. The farm manager circuit 110 may be further structured to adjust the planting instruction value 318 in response to an input from the operator and/or automatically in response to any sensed, measured, or adjusted parameters of the system, plants, nutrient solution, and/or environment. An example of an operator input is a required threshold of a plant metabolite in order to meet the requirements of a changed food labeling policy. Another example of an operator input is a change in the trace content of the batch of a nutrient salt used. An example of a measured parameter that may cause an adjustment to the planting instruction value is a current amount of metabolite in a plant stalk measured during the vegetative phase. An example of a sensed parameter that may cause an adjustment to the planting instruction value is a decreased uptake of nitrogen from the nutrient solution.

Referring to FIG. 64, in embodiments, a procedure 4100 may include an operation 4102 of interpreting a target plant metabolite value; an operation 4104 of determining a planting instruction value in response to the target plant metabolite value; and an operation 4108 of initiating a growing support operation in response to the planting instruction value. Referring to FIG. 65, the procedure 4200 may further include an operation 4210 of displaying, using an operator user interface, the planting instruction value to an operator. The procedure 4200 may further include an operation 4212 of receiving an input from the operator via the operator user interface; and adjusting the planting instruction value in response to the input. The procedure 4200 may further include initiating the growing support operation by performing at least one operation selected from the operations consisting of: defining a nutrient solution composition 2502; defining one of a nutrient solution transfer rate 2504 or a nutrient solution monitoring schedule 2508; defining a lighting schedule 2510; defining a growth rate 2512; defining a harvest count value 2514; defining a nutrient solution temperature value 2524; or defining an air quality value 2518.

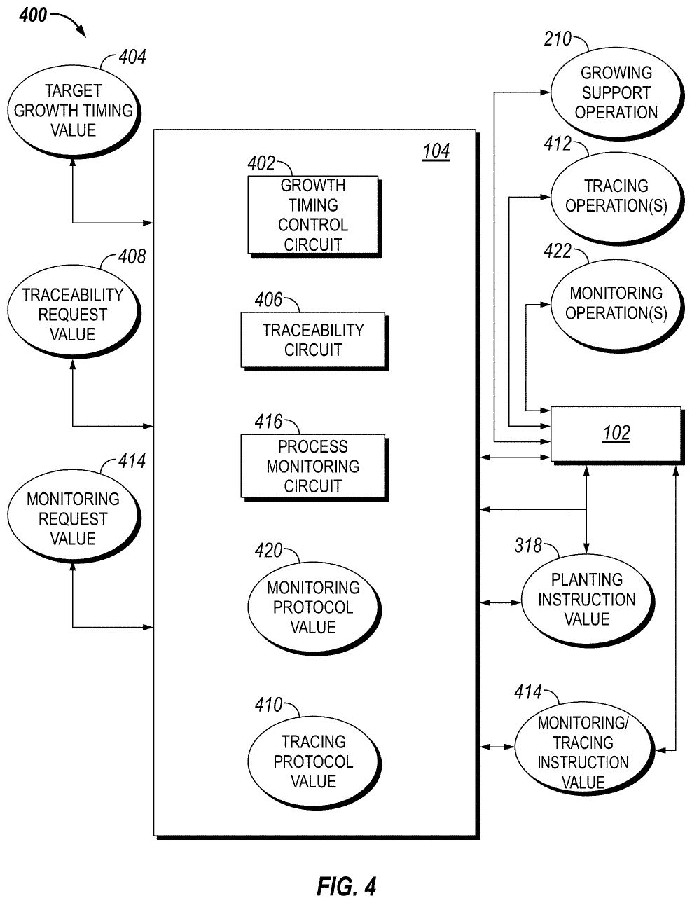

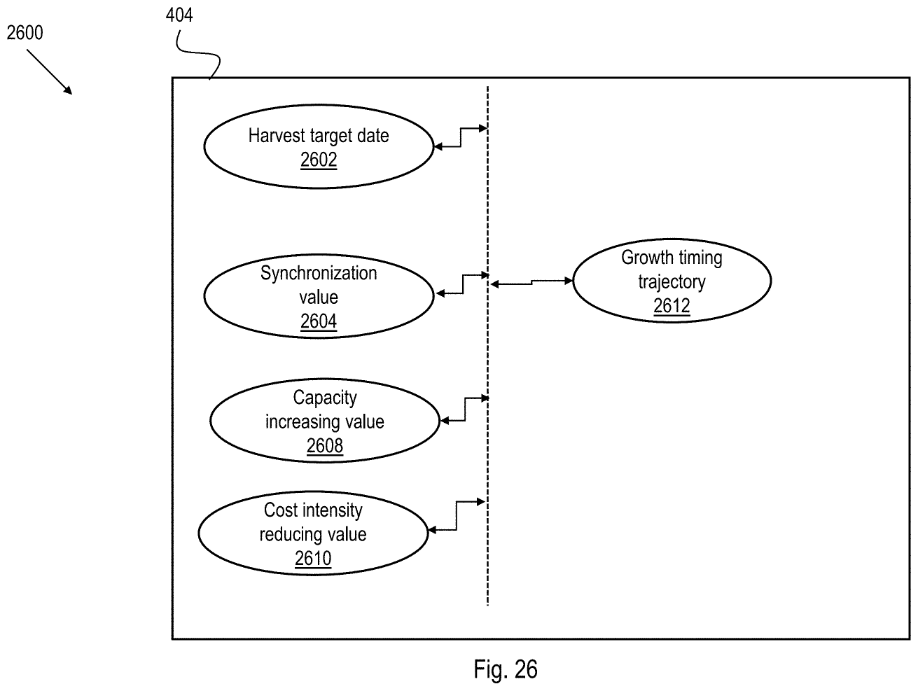

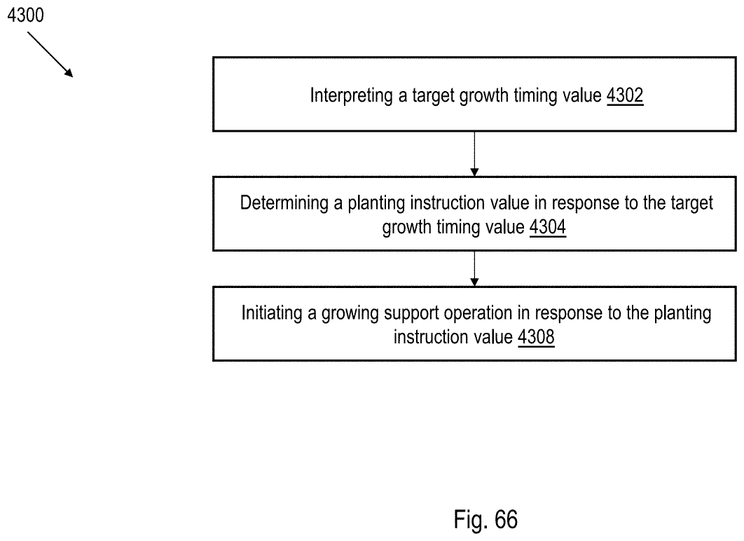

Referring to FIG. 4, FIG. 25, FIG. 26, and FIG. 66, a system, procedure, and/or apparatus may involve hardware integrated with software in a growth system. Referring to FIG. 4, a system may include a physical growing unit 102; and an apparatus including a growth timing control circuit 402 structured to interpret a target growth timing value 404, and to determine a planting instruction value 318 in response to the target growth timing value 404; and wherein the physical growing unit 102 is responsive to the planting instruction value 318 to initiate a growing support operation 210. In embodiments of operating an indoor farm, such as a vertical indoor farm, there may be challenges related to meeting inventory goals and/or capacity limitations with respect to facilities (e.g., rack height, enclosure size), personnel availability (e.g., sufficient numbers to staff year-round, sufficient numbers to staff multiple daily shifts), resource availability (e.g., water scarcity in some parts of world). and/or energy usage/availability (e.g., decreased solar power related to storm events). Solving these challenges may include staging and/or synchronizing the timing of growth and harvests.

Referring to the example embodiment 2600 of FIG. 26, the growth timing control circuit 402 facilitates overcoming these and other challenges by determining planting instruction values in response to the target growth timing value 404 which may include at least one value selected from the values consisting of: a value selected to synchronize a first set of plants and a second set of plants related to the physical growing unit 102 (e.g., synchronization value 2604); a value selected to increase a capacity of at least one of a germination unit, a seedling unit, a plantlet unit, a plant unit, or a harvesting capacity related to the physical growing unit 102 (e.g., capacity increasing value 2608); a value selected to reduce a cost intensity of the physical growing unit 102 (e.g., cost intensity reducing value 2610); or a growth timing trajectory 2612 of any one or more of the foregoing. The target growth timing value 404 may be a harvest target date 2602 for a set of plants related to the physical growing unit 102.

As used herein, the synchronization value 2604 selected to synchronize a first set of plants and a second set of plants may include a duration of time, a rack placement, a seedling transplant schedule, a temperature selection for each set of plants (e.g., temperature selected to slow growth in one instance and accelerate in another), a number of days to wait between initial placement of the sets of plants in plant growing units, or the like.

As used herein, the capacity increasing value 2608 may include an increased density of planting, an increased number of seedlings transplanted, an acceleration rate for a harvest process, or the like.

As used herein, the cost intensity reducing value 2610 may include an instruction to bias energy use to more renewables and fewer fossil fuels, to increase a number of harvest cycles from the same set of plants, to recycle nutrient solution through more harvest cycles, or the like.

Referring to FIG. 25, the planting instruction value may include instructions to perform at least one operation selected from the operations consisting of: defining a nutrient solution composition 2502; defining one of a nutrient solution transfer rate 2504 or a nutrient solution monitoring schedule 2508; defining a lighting schedule 2510; defining a growth rate 2512; defining a harvest count value 2514; defining a germination schedule 2520; defining a transplant schedule 2522; defining an air quality value 2518; or defining a tolerance value 2528 of any one or more of the foregoing.

As used herein, defining a nutrient solution composition 2502 may be as described herein and may also include increasing an amount of a nutrient to accelerate growth or decreasing an amount of a nutrient to slow growth, such as in order to stage harvesting with another set of plants.

As used herein, defining a germination schedule 2520 may include when to commence a round of germination, which growing unit will house the germinants, how long to allow germination, defining measures and/or endpoints of germination, defining personnel to monitor germinants, or the like.

As used herein, defining a transplant schedule 2522 may include monitoring plant growing units housing germinants (e.g., energy consumption, water usage, nutrient usage, pump speeds) to determine a need for transplant, defining a transplant schedule based on a trajectory of germination, defining a transplant schedule based on a start time of germination, defining a transplant schedule based on a customer requirement, or the like.

Referring to FIG. 66, a procedure 4300 may include interpreting a target growth timing value 4302; determining a planting instruction value in response to the target growth timing value 4304; and initiating a growing support operation in response to the planting instruction value 4308. Initiating the growing support operation may include instructions to at least one of define a nutrient solution composition 2502; define one of a nutrient solution transfer rate 2504 or a nutrient solution monitoring schedule 2508; define a lighting schedule 2510; define a growth rate 2512; define a harvest count value 2514; define a germination schedule 2520; define a transplant schedule 2522; define an air quality value 2518; or define a tolerance value 2528 of any one or more of the foregoing.

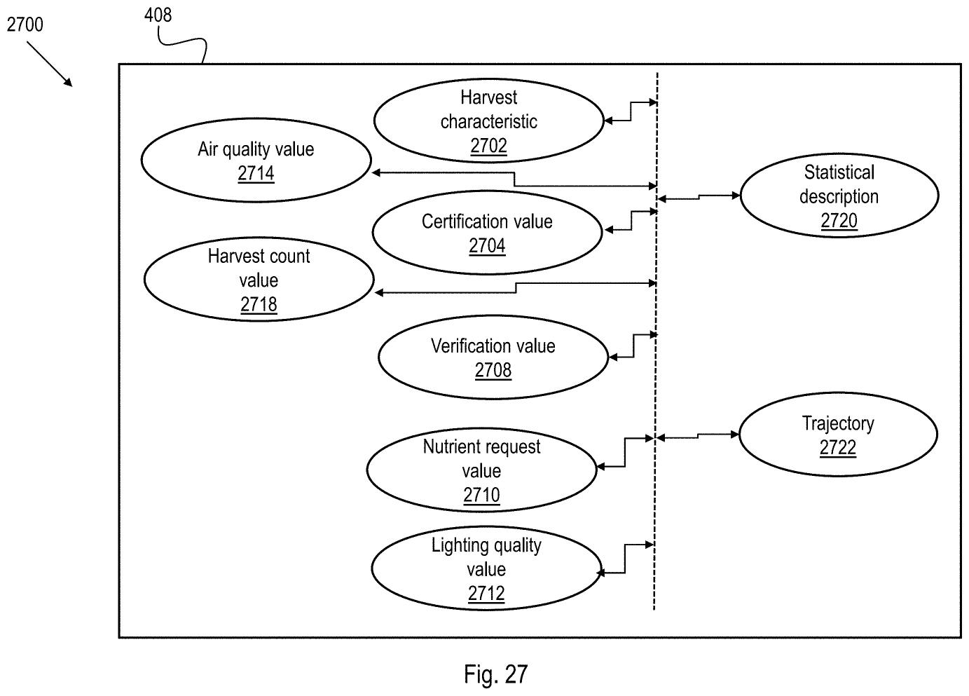

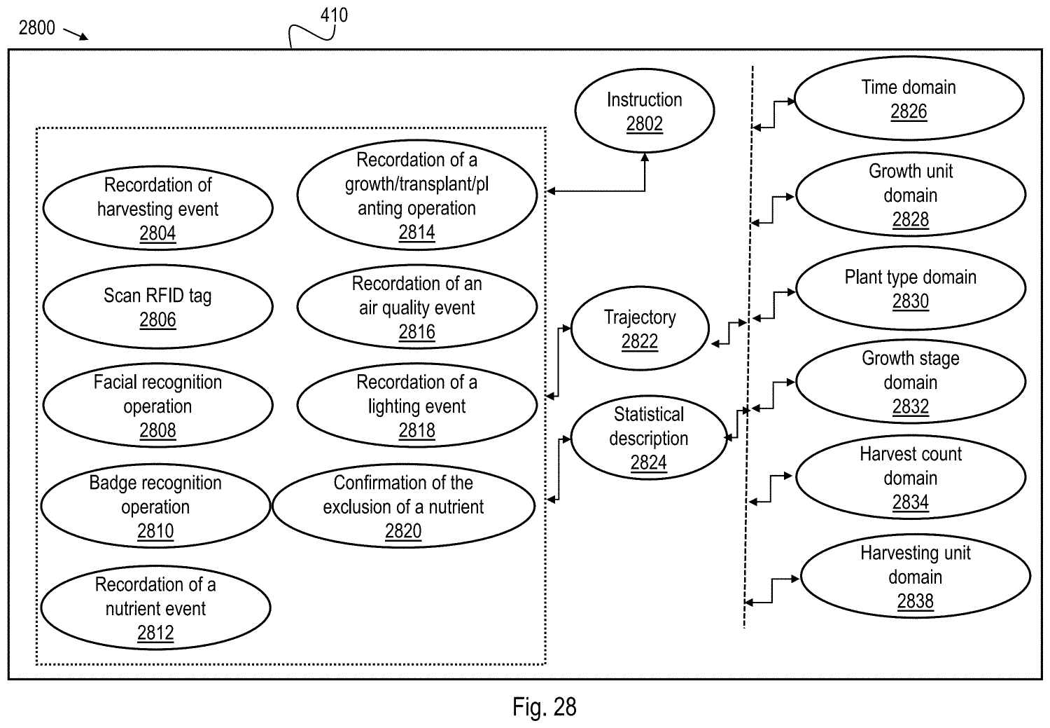

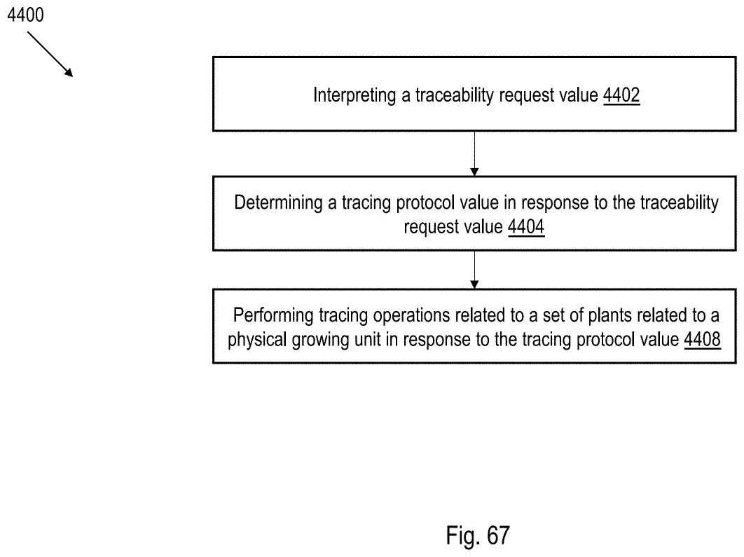

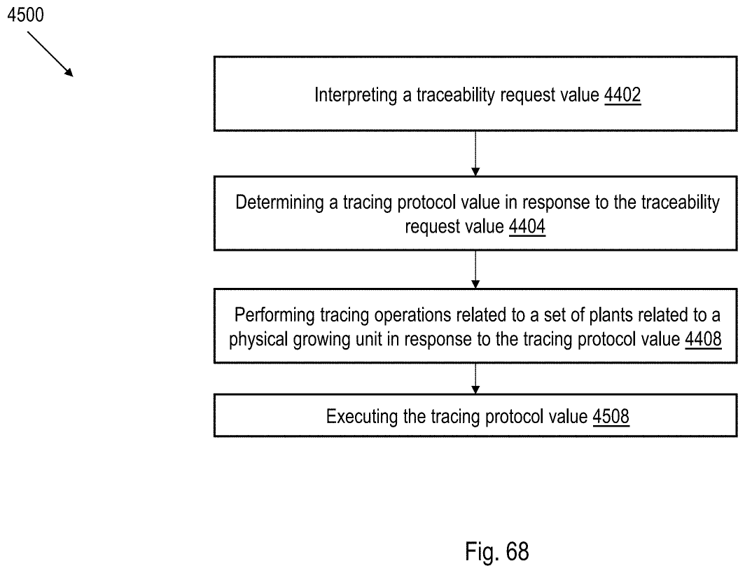

Referring to FIG. 4, FIG. 5, FIG. 27, FIG. 28, FIG. 67, FIG. 68, a system, procedure, and/or apparatus may facilitate chain of custody and traceability management in a farm management system. In certain embodiments, the system may facilitate being able to trace a plant along any portion of a growth trajectory from seed packet to the plant for sale at a customer location. Such tracing or chain of custody management may assist with marketability of certain plant products, recall management, process improvement, billing and cost expectations, projected budget and revenue planning, or the like. Traceability management in the farm management system may include collecting and interpreting data on a per plant, per shelf, per rack, per enclosure, or per harvest/batch. As used herein, traceability management may include unit tracing (e.g., enclosure, module, rack), handler tracing (e.g., personnel, operations performed, etc.), recordation/pictures/videos, inputs (e.g., nutrients used or omitted, air quality, any sensed values), or the like. Traceability management may cover various stages of a plant lifecycle, including seed batch; germination; seedling; plantlet; plant; harvest; packaging; and/or delivery.

Referring to FIG. 4, a system 400 may include a physical growing unit 102 and an apparatus comprising a traceability circuit 406 structured to interpret a traceability request value 408, and to determine a tracing protocol value 410 in response to the traceability request value 408; and wherein the physical growing unit 102 is responsive to the tracing protocol value 410 to perform tracing operations 412 related to a set of plants 108 related to the physical growing unit 102. In embodiments and referring to FIG. 27, the traceability request value 408 may include at least one value 2700 selected from the values consisting of: a harvest characteristic 2702, a certification value 2704, a verification value 2708, a nutrient request value 2710, a lighting quality value 2712, an air quality value 2714, a harvest count value 2718, a statistical description 2720 of any one or more of the foregoing, or a trajectory 2722 of any one or more of the foregoing.

As used herein, and without limitation to any other aspect of the present disclosure, the harvest characteristic 2702 may include a nutrient profile 1002, a certification description 1004 (e.g., description of compliance with one or more regulatory or voluntary requirements to obtain a certification), a verification description 1006 (e.g., one or more data points used to verify an aspect of the planting, growing, harvesting, packaging, or transporting process), or a chain of custody description 1008 (e.g., a summary of every touchpoint related to a plant including, but not limited to, seed lot, germination unit, plant growing unit, rack in plant growing unit, batch of nutrients used, personnel involved at each stage, scale used during harvesting, packaging used, refrigerator used to store harvested plants, transportation to endpoint).

As used herein, and without limitation to any other aspect of the present disclosure, the nutrient request value 2710 may include a request for data related to one or more nutrient-related aspects for the purposes of traceability, such as nutrient content, nutrient provider, personnel who formulated the nutrient solution, initial nutrient solution composition, adjustments made to the nutrient solution in response to sampling throughout one or more growing phases, nutrient temperature, nutrient flow rate, nutrient solution recycling duration, or the like.

As used herein, and without limitation to any other aspect of the present disclosure, the lighting quality value 2712 may include a request for data related to one or more lighting-related aspects for the purposes of traceability, such as wavelengths used, intensities used, particular LEDs or LED banks used, duration and schedule for lighting, distance from plant, distance from plant at each stage of growth, reflectance measurements, absorption measurements, or the like.

As used herein, and without limitation to any other aspect of the present disclosure, the air quality value 2714 may include a request for data related to one or more air quality-related aspects for the purposes of traceability, such as a humidity level, a condensation amount, a CO₂/O₂ level at various locations in the physical growing unit, a CO₂/O₂ level at various locations related to the plants/seedlings, a level of any other gas, an ambient air temperature, a temperature uniformity, or the like.

In embodiments 2800 and referring to FIG. 28, the tracing protocol value 410 may include at least one instruction 2802, wherein the physical growing unit 102 is responsive to the at least one instruction 2802 and thereby executes the tracing protocol value 410. The at least one instruction 2802 may include at least one instruction selected from the instructions consisting of: a recordation of a harvesting event 2804 (e.g., by manual or electronic logging in an electronic and/or paper log 578, video or still camera 570 recordation of the harvest, audio dictation of the harvest event, scanning of a shelf marker indicating a harvest event, including any parameter of a shelf cleaning component 588 such as for post-harvest); at least one of a scanning of a radio frequency identification tag 2806 or other tag (e.g. QR code, bar code, etc.) (e.g., an RFID tag 572 used at a shelf, rack, plant, growing unit scanned by an RFID sensor 574) used to capture data, executed operations, personnel executing operations, and to associate with recordations described herein, a facial recognition operation 2808 or a badge recognition operation 2810 (e.g., to identify personnel handling the plant during an operation); a recordation of a nutrient event 2812 (e.g., a nutrient added, a nutrient excluded, a nutrient adjusted, a parameter of a nutrient fluid transfer pump 560); a recordation of at least one of a growth operation, a transplant operation, or a planting operation 2814 (e.g., including any aspect of the aforementioned operation such as date, time, personnel, yield at time of operation, color/size/weight at time of operation, or the like); a recordation of an air quality event 2816 (e.g., an increase in O₂, a decrease in CO₂, a dehumidification, an ambient air temperature change, any air quality sensor 562 measurement or an air supply component 564 parameter); a recordation of a lighting event 2818 (e.g., a setting of a wavelength, a setting of a lighting schedule, an increase in light intensity, any lighting unit 568 parameter); or a confirmation of an exclusion of a nutrient 2820 (e.g., an operator exclusion from a nutrient solution, an exclusion from absorption by the plant, a customer-requested exclusion of a nutrient, based on data from any water purifier component 582 parameter or measurement or any water quality sensor 584 measurement). The at least one instruction may include at least one of the events, and further includes a trajectory 2822 of a plurality of the at least one of the events. The at least one instruction may include at least one of the events, and further includes a statistical description 2824 of a plurality of the at least one event. At least one of the trajectory 2822 or the statistical description 2824 may be determined for any one or more of the domains consisting of: a time domain 2826, a growth unit domain 2828, a plant type domain 2830, a growth stage domain 2832, a harvest count domain 2834, or a harvesting unit domain 2838.

Referring to FIG. 5, the physical growing unit 102 may include a hardware component responsive to the tracing protocol value 410 to perform the tracing operations 412, wherein the hardware component further comprises at least one component selected from the components consisting of: a sensor 548; a nutrient monitoring sensor 550; a data store 554 configured to store activity data related to the tracing operations; a door position sensor 558 (e.g., to trace an enclosure access, to trace an enclosure exposure); a nutrient fluid transfer pump 560; an air quality sensor 562; an air supply component 564; a lighting unit 568; a camera 570; a radio frequency identifier (RFID) tag 572; an RFID sensor 574; an electronic and/or paper log 578; an order confirmation and/or receipt 580 (e.g., to determine correct fulfillment); a water purifier component 582; a water quality sensor 584; or a shelf cleaning component 588.

Referring to FIG. 67, a procedure 4400 may include an operation 4402 of interpreting a traceability request value; an operation 4404 of determining a tracing protocol value in response to the traceability request value; and an operation 4408 of performing tracing operations related to a set of plants related to a physical growing unit in response to the tracing protocol value. Referring to FIG. 68, the procedure 4500 may further include an operation 4508 executing the tracing protocol value. Executing the tracing protocol value may be in response to a recordation of a harvesting event, in response to at least one of a scanning of a radio frequency identification tag, a facial recognition operation, or a badge recognition operation, in response to a recordation of a nutrient event, in response to a recordation of at least one of a growth operation, a transplant operation, or a planting operation, in response to a recordation of an air quality event, in response to a recordation of a lighting event, or in response to a confirmation of an exclusion of a nutrient.

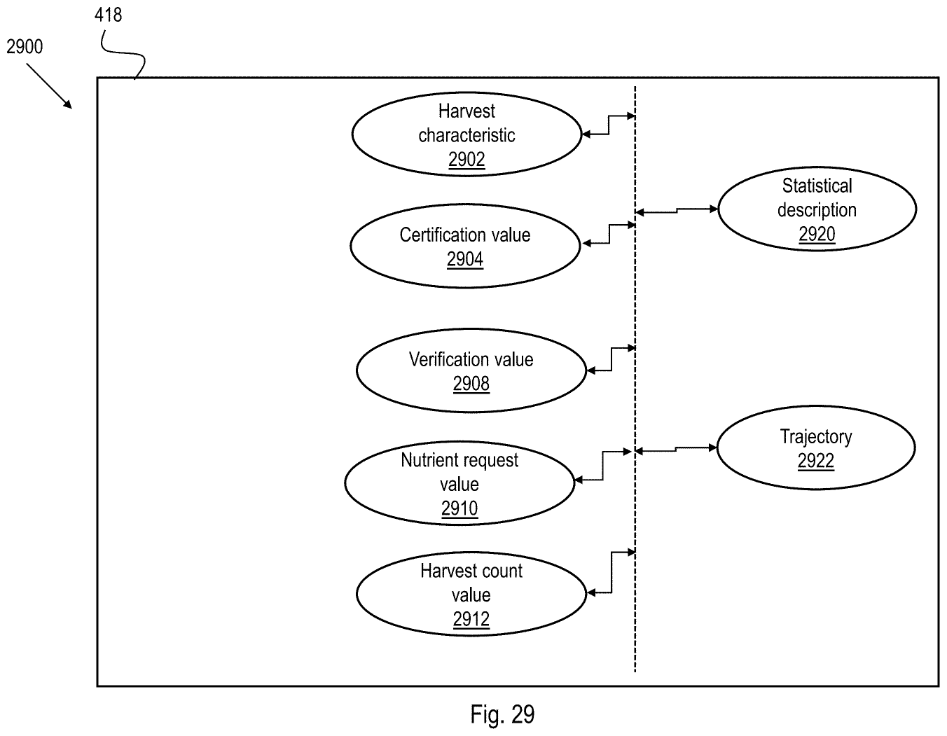

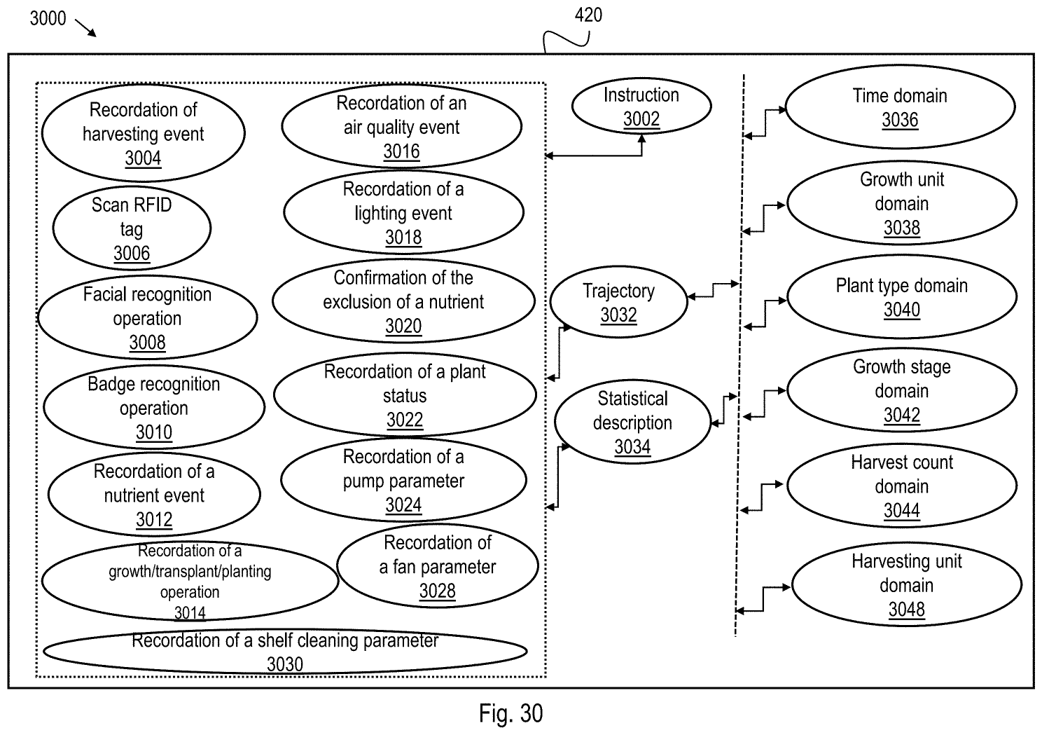

Referring to FIG. 4, an illustrative and non-limiting farm management system 400 is depicted. The example system may include a controller 104 communicatively coupled to a physical growing unit 102; the physical growing unit 102 may be further comprised of a set of plants 108. The example controller 104 includes a process monitoring circuit 416 that interprets a monitoring request value 418. An example monitoring request value 418 includes one or more of (e.g., reference the example embodiment 2900 of FIG. 29): a harvest characteristic 2902 (e.g., harvested weight, harvest confirmation, and/or harvesting personnel); a certification value 2904 (e.g., regulatory certification, kosher certification, and/or organic certification); a verification value 2908 (e.g., nutrient level verification, harvest technique verification, and/or stress event verification; a nutrient request value 2910 (e.g., nitrate level request value, fertilizer concentration request value, macro-nutrient request value, and/or trace element request value); a harvest count value 2912; a statistical description 2920 and/or a trajectory 2922 of any one or more of the foregoing. The example monitoring request values 418 are non-limiting examples to demonstrate certain aspects of the present disclosure. An example harvest count value 2912 includes the number of times that the same plant has been cut. Examples of statistical descriptions 2920 may include an average, a rolling average, a Bayesian analysis, or a filtered value. Each of a statistical description 2920 and/or a trajectory 2922 may be determined for any one or more of the domains consisting of (e.g., reference FIG. 30, also reference FIG. 15 and the related description): a time domain 3036; a growth unit domain 3038; a plant type domain 3040; a growth stage domain 3042; a harvest count domain 3044; and/or a harvesting unit domain 3048.

The process monitoring circuit 416 determines a monitoring protocol value 420 in response to the monitoring request value 418, and further determines a monitoring instruction value 414 in response to the monitoring request value 418 and the monitoring protocol value 420.

The physical growing unit 102 responds to the monitoring instruction value 414 and performs operations 422 related to a set of plants 108; The physical growing unit 102 may be further comprised of a hardware component that performs tracing operations 412 in response to the monitoring instruction value 414.

Referring to FIG. 5, an illustrative and non-limiting farm management system 500 is depicted. The example system may include a physical growing unit 102. The physical growing unit 102 may be further comprised of a hardware component selected from the hardware components consisting of: a sensor 548; a nutrient monitoring senser 550; a data store 554; a door position sensor 558; a nutrient fluid transfer pump 560; an air quality sensor 562; an air supply component 564; a lighting unit 568; a camera 570; an RFID tag 572; and RFID sensor 574; an electronic and/or paper log 578; an order confirmation and/or receipt 580; a water purifier component 582; a water quality sensor 584; a shelf cleaning component 588; a fan 590. The example hardware components are non-limiting examples to demonstrate certain aspects of the present disclosure.

Referring to FIG. 30, an illustrative and non-limiting farm management system 3000 is depicted. The example system may include a controller 104 communicatively coupled to a physical growing unit 102. The controller 104 may include (reference FIG. 4) a process monitoring circuit 416 structured to interpret a monitoring request value 418.The process monitoring circuit 416 may be further structured to determine a monitoring protocol value 420 in response to the monitoring request value 418. The monitoring protocol value 420 may be further comprised of at least one instruction scheme 3002. The process monitoring circuit 416 may be further structured to determine a monitoring instruction value 414 in response to the at least one instruction scheme 3002. The monitoring instruction value 414 comprises at least one instruction selected from the instructions consisting of: a recordation of a harvest event 3004; a recordation of a growth, transplant, or planting operation 3014; a recordation of a lighting event 3018; a recordation of a plant status 3022; a recordation of a pump parameter 3024; a recordation of a fan parameter 3028; a recordation of a shelf cleaning parameter 3030; a scanning of a radio frequency identification (RFID) tag 3006; a facial recognition operation 3008 (e.g., to determine a harvesting personnel, and/or to confirm access authorization to an enclosure having the group of plants 108 for harvest); a badge recognition operation 3010; a recordation of a nutrient event 3012; a recordation of an air quality event 3016; and/or a confirmation of the exclusion of a nutrient 3020. The example instruction scheme 3002 may additionally or alternatively include a trajectory 3032 and/or statistical description 3034 of any of the foregoing, including using a time domain 3036 or another domain (e.g., reference the description related to FIG. 15 and FIG. 29). The example monitoring instruction values 414 are non-limiting examples to demonstrate certain aspects of the present disclosure.

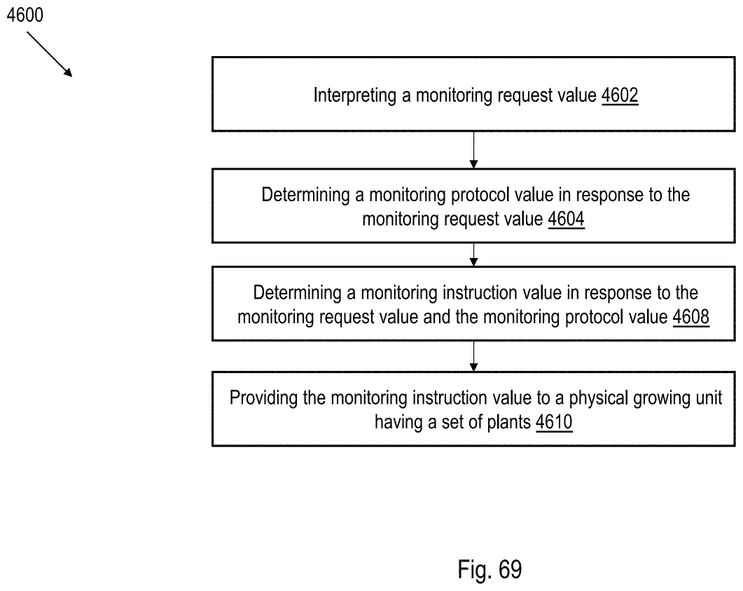

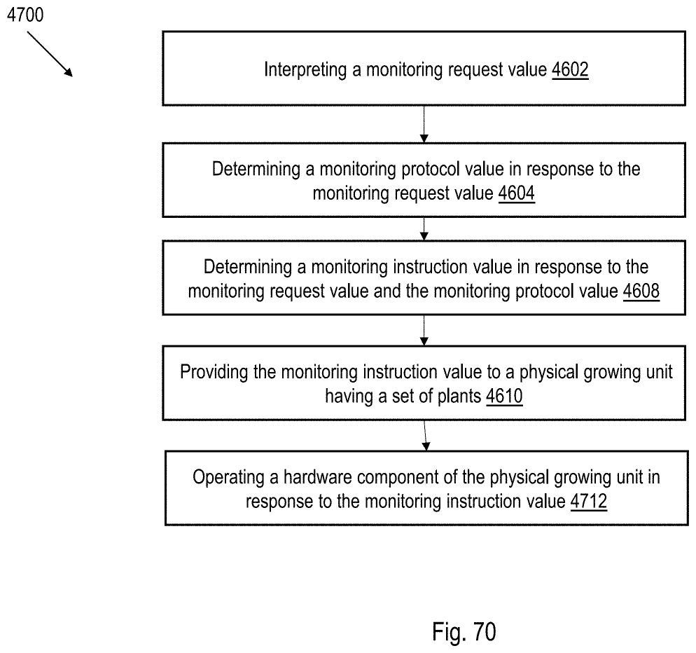

Referring to FIG. 69, an illustrative and non-limiting farm management procedure 4600 is depicted. The example procedure includes an operation 4602 to interpret a monitoring request value; an operation 4604 to determine a monitoring protocol in response to the monitoring request value; an operation 4608 to determine a monitoring instruction value in response to the monitoring request value and the monitoring protocol value; and an operation 4610 to provide the monitoring instruction value to a physical growing unit having a set of plants. Referencing FIG. 70, an example procedure 4700 further includes an operation 4712 to operate a hardware component of the physical growing unit in response to the monitoring instruction value.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are contemplated in embodiments of the present disclosure.

1. A system, comprising:
a physical growing unit;
a capacity control circuit structured to interpret a growing capacity description; and
a growth support circuit structured to determine a planting instruction value in response to the growing capacity description,
wherein the physical growing unit is responsive to the planting instruction value to initiate a growing support operation.

2. The system of claim 1, wherein the physical growing unit comprises at least one apparatus selected from the apparatus consisting of: a cultivar receiving unit; a cultivar tracking unit; a germination unit; a seedling tracking unit; a plantlet development unit; a transplant trajectory circuit; a vertical indoor farm; a personnel tracking unit; a receiving planning unit; a harvesting planning unit; a nutrient planning unit; a water planning unit; a power planning unit; a shelf preparation planning unit; a nutrient delivery unit; a nutrient control unit; a nutrient monitoring unit; a plant monitoring unit; or a harvest monitoring unit.

3. The system of claim 1, wherein the physical growing unit is structured to initiate the growing support operation by performing at least one operation selected from the operations consisting of: providing a capacity indication related to an indoor vertical farm; adjusting a capacity related to an indoor vertical farm; directing a planting operation; directing a transplanting operation; directing a supply operation; directing a cleaning operation; adjusting a growth rate; adjusting a nutrient solution transfer or monitoring schedule; adjusting a trajectory of any one or more of the foregoing; providing a report related to any one or more of the foregoing; or validating any one or more of the foregoing.

4. The system of claim 1, wherein the growing capacity description includes a delivery target value for at least one aspect of an indoor vertical farm.

5. The system of claim 4, wherein the delivery target value comprises at least one value selected from the values consisting of: a personnel value; a seedling value; a plantlet value; a shelf capacity value; a nutrient delivery value; a power value; a water value; a cleaning capacity value; a cultivar supplier value; or a trajectory of any one or more of the foregoing.

6. The system of claim 1, wherein the planting instruction value comprises at least one value selected from the values consisting of: a type of harvested plant; a specified cultivar; a set of acceptable cultivars; a harvest characteristic; a time value of any one or more of the foregoing; a quantity of any one or more of the foregoing; or a trajectory of any one or more of the foregoing.

7. The system of claim 1, wherein the planting instruction value comprises a harvest characteristic, and wherein the harvest characteristic comprises at least one value selected from the values consisting of: a nutrient profile; a certification description; a verification description; a chain-of-custody description; or a support description relating to any one or more of the foregoing.

8. The system of claim 1, further comprising a farm manager circuit structured to provide a supplier user interface structured to display the growing capacity description to a supply user, to receive an input from the supply user in response to the growing capacity description, and to adjust the planting instruction value in response to the input from the supply user.

9. The system of claim 8, wherein the farm manager circuit is further structured to determine and display at least one recommendation for the planting instruction value to the supply user.

10. The system of claim 9, wherein the farm manager circuit is further structured to determine and display a plurality of recommendations for the planting instruction value to the supply user, and wherein receiving the input from the supply user includes receiving a selection from the supply user of the plurality of recommendations for the planting instruction value.

11. The system of claim 10, wherein the farm manager circuit is further structured to determine and display an outcome description value corresponding to each of the plurality of recommendations for the planting instruction value to the supply user.

12. The system of claim 11, wherein the farm manager circuit is further structured to determine and display an adjusted outcome description value in response to one of the selection from the supply user or an entry from the supply user, wherein the entry from the supply user comprises one of a user-entered planting instruction value or a user-adjusted planting instruction value.

13. An apparatus, comprising:
a capacity control circuit structured to interpret a growing capacity description;
a growth support circuit structured to determine a planting instruction value in response to the growing capacity description; and
a farm manager circuit structured to receive an input from a supply user, and to adjust the planting instruction value in response to the input.

14. The apparatus of claim 13, wherein the farm manager circuit is further structured to provide a supplier user interface structured to display the growing capacity description to the supply user, and to receive the input from the supply user in response to the growing capacity description.

15. The apparatus of claim 14, wherein the input relates to a harvest capacity including at least one of a harvest amount, a certification, a verification, a nutrient content, a cultivar, or a cut limitation.

16. The apparatus of claim 13, wherein the growing capacity description includes a delivery target value for at least one aspect of an indoor vertical farm.

17. The apparatus of claim 16, wherein the delivery target value comprises at least one value selected from the values consisting of: a personnel value; a seedling value; a plantlet value; a shelf capacity value; a nutrient delivery value; a power value; a water value; a cleaning capacity value; a cultivar supplier value; or a trajectory of any one or more of the foregoing.

18. The apparatus of claim 13, wherein the planting instruction value comprises at least one value selected from the values consisting of: a type of harvested plant; a specified cultivar; a set of acceptable cultivars; a harvest characteristic; a time value of any one or more of the foregoing; a quantity of any one or more of the foregoing; or a trajectory of any one or more of the foregoing.

19. The apparatus of claim 13, wherein the planting instruction value comprises a harvest characteristic, and wherein the harvest characteristic comprises at least one value selected from the values consisting of: a nutrient profile; a certification description; a verification description; a chain-of-custody description; or a support description relating to any one or more of the foregoing.

20. A method, comprising:
interpreting a growing capacity description;
determining a planting instruction value in response to the growing capacity description; and
initiating a growing support operation in response to the planting instruction value.

21. The method of claim 20, further comprising:
initiating the growing support operation by performing at least one operation selected from the operations consisting of: providing a capacity indication related to an indoor vertical farm; adjusting a capacity related to an indoor vertical farm; directing a planting operation; directing a transplanting operation; directing a supply operation; directing a cleaning operation; adjusting a growth rate; adjusting a nutrient solution transfer or monitoring schedule; adjusting a trajectory of any one or more of the foregoing; providing a report related to any one or more of the foregoing; or validating any one or more of the foregoing.

22. The method of claim 20, further comprising:
providing, via a supplier user interface, the growing capacity description to a supply user;
receiving, via the supplier user interface, an input from the supply user in response to the growing capacity description; and
adjusting the planting instruction value in response to the input from the supply user.

23. The method of claim 22, further comprising:
determining and displaying at least one recommendation for the planting instruction value to the supply user.

24. The method of claim 23, further comprising:
determining and displaying a plurality of recommendations for the planting instruction value to the supply user,
wherein receiving the input from the supply user includes receiving a selection from the supply user of the plurality of recommendations for the planting instruction value.

25. The method of claim 24, further comprising:
determining and displaying an outcome description value corresponding to each of the plurality of recommendations for the planting instruction value to the supply user.

26. The method of claim 25, further comprising:
determining and displaying an adjusted outcome description value in response to one of the selection from the supply user or an entry from the supply user,
wherein the entry from the supply user comprises one of a user-entered planting instruction value or a user-adjusted planting instruction value.

27.-206. (canceled)
